(19) United States
(12) Patent Application Publication
(10) Pub. No.: US 2019/0108561 A1
(43) Pub. Date: Apr. 11, 2019

(54) Purchase Intent Determination And Real Time In-store Shopper Assistance

(71) Applicant: Mindtree Ltd., Bangalore (IN)

(72) Inventors: Sudhakar Bangalore Shivashankar, Bangalore (IN); Sharmila Saha, Bangalore (IN); Gaurav Johri, Bangalore (IN); Gautham Gopalakrishna, Bangalore (IN)

(73) Assignee: Mindtree Ltd.

(21) Appl. No.: 15/861,695

(22) Filed: Jan. 4, 2018

(30) Foreign Application Priority Data
Oct. 5, 2017 (IN) 201741035297

(51) Int. Cl. G06Q 30/06; G06Q 30/00; G06K 9/00; G06F 17/18

(52) U.S. Cl. CPC G06Q 30/06; G06Q 30/01; G06F 17/18; G06K 9/00369; G06K 9/00624

(57) ABSTRACT

A method and a purchase intent determination and assistance management system (PIDAMS) for determining purchase intent of an anonymous shopper and providing assistance in a retail store are provided. The PIDAMS identifies an anonymous shopper, receives images of the anonymous shopper, and determines shopper attributes of the anonymous shopper within a region of interest using sensors. The PIDAMS generates an event based on a configurable dwell time threshold, determines the purchase intent of the anonymous shopper by iteratively ranking the anonymous shopper based on section attributes, transmits alert notifications, renders information on target items and offers on the target items to a store assistant who accepted an alert notification to provide assistance to the anonymous shopper, and receives and stores feedback on a communication between the anonymous shopper and the store assistant for iteratively ranking the anonymous shopper in conjunction with conversion data extracted from the feedback.

### CROSS-REFERENCE TO RELATED APPLICATIONS

This application claims priority to and the benefit of the non-provisional patent application titled “Purchase Intent Determination And Real Time In-Store Shopper Assistance”, application number 201741035297, filed in the Indian Patent Office on Oct. 5, 2017. The specification of the above referenced patent application is incorporated herein by reference in its entirety.

### BACKGROUND

Retail stores have their presence around the world and are growing day by day to meet increasing needs of shoppers. Retail stores typically offer a wide range of products of different brands under one roof, that is, at one location. In such retail stores, products of different qualities, in different quantities, and with different rates that suit the needs of the shoppers are made available. Therefore, such multi-brand retail stores allow the shoppers to browse and buy different types of products from one place, which helps in saving time and resources of the shoppers. A shopper can easily compare products of different brands and buy a product that best suits the shopper's requirement. A shopper's behaviour relates to a process through which shoppers make decisions associated with utilization of their time, money, and efforts to procure, use, and dispose products and services. Although the process of purchase, that is, the stages through which a shopper passes, while the shopper makes a purchase decision, is typically the same in most cases, the factors that influence the purchase decision vary from shopper to shopper.

Shoppers play a vital role in economic growth. Retailers need to understand the different types of decisions that shoppers make and factors that influence the shoppers' decisions, and then generate insights that will help the retailers develop optimally targeted programs to activate their products and brands in their retail stores. Shopper behaviour focuses on how shoppers make decisions to spend their resources on consumption related items. Shopper behaviour depends not only on what shoppers buy, but also on why, when, where, and how shoppers purchase consumption related items. To determine shopper behaviour, shopper research is typically conducted at every stage of the process of purchase, that is, before the purchase, during the purchase, and after the purchase. Shopper behaviour is that subset of human behaviour that relates to decisions and acts of shoppers in purchasing and using products of a manufacturer or in purchasing products from particular retailers. A shopper's decision on which brand to purchase is typically not made until the shopper visits a retail store. A product manufacturer must understand a shopper's purchase behaviour as the shopper's purchase behaviour differs from shopper to shopper. The product manufacturer must be able to identify motives that prompt shoppers to purchase a product so that the product manufacturer can offer a complete product that satisfies the shoppers' needs. A shopper's motives to purchase a product depend on different shopper attributes, for example, age, gender, physical attributes, shopper preferences associated with spending power, vanity, fashion, style, comfort, relationships, etc. A retailer must analyze shopper behaviour and shopper attributes to target, sell, and improve a product.

In-store customer service is typically provided by store assistants. For example, when a shopper enters a retail store and proceeds to browse products and brands offered by the retail store, the shopper may have no preconceived notion of what the shopper wishes to buy and may utilize in-store assistance and/or advice to make a purchase. In another scenario, the shopper may have an idea of the purchase the shopper wishes to make, and yet may still rely upon in-store assistance to make the purchase and/or additional purchases based on a number of factors, for example, recommendations made by a store assistant, sales, etc. In cases where store assistants are not available to assist the shopper, the shopper may decide to leave the retail store without making a purchase. Furthermore, if a shopper is not aware of deals, sales, offers, etc., provided by the retail store, limited access to the required information on deals, sales, offers, etc., would further decrease the sale of products and revenue.

Profile data of shoppers is typically used to generate marketing strategies for marketing products to the shoppers. This profile data typically comprises information provided by the shoppers in response to questionnaires or surveys, for example, name, address, telephone number, etc., of shoppers as well as products preferred by the shoppers. Demographic data comprising, for example, a shopper's age, gender, income, career, interests, hobbies, and preferences may also be requested from shoppers to generate profile data of the shoppers. However, these methods typically infringe a shopper's privacy and provide limited information that is used to develop generalized marketing strategies that are directed towards a large segment of shoppers without taking into account actual shopper reactions to product placement in a particular retail store or to other factors that influence product purchases by shoppers.

Moreover, in a retail store, there is a need for measuring effectiveness of a product display or measuring the attractiveness of a product. Being able to measure these attributes can help with store layout planning and identifying regions of interest for optimizing products and product displays and their placement in the retail store to generate revenue.

In an attempt to monitor shoppers in large retail stores, the retail stores utilize cameras and other audio and/or video monitoring devices to record the shoppers inside the retail store or in a parking lot. A store manager may watch one or more monitors that display closed circuit images of the shoppers in various sections inside the retail store for security purposes, for example, to identify shoplifters. However, these solutions require a human user to review the audio and video recordings. Moreover, the video and audio recordings are typically used only for store security. Furthermore, the conventional solutions do not utilize potential dynamic shopper data elements that may be available for identifying shoppers who should be encouraged to shop at the retail store, shoppers who should be targeted as potential buyers, shoppers that have the highest likelihood of purchasing, etc.

Hence, there is a long felt need for a method and a system for determining an anonymous shopper's purchase intent, that is, likelihood of purchase in a retail store and providing assistance to the anonymous shopper through available store assistants in the retail store based on the determined purchase intent in real time. Moreover, there is a need for a method and a system for capturing multiple images of an anonymous shopper in a specific region of interest in a section of the retail store and processing the images for identifying human shoppers, determining multiple detailed shopper attributes comprising, for example, dwell time, sections of dwell, an age range, gender, prominent colour of a clothing worn by the anonymous shopper, whether the anonymous shopper is accompanied by another shopper, location, date, time, etc., and determining the purchase intent of the anonymous shopper using the detailed shopper attributes. Furthermore, there is a need for a method and a system for identifying and alerting store assistants about presence of an anonymous shopper with detailed shopper attributes and regions of interest to allow the store assistants to optimally assist the anonymous shopper and provide information on target items and offers on the target items applicable to the anonymous shopper. Furthermore, there is a need for a method and a system for storing feedback received from the anonymous shopper for iteratively ranking anonymous shoppers, converting the anonymous shoppers into potential buyers, and improving shopper experience in a retail store, thereby increasing revenue for the retail store.

### SUMMARY OF THE INVENTION

This summary is provided to introduce a selection of concepts in a simplified form that are further disclosed in the detailed description of the invention. This summary is not intended to determine the scope of the claimed subject matter.

The method and the system disclosed herein address the above recited needs for determining an anonymous shopper's purchase intent, that is, likelihood of purchase in a retail store and providing assistance to the anonymous shopper through available store assistants in the retail store based on the determined purchase intent in real time. Moreover, the method and the system disclosed herein address the above recited needs for capturing multiple images of an anonymous shopper in a specific region of interest in a section of the retail store and processing the images for identifying human shoppers, determining multiple detailed shopper attributes comprising, for example, dwell time, sections of dwell, an age range, gender, prominent colour of a clothing worn by the anonymous shopper, whether the anonymous shopper is accompanied by another shopper, location, date, time, etc., and determining the purchase intent of the anonymous shopper using the detailed shopper attributes. Furthermore, the method and the system disclosed herein address the above recited needs for identifying and alerting store assistants about presence of an anonymous shopper with detailed shopper attributes and regions of interest to allow the store assistants to optimally assist the anonymous shopper and provide information on target items and offers on the target items applicable to the anonymous shopper. Furthermore, the method and the system disclosed herein address the above recited need for storing feedback received from the anonymous shopper for iteratively ranking anonymous shoppers, converting the anonymous shoppers into potential buyers, and improving shopper experience in a retail store, thereby increasing revenue for the retail store.

The method disclosed herein employs a purchase intent determination and assistance management system (PIDAMS) comprising at least one processor configured to execute computer program instructions for determining purchase intent of an anonymous shopper in a retail store and providing assistance to the anonymous shopper in the retail store based on the determined purchase intent. The PIDAMS identifies the anonymous shopper within a region of interest configured for a section in the retail store using one or more of multiple sensors positioned at multiple sections of the retail store. The PIDAMS receives multiple images of the identified anonymous shopper captured by one or more sensors positioned at the configured region of interest. The PIDAMS determines shopper attributes of the identified anonymous shopper from the received images. The PIDAMS generates an event associated with the received images and the determined shopper attributes based on a configurable dwell time threshold. The PIDAMS dynamically configures the dwell time threshold based on iterative statistical inputs. The PIDAMS iteratively ranks the identified anonymous shopper based on the generated event and section attributes of the configured region of interest for determining the purchase intent of the identified anonymous shopper to convert the identified anonymous shopper into a potential buyer.

The purchase intent determination and assistance management system (PIDAMS) generates and transmits one or more alert notifications with the determined shopper attributes, images that provide a physical identification of the identified anonymous shopper, and the region of interest to a communication device of each of one or more of multiple store assistants to provide assistance to the identified anonymous shopper based on the iterative ranking of the identified anonymous shopper and predetermined section criteria. When the PIDAMS receives an acceptance indication from one of the store assistants to provide assistance to the identified anonymous shopper, the PIDAMS renders information on target items and offers on the target items applicable to the identified anonymous shopper based on the determined shopper attributes to the communication device of the store assistant on request. The PIDAMS receives and stores feedback on a communication initiated with the identified anonymous shopper from the communication device of the store assistant for the iterative ranking of the identified anonymous shopper in conjunction with conversion data extracted from the feedback received from an assistant application implemented on the store assistant's communication device.

In one or more embodiments, related systems comprise circuitry and/or programming for effecting the methods disclosed herein. The circuitry and/or programming can be any combination of hardware, software, and/or firmware configured to effect the methods disclosed herein depending upon the design choices of a system designer. Also, various structural elements can be employed depending on the design choices of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1 illustrates a method for determining purchase intent of an anonymous shopper in a retail store and providing assistance to the anonymous shopper in the retail store based on the determined purchase intent in real time.

FIG. 2 exemplarily illustrates a flowchart comprising the steps performed by a purchase intent determination and assistance management system for determining dwell time of an anonymous shopper.

FIG. 3 exemplarily illustrates a flowchart comprising the steps performed by the purchase intent determination and assistance management system for determining one or more human objects at a region of interest configured for a section in a retail store.

FIG. 4 exemplarily illustrates a flowchart comprising the steps performed by the purchase intent determination and assistance management system for generating an alert notification based on dwell time of an anonymous shopper.

FIG. 5 exemplarily illustrates a flowchart comprising the steps performed by the purchase intent determination and assistance management system for computing dwell time thresholds of a configured region of interest based on weather conditions at a location of a retail store.

FIG. 6 exemplarily illustrates a flowchart comprising the steps performed by the purchase intent determination and assistance management system for computing dwell time thresholds of a configured region of interest based on shift roster data of a retail store.

FIGS. 7A-7B exemplarily illustrate graphical representations showing dwell time distributions of anonymous shoppers identified in configured regions of interest that are in view of sensors in a retail store, indicating performance of iterative statistical models in determining dwell time thresholds.

FIG. 8 exemplarily illustrates a flowchart comprising the steps performed by the purchase intent determination and assistance management system for ranking an identified anonymous shopper and alerting store assistants.

FIG. 9A exemplarily illustrates a system comprising the purchase intent determination and assistance management system for determining purchase intent of an anonymous shopper in a retail store and providing assistance to the anonymous shopper in the retail store based on the determined purchase intent.

FIG. 9B exemplarily illustrates an implementation of the purchase intent determination and assistance management system for determining purchase intent of an anonymous shopper in a retail store and providing assistance to the anonymous shopper in the retail store based on the determined purchase intent.

FIG. 10A exemplarily illustrates a screenshot of a graphical user interface provided by a manager application on a communication device of a store manager for configuring regions of interest in a retail store.

FIG. 10B exemplarily illustrates a screenshot of alert notifications rendered on a graphical user interface of an assistant application on a communication device of a store assistant for multiple anonymous shoppers identified in the retail store.

FIG. 10C exemplarily illustrates a screenshot of a graphical user interface of the assistant application rendered on the communication device of the store assistant, showing feedback on a communication initiated with an anonymous shopper identified in the retail store.

FIGS. 10D-10F exemplarily illustrate screenshots of a graphical user interface of the manager application on the communication device of the store manager, showing a live stream from sensors in the retail store.

FIGS. 10G-10J exemplarily illustrate screenshots of a graphical user interface of the manager application on the communication device of the store manager, showing shopper conversion dashboards and retail store analytics reports generated by the purchase intent determination and assistance management system.

FIGS. 11A-11B exemplarily illustrate images captured by sensors positioned at configured regions of interest in a retail store.

FIGS. 12A-12B exemplarily illustrate scatter graphs of dwell time distributions of anonymous shoppers identified in the configured regions of interest exemplarily illustrated in FIGS. 11A-11B.

FIG. 13 exemplarily illustrates a scatter graph of dwell time distributions of anonymous shoppers identified in the configured region of interest exemplarily illustrated in FIG. 11A, showing the number of alert notifications generated by the purchase intent determination and assistance management system based on a onetime dwell time threshold configuration.

FIG. 14 exemplarily illustrates a tabular representation of the number of alert notifications generated by the purchase intent determination and assistance management system based on a onetime dwell time threshold configuration for the configured region of interest exemplarily illustrated in FIG. 11A.

FIG. 15 exemplarily illustrates a scatter graph of dwell time distributions of anonymous shoppers identified in the configured region of interest exemplarily illustrated in FIG. 11B, showing the number of alert notifications generated by the purchase intent determination and assistance management system based on a onetime dwell time threshold configuration.

FIG. 16 exemplarily illustrates a tabular representation of the number of alert notifications generated by the purchase intent determination and assistance management system based on a onetime dwell time threshold configuration for the configured region of interest exemplarily illustrated in FIG. 11B.

FIG. 17 exemplarily illustrates a scatter graph of dwell time distributions of anonymous shoppers identified in the configured region of interest exemplarily illustrated in FIG. 11A, showing dwell time thresholds dynamically generated by the purchase intent determination and assistance management system using iterative statistical models.

FIG. 18 exemplarily illustrates a tabular representation of the number of alert notifications generated by the purchase intent determination and assistance management system based on the dwell time thresholds dynamically generated using the iterative statistical models associated with the configured region of interest exemplarily illustrated in FIG. 11A.

FIG. 19 exemplarily illustrates a scatter graph of dwell time distributions of anonymous shoppers identified in the configured region of interest exemplarily illustrated in FIG. 11B, showing dwell time thresholds dynamically generated by the purchase intent determination and assistance management system using the iterative statistical models.

FIG. 20 exemplarily illustrates a tabular representation of the number of alert notifications generated by the purchase intent determination and assistance management system based on the dwell time thresholds dynamically generated using the iterative statistical models associated with the configured region of interest exemplarily illustrated in FIG. 11B.

FIG. 21 exemplarily illustrates a scatter graph of dwell time distributions of anonymous shoppers identified in the configured region of interest exemplarily illustrated in FIG. 11A, showing dwell time thresholds dynamically generated by the purchase intent determination and assistance management system using iterative statistical models trained on weather conditions and shift roster data.

FIG. 22 exemplarily illustrates a tabular representation of the dwell time thresholds dynamically generated by the purchase intent determination and assistance management system using the iterative statistical models trained on weather conditions and shift roster data of the configured region of interest exemplarily illustrated in FIG. 11A.

FIG. 23 exemplarily illustrates a scatter graph of dwell time distributions of anonymous shoppers identified in the configured region of interest exemplarily illustrated in FIG. 11B, showing dwell time thresholds dynamically generated by the purchase intent determination and assistance management system using the iterative statistical models trained on weather conditions and shift roster data.

FIG. 24 exemplarily illustrates a tabular representation of the dwell time thresholds dynamically generated by the purchase intent determination and assistance management system using the iterative statistical models trained on weather conditions and shift roster data of the configured region of interest exemplarily illustrated in FIG. 11B.

### DETAILED DESCRIPTION OF THE INVENTION

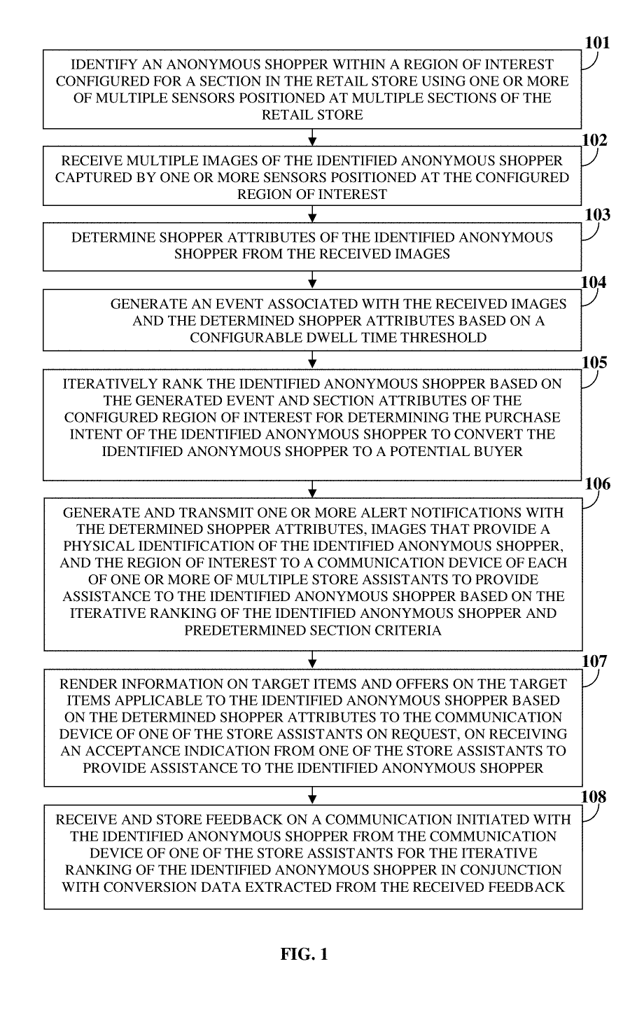

FIG. 1 illustrates a method for determining purchase intent of an anonymous shopper in a retail store and providing assistance to the anonymous shopper in the retail store based on the determined purchase intent in real time. As used herein, “purchase intent” refers to a probability or a likelihood of a shopper's aim to direct his or her actions towards purchasing an item, for example, a product or a service. The method disclosed herein identifies the highest likelihood of purchasing among anonymous shoppers and assists the anonymous shoppers by identifying an appropriate store assistant within a physical retail store, using sensors. As used herein, the term “sensors” refers to image capture devices, for example, digital cameras, video cameras, video recorders, surveillance cameras, smart phones and tablet computing devices with image capture capabilities, other sensory devices, visual sensors, etc. One or more sensors are positioned at one or more sections of the retail store.

The method disclosed herein employs a purchase intent determination and assistance management system (PIDAMS) comprising at least one processor configured to execute computer program instructions for determining purchase intent of an anonymous shopper in a retail store and providing assistance to the anonymous shopper in the retail store based on the determined purchase intent. In an embodiment, the PIDAMS is implemented in a cloud computing environment. As used herein, “cloud computing environment” refers to a processing environment comprising configurable computing physical and logical resources, for example, networks, servers, storage media, virtual machines, applications, services, etc., and data distributed over a network, for example, the internet. The cloud computing environment provides on-demand network access to a shared pool of the configurable computing physical and logical resources. In an embodiment, the PIDAMS is a cloud based platform implemented as a service for determining purchase intent of an anonymous shopper in a retail store and providing assistance to the anonymous shopper in the retail store based on the determined purchase intent. The PIDAMS is developed using one of the cloud platforms selected, for example, from the Google App engine cloud infrastructure of Google Inc., Amazon Web Services® of Amazon Technologies, Inc., the Amazon elastic compute cloud EC2® web service of Amazon Technologies, Inc., the Google® Cloud platform of Google Inc., the Microsoft® Cloud platform of Microsoft Corporation, etc.

The purchase intent determination and assistance management system (PIDAMS) identifies 101 an anonymous shopper within a region of interest configured for a section in the retail store using one or more of the sensors positioned at multiple sections of the retail store. As used herein, the term “section” refers to a particular area classified in the retail store based on a type of product stored in the area. The sections of the retail store comprise, for example, electronics, sports equipment, stationary, toys, etc. The PIDAMS classifies sections in the retail store that are of interest for determining shopper attributes. Also, as used herein, “region of interest” refers to an area defined by a store manager of the retail store, within a field of view of a sensor in a section of the retail store. In an embodiment, the PIDAMS creates multiple regions of interest within a field of view of a sensor. The PIDAMS creates the regions of interest based on a mapping of images captured by the sensors on a floor plan for each section of the retail store. In an embodiment, the PIDAMS creates the regions of interest based on a mapping of the sensors on a floor plan for each section of the retail store using mapping services. The mapping services comprise, for example, planograms, Google® maps of Google Inc., static maps, etc. The PIDAMS maps the section of interest to one or more regions of interest.

One or more of the sensors positioned in a section of the retail store capture multiple images at the configured region of interest. In an embodiment, one or more of the sensors, for example, the video cameras, the video recorders, the surveillance cameras, etc., positioned in a section of the retail store record a live video in the section of the retail store. The purchase intent determination and assistance management system (PIDAMS) extracts snapshots or video frames from the recorded video. The PIDAMS processes the extracted video frames or the captured images and extracts objects from the extracted video frames or the captured images. The PIDAMS filters the extracted objects and identifies anonymous shoppers in the section of the retail store. For an identified anonymous shopper, the PIDAMS allows a store manager of the retail store to mark a region of interest, for example, by drawing a polygon over a live video or a snapshot received from a sensor positioned at the retail store.

The purchase intent determination and assistance management system (PIDAMS) receives 102 multiple images of the identified anonymous shopper captured by one or more of the sensors positioned at the configured region of interest. The sensors capture images of the identified anonymous shopper and transmit the captured images to the PIDAMS via a network, for example, the internet, an intranet, a wired network, a wireless network, a network that implements Bluetooth® of Bluetooth Sig, Inc., a network that implements Wi-Fi® of Wi-Fi Alliance Corporation, etc. The PIDAMS receives the captured images from the sensors. The images captured by the sensors and received by the PIDAMS are transformed, processed, and executed by an algorithm in the PIDAMS for determining shopper attributes of the identified anonymous shopper. The sensors track the identified anonymous shopper and obtain metadata from the tracked data. The metadata comprises, for example, sensor identification (ID), trackscount, track ID, trackdatabase ID, region of interest ID (ROIID), region of interest name (ROI name), etc.

The purchase intent determination and assistance management system (PIDAMS) determines 103 shopper attributes of the identified anonymous shopper from the received images. The shopper attributes of the identified anonymous shopper comprise, for example, dwell time, sections of dwell, an age range, gender, prominent colour of a clothing worn by the identified anonymous shopper, whether the identified anonymous shopper is accompanied by another shopper such as a family member, location, date, time, etc. As used herein, “dwell time” refers to time spent by a shopper within an identified region of interest in a particular section of the retail store. The PIDAMS implements multiple image processing techniques to process the received images and determine the shopper attributes of the identified anonymous shopper from the received images. The PIDAMS allows a retailer to analyze the identified anonymous shopper's behaviour through the shopper attributes to target, sell, and improve a product. In an embodiment, the PIDAMS is equipped to process data received from multiple different sensors.

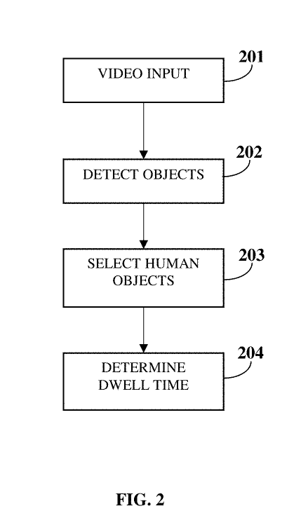

The purchase intent determination and assistance management system (PIDAMS) determines the dwell time of the identified anonymous shopper from the received images as follows. The PIDAMS extracts one or more objects from the received images, determines one or more human objects from the extracted objects based on predefined criteria, determines persistence of the identified anonymous shopper from the determined human objects at the configured region of interest, and computes the dwell time of the identified anonymous shopper based on the determined persistence by calculating a duration of presence of the identified anonymous shopper at the configured region of interest as disclosed in the detailed description of FIGS. 2-4.

The purchase intent determination and assistance management system (PIDAMS) determines the sections of dwell of the identified anonymous shopper by using a floor plan of the retail store. From the received images, the PIDAMS extracts a first appearance of the identified anonymous shopper using extracted motion information, background subtraction, and offline trained models for detecting a human. By using pertained body shape models for male and female, the PIDAMS determines the gender of the identified anonymous shopper. Furthermore, using facial feature points and pertained face models, the PIDAMS determines finer details of the identified anonymous shopper, for example, age and gender of the identified anonymous shopper. The PIDAMS detects colour of the clothing worn by the identified anonymous shopper using colour image processing techniques. The PIDAMS further identifies the number of human objects in the received images and their proximity to each other to determine whether the identified anonymous shopper is accompanied by another shopper such as a family member. The PIDAMS identifies family members of the identified anonymous shopper, for example, depending on size and location obtained from the extracted motion information of the identified anonymous shopper, number of shoppers detected in close proximity of the identified anonymous shopper, and a duration over which the identified anonymous shopper and the shoppers stay in close proximity to each other. A generic computer using a generic program cannot determine shopper attributes of the identified anonymous shopper from the received images in accordance with the method steps disclosed above.

The purchase intent determination and assistance management system (PIDAMS) generates 104 an event associated with the received images and the determined shopper attributes based on a configurable dwell time threshold. As used herein, the term “event” is defined by an action of the identified anonymous shopper, for example, entry and exit of the identified anonymous shopper in a configured region of interest, dwell time of the identified anonymous shopper in the configured region of interest, etc., recognized by the PIDAMS and handled subsequently by the PIDAMS. The PIDAMS executes an event loop corresponding to the event on recognizing occurrence of the event. Using the determined shopper attributes, the PIDAMS obtains an entry time and an exit time of the identified anonymous shopper in a configured region of interest and computes the dwell time of the identified anonymous shopper in the configured region of interest. The PIDAMS repeatedly extracts the appearance of the identified anonymous shopper in consecutive image frames to determine the total time or the dwell time that the identified anonymous shopper spends in the configured region of interest. The PIDAMS compares the computed dwell time with the dwell time threshold configured by the PIDAMS. The PIDAMS generates an event when the computed dwell time reaches the dwell time threshold. In an embodiment, the PIDAMS is hosted on a central server or a network of servers comprising a central server and an analytics server. In this embodiment, the central server generates the event when the computed dwell time of the identified anonymous shopper reaches the dwell time threshold and transmits the generated event to the analytics server along with metadata comprising, for example, the metadata of the received images, the determined shopper attributes, section information such as a section identifier, etc., via the network. The data structure of the event is disclosed below:

Content-Type: application/json
{
“response”: {
“status”: 0,
“trackscount”: 9098,
“track”: [

{
“cameraId”: “Cam5501”,
“trackdbid”: 1953136,
“roiinfo”: [

{
“time”: 0,
“roiId”: “ROI1”,
“roiName”: “ROI12001101”
},
{
“time”: 1,
“roiId”: “ROI2”,
“roiName”: “ROI12001102”
}

],

“trackid”: 352946,
“timestamp”: 1469476806,
“entry”: “126|227”,
“exit”: “0|263”,
“dwelltime”: 12
}
]

}
}

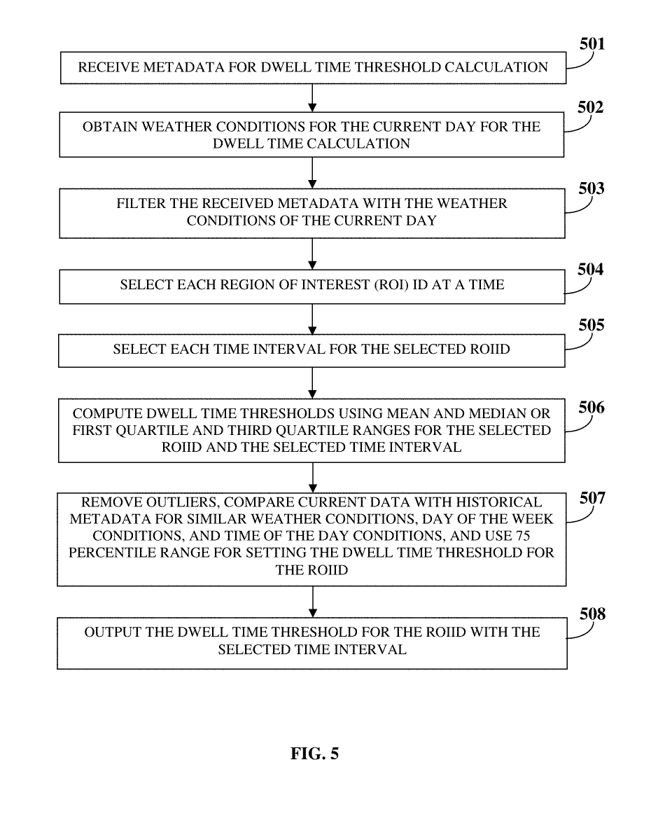

The purchase intent determination and assistance management system (PIDAMS) dynamically configures the dwell time threshold using iterative statistical models based on iterative statistical inputs as disclosed in the detailed description of FIG. 5. The iterative statistical inputs comprise, for example, time of day, day of week, promotions in the configured region of interest, shopper demographics, climatic conditions at the location of the retail store, for example, temperature of the configured region of interest, etc. In an example, if a retailer offers promotions in a configured region of interest, the PIDAMS configures a short dwell time threshold of about 3 minutes. In this example, if the identified anonymous shopper dwells at the configured region of interest beyond 3 minutes, the central server of the PIDAMS generates an event and transmits the generated event to the analytics server along with metadata comprising, for example, the received images, the determined shopper attributes, section information such as a section identifier, etc., via the network. In another example, on a day of a weekend, for example, Saturday, as shoppers may have more time to shop, the PIDAMS configures a longer dwell time threshold of about 5 minutes at a configured region of interest. In this example, if the identified anonymous shopper dwells at the configured region of interest beyond 5 minutes, the central server of the PIDAMS generates an event and transmits the generated event to the analytics server along with metadata comprising, for example, the received images, the determined shopper attributes, section information such as a section identifier, etc., via the network.

The purchase intent determination and assistance management system (PIDAMS) computes and refines the dwell time threshold periodically based on the iterative statistical inputs. The PIDAMS extracts daily climatic conditions, for example, minimum temperature, maximum temperature, weather conditions such as raining, snowing, thunder storm, etc., at the location of the retail store. The shopper demographics, for example, gender and age also affect the configuration of the dwell time threshold. If the shoppers include only children, or only adults, or adults accompanied by family, for example, by children, the PIDAMS configures the dwell time thresholds differently. In an example, if the identified anonymous shopper is single, the identified anonymous shopper may spend less time in a configured region of interest, and hence, the PIDAMS configures a short dwell time threshold at the configured region of interest. In another example, if the identified anonymous shopper is accompanied by a child, the identified anonymous shopper may spend more time in a configured region of interest of a section, for example, a stationary section or a toy section of the retail store. The PIDAMS, in this example, configures a longer dwell time threshold at the configured region of interest of the stationary section or the toy section of the retail store.

Consider another example where the climatic condition at the location of a retail store is raining. The identified anonymous shopper may stay in the retail store for a long time until the rain subsides. The identified anonymous shopper may spend more time in the configured region of interest or may explore another section, for example, a section for raincoats, umbrellas, etc. Thus, the dwell time of the identified anonymous shopper is increased in the retail store. In this example, the purchase intent determination and assistance management system (PIDAMS) configures a longer dwell time threshold at the configured region of interest or at the explored section. The PIDAMS processes climatic conditions, time of day, day of week, promotions in the configured region of interest, value of merchandise, number of shoppers in the retail store, number of store assistants, dwell time, etc., along with historical dwell time data of shoppers through iterative statistical models to define patterns and set dwell time thresholds based on observed behaviour of shoppers in the configured regions of interest at the retail store. Historical dwell time data in a configured region of interest comprises dwell time of shoppers in the configured region of interest corresponding to the iterative statistical inputs over a duration of time in the past. A generic computer using a generic program cannot generate an event associated with the received images and the determined shopper attributes based on a configurable dwell time threshold in accordance with the method steps disclosed above.

The purchase intent determination and assistance management system (PIDAMS) iteratively ranks 105 the identified anonymous shopper based on the generated event and section attributes of the configured region of interest by implementing a ranking algorithm, for determining the purchase intent of the identified anonymous shopper to convert the identified anonymous shopper into a potential buyer. The section attributes comprise, for example, time of day, day of week, section value, store sales, offers, and other shopper conversion elements. At least one processor of the PIDAMS executes the ranking algorithm to iteratively rank the identified anonymous shopper based on the generated event and the section attributes of the configured region of interest. The output of the ranking algorithm is a score ranking the identified anonymous shopper based on the generated event and the section attributes of the configured region of interest. An identified anonymous shopper with a higher score, ranks high and is identified as a potential buyer.

In an embodiment, the purchase intent determination and assistance management system (PIDAMS) performs ranking of the identified anonymous shopper using a machine learning recommendation algorithm that uses iterative statistical models. As used herein, “machine learning recommendation algorithm” refers to a machine learning algorithm used for predicting a rating or a score of the identified anonymous shopper. A machine learning algorithm is an algorithm executed by the PIDAMS for performing machine learning, that is, a type of artificial intelligence that provides processors with an ability to learn from and make predictions on data without being explicitly programmed. A machine learning algorithm searches for a pattern in data used for training the machine learning algorithm and uses the pattern to detect patterns in new data and adjust program actions accordingly. The iterative statistical models used for ranking by the PIDAMS comprise, for example, linear regression models, logistic regression models, etc. The machine learning recommendation algorithm using the iterative statistical models is trained and tested on training data and test data. The training data and the test data constitute historical ranking data comprising combinations of the generated events and the section attributes, and corresponding ranks associated with the identified anonymous shoppers over a duration of time.

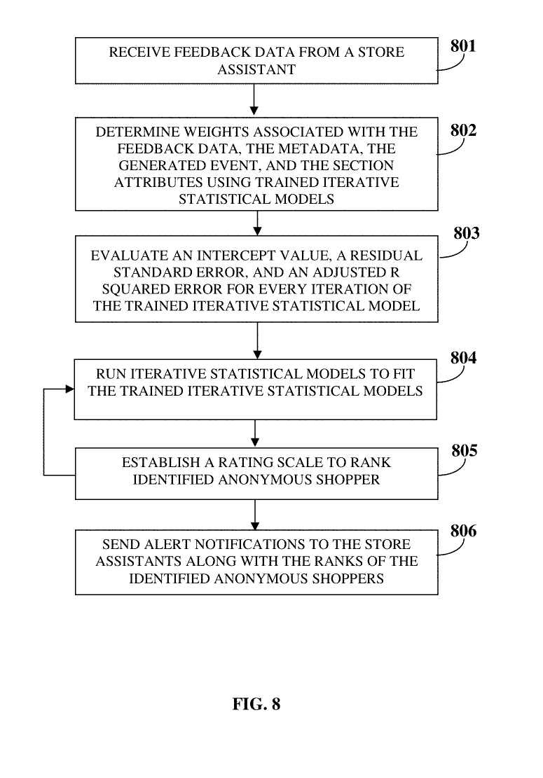

The purchase intent determination and assistance management system (PIDAMS) divides the historical ranking data into the training data and the test data. The PIDAMS divides, for example, 60% of the historical ranking data as the training data and 40% of the historical ranking data as the test data. As used herein, “training data” refers to labeled data comprising pairs of input values and predetermined output values for training the machine learning recommendation algorithm. On training the machine learning recommendation algorithm using iterative statistical models with the training data, trained iterative statistical models are obtained. The generated event and the section attributes in real time are input to the trained iterative statistical models and the trained iterative statistical models rank the identified anonymous shopper in real time to identify a likelihood of shopper conversion. The ranking of the identified anonymous shopper based on the generated event and the section attributes is disclosed in the detailed description of FIG. 8. A generic computer using a generic program cannot iteratively rank the identified anonymous shopper based on the generated event and the section attributes of the configured region of interest for determining the purchase intent of the identified anonymous shopper to convert the identified anonymous shopper into a potential buyer in accordance with the method steps disclosed above.

The purchase intent determination and assistance management system (PIDAMS) generates and transmits 106 one or more alert notifications with the determined shopper attributes, images that provide a physical identification of the identified anonymous shopper, and the region of interest to a communication device, for example, a smartphone, a tablet computing device, a mobile phone, a personal digital assistant, etc., of each of one or more of multiple store assistants in the retail store via the network to provide assistance to the identified anonymous shopper based on the iterative ranking of the identifier anonymous shopper and predetermined section criteria. The predetermined section criteria comprise, for example, section value, type of the section, number of available store assistants assigned to the section, etc. For example, if the PIDAMS assigns a high rank to the identified anonymous shopper and if the retail store is offering a 50% discount on sports equipment determined as a preference of the identified anonymous shopper, and if there are many available store assistants in the retail store, the PIDAMS generates and transmits one or more alert notifications with the determined shopper attributes, images that provide a physical identification of the identified anonymous shopper, and the region of interest to the available store assistants' communication devices via the network in real time to allow the available store assistants to provide immediate assistance to the identified anonymous shopper. The PIDAMS transmits the alert notifications to the communication devices of the available store assistants, for example, via a voice communication, short message service (SMS) messages, mobile instant messages via instant messengers installed on the communication devices, audio alerts, etc.

In an embodiment, the purchase intent determination and assistance management system (PIDAMS) calculates a number of alert notifications to be transmitted to the communication device of each of the store assistants based on a percentage of time allocated to assist the identified anonymous shopper and a number of available store assistants to assist the identified anonymous shopper. The PIDAMS transmits the alert notifications with the required visual and textual identifiers to the available store assistants' communication devices based on the calculated number of alert notifications.

In an embodiment, the purchase intent determination and assistance management system (PIDAMS) transmits the alert notifications to one or more store assistants through a mobile application, hereafter referred to as an “assistant application”, deployed on the communication device of each of the store assistants. In an example, the PIDAMS transmits a push notification to the most appropriate store assistant with visual cues of the identified anonymous shopper including the region of interest via the assistant application deployed on the store assistant's communication device. The store assistants provide assistance to the identified anonymous shopper to clarify questions that the identified anonymous shopper may have with an intent to convert the identified anonymous shopper into a potential buyer. In another example, if multiple events are sent to the communication devices of store assistants manning complementary sections, the PIDAMS transmits alert notifications based on the number of store assistants and the section value. The store assistants may accept or reject the alert notifications. A generic computer using a generic program cannot generate and transmit one or more alert notifications with the determined shopper attributes, images that provide a physical identification of the identified anonymous shopper, and the region of interest to communication devices of multiple store assistants via the network to provide assistance to the identified anonymous shopper based on the iterative ranking of the identifier anonymous shopper and the predetermined section criteria in accordance with the method steps disclosed above.

In an embodiment, the purchase intent determination and assistance management system (PIDAMS) generates and renders a consolidated view of the generated alert notifications on a graphical user interface (GUI) provided by a manager application deployable on a communication device of a store manager for assignment of the generated alert notifications to the store assistants. In an embodiment, the manager application is a web application. In another embodiment, the manager application is a mobile application. A generic computer using a generic program cannot generate and render a consolidated view of the generated alert notifications on the GUI of the manager application on the store manager's communication device for assignment of the generated alert notifications to one or more store assistants in accordance with the method steps disclosed above.

On receiving an acceptance indication from at least one of the store assistants to provide assistance to the identified anonymous shopper, the purchase intent determination and assistance management system (PIDAMS) renders 107 information on target items and offers on the target items applicable to the identified anonymous shopper based on the determined shopper attributes to the store assistant's communication device on request via the network. If a store assistant accepts the alert notification indicating his or her intent to assist the identified anonymous shopper, the store assistant may proceed to observe the identified anonymous shopper and query the PIDAMS for additional information on target items. For example, based on observing the identified anonymous shopper, prior to meeting the identified anonymous shopper, the store assistant selects one or more categories and sub categories of the target items on which the identified anonymous shopper spends time on a graphical user interface (GUI) provided by the assistant application on the store assistant's communication device, and queries the PIDAMS for additional information. On receiving the query from the assistant application on the store assistant's communication device, the PIDAMS prompts the store assistant, for example, with “Hot selling products”, trending products, offers, discounts, etc., on the GUI of the assistant application. A generic computer using a generic program cannot render information on target items and offers on the target items applicable to the identified anonymous shopper based on the determined shopper attributes to the store assistant's communication device on request via the network in accordance with the method steps disclosed above.

Equipped with the additional information prompted by the purchase intent determination and assistance management system (PIDAMS), the store assistant can proceed to meet the identified anonymous shopper at the section of interest, and communicate, that is, have an offline conversation with the identified anonymous shopper and assist the identified anonymous by addressing any questions the identified anonymous shopper may have. After communicating with the identified anonymous shopper, the store assistant shares feedback, for example, by rating the conversation, with the PIDAMS through the graphical user interface (GUI) of the assistant application. That is, the assistant application transmits the feedback shared by the store assistant to the PIDAMS, for example, via the network. The PIDAMS receives and stores 108 the feedback on the communication initiated with the identified anonymous shopper from the assistant application on the store assistant's communication device for further iteratively ranking the identified anonymous shopper in conjunction with conversion data extracted from the feedback received from the assistant application on the store assistant's communication device. The conversion data refers to a ratio of a number of shoppers who have transacted at the retail store to a number of alert notifications accepted by the store assistants over a duration of time. Conversion data is an indication of the number of identified anonymous shoppers who have converted from potential buyers into buyers.

In an embodiment, the assistant application displays a customizable interactive feedback form, for example, in the form of a questionnaire on the graphical user interface (GUI) of the assistant application to facilitate gathering of shopper behaviour insight and conversions of potential buyers into buyers at the retail store. The feedback provided by the store assistant via the GUI of the assistant application comprises responses to the questionnaire on the behaviour of the identified anonymous shopper in the configured region of interest, for example, whether the identified anonymous shopper needed assistance, whether he or she found his or her desired product, whether the identified anonymous shopper is a value shopper or a frequent shopper, whether the store assistant recommended a product, whether the identified anonymous shopper showed interest in the recommendation, etc.

Consider an example where the purchase intent determination and assistance management system (PIDAMS) identifies 230 anonymous shoppers in a retail store. The PIDAMS ranks the identified anonymous shoppers and generates and transmits 100 alert notifications to the communication devices of the store assistants. Out of the 100 alert notifications sent, the store assistants accept 60 alert notifications and start to assist the 60 ranked anonymous shoppers. Out of the 60 ranked anonymous shoppers, the store assistant provides feedback that only 30 needed assistance in selecting products of their choice. Out of the 30 ranked anonymous shoppers who needed assistance, only 15 ranked anonymous shoppers actually transacted at the retail store. The conversion data is the number of ranked anonymous shoppers who actually transacted at the retail store divided by the number of alert notifications accepted by the store assistants=15/60=0.25.

The purchase intent determination and assistance management system (PIDAMS) utilizes the feedback from the store assistants as an additional parameter in ranking the identified anonymous shopper along with conversion data of the retail store. The iterative statistical models learn about the identified anonymous shopper's behaviour and consume this information in the next iterative run, thereby strengthening the machine learning recommendation algorithm executed by the PIDAMS. In an embodiment, the PIDAMS calculates a confidence score estimating performance of the trained iterative statistical models in ranking the identified anonymous shopper based on the generated events, the section attributes, the feedback, the conversion data, and the number of store assistants available to assist the identified anonymous shopper in real time by cross validating the rank generated by the trained iterative statistical models for a labeled input of the generated events, the section attributes, the feedback, the conversion data, and the number of store assistants available to assist the identified anonymous shopper. A generic computer using a generic program cannot receive and store feedback on the communication initiated with the identified anonymous shopper from the assistant application on the store assistant's communication device for further iteratively ranking the identified anonymous shopper in conjunction with the conversion data in accordance with the method steps disclosed above. The accuracy of the iterative statistical models increases when sales data of the retail store is integrated with the PIDAMS, if the retail store shares the sales data. “Sales data” refers to transactional data of the retail store generated from purchases made by the identified anonymous shoppers. In an embodiment, the sales data is used to validate whether an identified anonymous shopper who needed assistance made a purchase of a selected product.

In an embodiment, the purchase intent determination and assistance management system (PIDAMS) generates one or more retail store analytics reports comprising the conversion data, the sales data, the number of generated alert notifications, and the section attributes of the configured region of interest for analyzing purchase intent of anonymous shoppers in the retail store over a duration of time. The PIDAMS renders the generated retail store analytics reports on the graphical user interface (GUI) provided by the manager application deployable on the communication device of the store manager. The retail store analytics reports are data visualization tools providing a consolidated view of conversion data, sales data, number of alert notifications generated, etc., to draw inferences on current performance of the retail store. The PIDAMS generates a variety of retail store analytics reports, for example, shopper conversion dashboards, a dwell time dashboard report, a site traffic analytics report, etc. In an embodiment, the retail store analytics reports are configured as drill down reports. The retail store analytics reports assist the store manager in analyzing purchase intent of the anonymous shoppers and accordingly plan placement of products, introduction of offers and incentives, A/B or split testing of promotions, etc., to maximize profit of the retail store over a predetermined duration of time. A/B testing compares two promotions, namely, A and B, and determines which promotion performs better. The retail analytics reports comprise line charts, pie charts, bar charts, gauges, tables, etc., indicating different shopper attributes, section attributes, conversion data, sales data, etc., per section of the retail store over a selected duration of time. The store manager can access the retail store analytics reports on the GUI of the manager application deployed on the store manager's communication device. The store manager can also access sensor configuration, region of interest configuration, shift roster data of the retail store, a sales calendar of the retail store, etc., via the GUI of the manager application.

Consider an example of determining purchase intent of an anonymous shopper in a retail store and providing assistance to the anonymous shopper in the retail store based on the determined purchase intent. The purchase intent determination and assistance management system (PIDAMS) defines an initial dwell time threshold for an anonymous shopper. The PIDAMS receives video feeds of a section of the retail store from sensors, for example, cameras, and overlays those video feeds on a floor plan of the retail store to allow the store manager to mark one or more particular sections of the retail store in view of the sensors as regions of interest using the manager application deployed on the store manager's communication device. The PIDAMS captures dwell times of anonymous shoppers over a sustained period of time on different days, time of day, and days of a week. The PIDAMS dynamically processes the dwell times on the analytics server and then dynamically predicts and sets a dwell time threshold for each marked region of interest. In an embodiment, the PIDAMS transmits the output comprising the dwell times to a video analytics server for an automatic configuration of dwell time thresholds. The video analytics server captures the region of interest, the section of interest, the dwell time, and other shopper attributes when an anonymous shopper identified within the marked region of interest meets the dynamically set dwell time threshold, and generates an event. The video analytics server transmits the captured information to the analytics server which further performs a lookup to match the shopper attributes with pre-processed shopper behaviour attributes. The PIDAMS then ranks the identified anonymous shopper based on the generated event for determining the purchase intent of the identified anonymous shopper to convert the identified anonymous shopper into a potential buyer. The PIDAMS ranks the identified anonymous shopper and further performs a lookup of the number of store assistants assigned to the marked region of interest, their predefined percentage to serve, and their availability for a given shift, and then calculates the number of alert notifications to be sent. The PIDAMS equipped with all this information sends the appropriate number of alert notifications to the store assistants based on the ranking of the identified anonymous shopper.

The purchase intent determination and assistance management system (PIDAMS) further determines products with offers, trending products, and other target items by a lookup in store systems of the retail store and renders the necessary information to the assistant application on the communication device of the store assistant who accepted the alert notification. An available store assistant equipped with this information has an offline discussion with the identified anonymous shopper. The store assistant then posts the discussion and captures the feedback of the concluded discussion in the form of a rating. The PIDAMS transmits the information to the analytics server for further processing and increases the accuracy of iterative statistical models of the PIDAMS.

The purchase intent determination and assistance management system (PIDAMS) implements one or more specific computer programs to identify the anonymous shopper within a configured region of interest in a retail store, determine the shopper attributes of the identified anonymous shopper, iteratively rank the identified anonymous shopper, determine purchase intent of the identified anonymous shopper, generate alert notifications to be transmitted to store assistants to provide assistance to the identified anonymous shopper, and store feedback on the communication initiated with the identified anonymous shopper for the iterative ranking of the identified anonymous shopper. The data inputted to the PIDAMS, for example, video images of the identified anonymous shopper is transformed, processed, and executed by an algorithm in the PIDAMS. The PIDAMS dynamically processes the video images to extract human objects to identify anonymous shoppers, and determine dwell time and other shopper attributes of the identified anonymous shopper for each region of interest. The PIDAMS processes and transforms the video images into shopper attributes to iteratively rank the identified anonymous shopper, determine purchase intent of the identified anonymous shopper, and generate one or more alert notifications to alert available store assistants to assist the identified anonymous shopper and transform the identified anonymous shopper into a potential buyer.

In the method disclosed herein, the design and flow of data between the sensors, the purchase intent determination and assistance management system (PIDAMS), and the communication devices of the store manager and the store assistants are deliberate, designed, and directed. Every communication with the sensors and the communication devices of the store manager and the store assistants and processing step performed by the PIDAMS steers the method disclosed herein towards a finite set of predictable outcomes. The PIDAMS implements one or more specific computer programs to determine one or more shopper attributes of the identified anonymous shopper within a configured region of interest and direct the method towards a set of end results. The communications established by the PIDAMS allow the PIDAMS to receive the image output from the sensors and identify the anonymous shopper in a configured region of interest, and from this information, through the use of other, separate and autonomous computer programs, infer the shopper attributes. This inference is used as a trigger to generate an event based on the configurable dwell time threshold, iteratively rank the identified anonymous shopper, generate alert notifications to alert available store assistants to assist the identified anonymous shopper, and render information on special offers that are most relevant and attractive to the identified anonymous shopper.

The interactions between the sensors and the purchase intent determination and assistance management system (PIDAMS) allow the PIDAMS to identify an anonymous shopper within a region of interest configured for a section in the retail store, process images captured by the sensors, and determine shopper attributes from the captured images. From this data, the PIDAMS, through the use of other, separate and autonomous computer programs, transforms the shopper attributes for generating an event based on a configurable dwell time threshold, iteratively ranking the identified anonymous shopper, and generating alert notifications to be transmitted to available store assistants. The interactions between the sensors, the PIDAMS, the assistant application on each of the store assistants' communication devices, and the manager application on the store manager's communication device allow the PIDAMS to determine the purchase intent of the identified anonymous shopper, transmit the generated alert notifications to the store assistants' communication devices, render information on target items and offers on the target items applicable to the identified anonymous shopper to the store assistants' communication devices, and receive and store feedback for iteratively ranking the identified anonymous shopper in conjunction with conversion data extracted from the feedback received from the communication devices of the store assistants of the retail store.

Through the method steps 101, 102, 103, 104, 105, 106, 107, and 108 disclosed above, the purchase intent determination and assistance management system (PIDAMS) determines purchase intent of the identified anonymous shopper and transforms the identified anonymous shopper into a potential buyer based on the iterative ranking of the identified anonymous shopper. The method steps 101, 102, 103, 104, 105, 106, 107, and 108 require eight or more separate computer programs and subprograms, the execution of which cannot be performed by a person using a generic computer with a generic program. The store assistants may also share the feedback of the identified anonymous shopper with the PIDAMS to improve the chances of conversion of the identified anonymous shopper into a potential buyer in future. The PIDAMS utilizes the feedback received from the store assistant regarding the previously identified anonymous shopper to iteratively rank the identified anonymous shopper based on the number of available store assistants. The method steps 101, 102, 103, 104, 105, 106, 107, and 108 performed by the PIDAMS are tangible, provide useful results, and are not abstract. The software implementation of the PIDAMS and operable coupling of the sensors, the assistant application on each store assistant's communication device, and the manager application on the store manager's communication device with the PIDAMS are improvements in computer related technology.

The method disclosed herein provides an improvement in computer related technology for determining purchase intent of an anonymous shopper in a retail store and providing assistance to the anonymous shopper based on the determined purchase intent as follows. On implementing the method disclosed herein, the purchase intent determination and assistance management system (PIDAMS) identifies an anonymous shopper within a region of interest configured for a section in the retail store using visual sensors. The PIDAMS determines the shopper attributes of the identified anonymous shopper from the images captured from the visual sensors. The PIDAMS iteratively ranks the identified anonymous shopper and generates and transmits one or more alert notifications to an available store assistant to provide assistance to the identified anonymous shopper. The PIDAMS utilizes the feedback from the store assistant to iteratively rank the identified anonymous shopper and convert the identified anonymous shopper into a potential buyer. The PIDAMS utilizes the shopper attributes to interpret an anonymous shopper's purchase intent and decisions, and generates insights that will help retailers develop optimally targeted programs to activate their products and brands in-store. The PIDAMS utilizes the determined purchase intent of the anonymous shopper to identify motives that prompt the anonymous shopper to purchase a product so that a product manufacturer can offer a complete product that satisfies the anonymous shopper's needs. The shopper attributes, the ranking of the anonymous shoppers, and feedback obtained by the PIDAMS provide detailed information that is used to develop specific targeted marketing strategies that are directed toward each individual anonymous shopper while taking into account actual shopper reactions to product placement in a particular retail store or to other factors that influence product purchases by anonymous shoppers. The dwell time determined by the PIDAMS facilitates measurement of effectiveness of a product display or attractiveness of a product. Being able to measure these shopper attributes can help with store layout planning and identification of regions of interest for optimizing products and product displays and their placement in the retail store to improve shopper experience in the retail store and generate revenue. The PIDAMS utilizes potential dynamic shopper data elements comprising, for example, the shopper attributes that are available for identifying anonymous shoppers who should be encouraged to shop at the retail store, anonymous shoppers who should be targeted as potential buyers, anonymous shoppers that have the highest likelihood of purchasing, etc.

The focus of the method and the purchase intent determination and assistance management system (PIDAMS) disclosed herein is an improvement to computer functionality itself, and not on economic or other tasks for which a generic computer is used in its ordinary capacity. Accordingly, the method and the PIDAMS disclosed herein are not directed to an abstract idea. Rather, the method and the PIDAMS disclosed herein are directed to a specific improvement to identifying an anonymous shopper and recognizing purchase intent of the anonymous shopper to influence sales and the way the sensors and the PIDAMS operate, embodied in, for example, determining shopper attributes, dynamically configuring the dwell time threshold, generating an event based on the configurable dwell time threshold, iteratively ranking the identified anonymous shopper, generating and transmitting one or more alert notifications to the communication device of at least one of the store assistants of the retail store, rendering information on target items and offers on target items applicable to the identified anonymous shopper based on the determined shopper attributes, and receiving and storing feedback on a communication initiated with the identified anonymous shopper from the communication devices of the store assistants for iterative ranking of the identified anonymous shopper in conjunction with conversion data extracted from the feedback received from the communication devices of the store assistants.

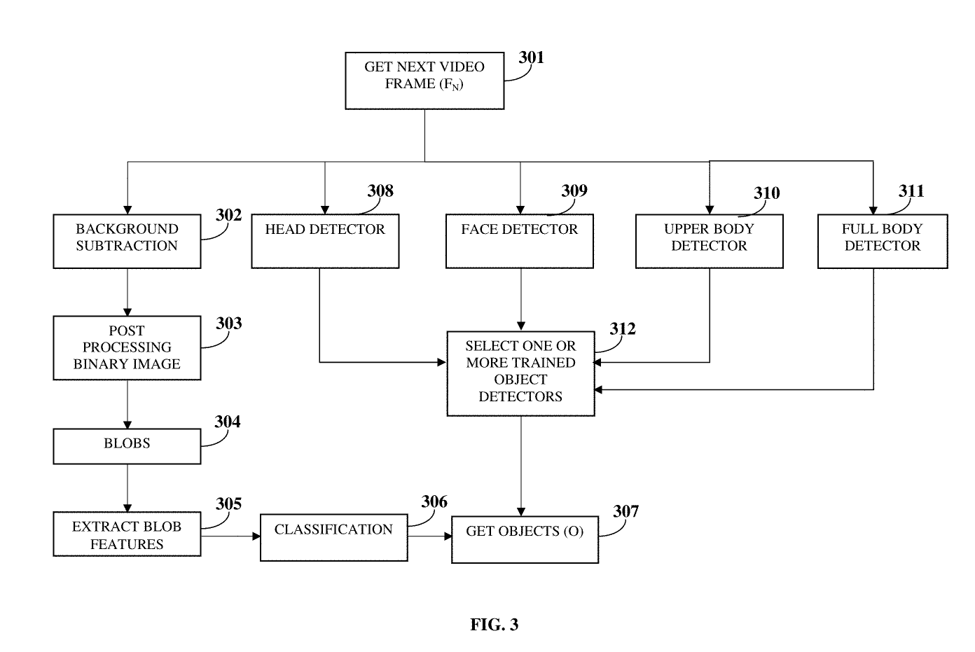

FIG. 2 exemplarily illustrates a flowchart comprising the steps performed by the purchase intent determination and assistance management system (PIDAMS) for determining dwell time of an anonymous shopper. The PIDAMS receives 201 video input of the identified anonymous shopper from one or more sensors, for example, video cameras, video recorders, surveillance cameras, etc., positioned at a configured region of interest at a retail store. The video input is a live camera input or a video file transmitted by a visual sensor, for example, a video camera, a video recorder, a surveillance camera, etc., to the PIDAMS. The PIDAMS decodes video frames extracted from the video input and applies an image processing algorithm to the video frames sequentially. The PIDAMS detects 202 objects from the video frames of the received video input by processing the video frames either temporally or independently and extracting objects either through background subtraction or, in an embodiment, through a trained object detector as disclosed in the detailed description of FIG. 3.

“Object detector” refers to a model that detects instances of objects of a certain class, for example, humans, cars, etc., in the received video input. As used herein, “trained object detector” refers to an offline trained model of the object detector trained on detecting specific parts of objects, for example, humans. The trained object detector is trained on features extracted from specific parts of a human and uses image classification techniques to classify a section of the received video input as a desired part or not a desired part. That is, the trained object detector finds the desired object in the received video input by using offline trained models for specific parts, for example, face, full body, upper body, head, etc. Based on the training on features of the face, full body, upper body, etc., the trained object detector identifies humans in the received video input. The purchase intent determination and assistance management system (PIDAMS) further trains the trained object detector to distinguish between a mannequin and a human present in view of a camera at the retail store, since the features of the human and the mannequin are similar. The PIDAMS trains the trained object detector to identify humans based on some motion of their face, full body, upper body, etc. Support vector machines (SVM) or Gaussian mixture model (GMM) classifiers are used for image classification. The PIDAMS performs offline training of the SVM or the GMM classifiers with features of the face, full body, upper body of humans, etc., for a period of time, for example, for about 3 weeks.

Background subtraction refers to an image processing technique where a foreground of an image is extracted for further processing comprising, for example, object recognition. Regions of interest in an image are typically objects, for example, humans in the foreground. Background subtraction is used for detecting moving objects in videos from static visual sensors, for example, static cameras. The trained object detector of the purchase intent determination and assistance management system (PIDAMS) detects the moving objects from the difference between a current video frame and a reference video frame also referred as a “background image” or a “background model”. The PIDAMS selects 203 human objects from the detected objects to identify anonymous shoppers. The PIDAMS filters the detected objects to find the required sized human objects depending on the scene and positioning of the sensors in the retail store. The PIDAMS analyzes parameters comprising, for example, the size of the objects, their motion properties, foreground pixels count, aspect ratio, selection of the trained object detector, etc., to select the human objects and identify anonymous shoppers. The PIDAMS then determines 204 dwell time of the identified anonymous shoppers. The PIDAMS monitors the human objects that remain persistent in a specific region of interest for a duration of their presence. The PIDAMS utilizes a timer or a timing application to measure the duration of presence of a persistent anonymous shopper in a specific region of interest and determines the dwell time.

FIG. 3 exemplarily illustrates a flowchart comprising the steps performed by the purchase intent determination and assistance management system (PIDAMS) for determining one or more human objects at a region of interest configured for a section in a retail store. The PIDAMS extracts objects from each video frame either through temporal processing of video frames or by using a trained object detector on individual video frames. The PIDAMS receives 301 each individual video frame and performs background subtraction 302 on the received video frame. The PIDAMS performs temporal processing of each video frame by modeling a background using one of the methods known in the art selected, for example, from Gaussian mixture models (GMM), weighted temporal frame averaging, etc. The PIDAMS generates a difference image by subtracting the obtained background with the current video frame or by using one of “N” frame differencing methods or a combination of the above methods. The PIDAMS then compares each pixel in the difference image using a fixed or dynamically calculated threshold and generates a binary image.

The purchase intent determination and assistance management system (PIDAMS) post processes 303 the obtained binary image using morphological operators and performs a connected pixel analysis to obtain bounding boxes for different objects in each video frame. The PIDAMS identifies binary large objects (BLOBs) 304 in the processed binary image and extracts 305 features of the BLOBs. The BLOB is a collection of binary data, that is, a group of connected pixels in a binary image, stored as a single entity in a database of the PIDAMS. The BLOB comprises a bounding box that defines coordinates of a rectangular border that encloses a captured image, when the captured image is placed on a screen or a canvas. The bounding box of the BLOB comprises, for example, width, height, center of the bounding box, ratio of width to height or height to width of the bounding box, percentage of foreground pixels inside the bounding box, and dominant colour of the bounding box defined, for example, by a red green blue (RGB) colour model or a hue, saturation, value (HSV) colour model. The PIDAMS classifies 306 the extracted features to detect or obtain 307 the human objects. For a binary image of a scene, the size of bounding box determines the objects in the scene. A human object's height in the captured image typically varies, for example, from 30 pixels to more than 90 pixels. Depending on the scene in the captured image, a minimum size threshold is used to filter small non-human objects. For an upright human in the captured image of the scene, height is greater than width and ratio of height to width is, for example, about 2.4 to about 3. By using parameters, for example, height of human objects, ratio of height to width, etc., the PIDAMS filters the BLOBs to obtain human objects.

In an embodiment, the purchase intent determination and assistance management system (PIDAMS) selects 312 trained object detectors comprising, for example, a head detector 308, a face detector 309, an upper body detector 310, and a full body detector 311 based on the camera view, object closeness, and use case. For example, top mounted cameras positioned near doors and near an entrance of the retail store use a head detector 308 as the trained object detector for detecting a human object since full body or upper body of the human object is not visible. A passage way camera or a shelf monitoring camera uses the full body detector 311 or the upper body detector 310 as the trained object detector for detecting a human object depending on visibility of parts, for example, the full body or the upper body of the human object.

For a top mount camera, the purchase intent determination and assistance management system (PIDAMS) selects the head detector 308 as the trained object detector for detecting a human object. For a perspective view depending on the object closeness, the PIDAMS selects the full body detector 311, or the upper body detector 310, or the face detector 309, or the head detector 308 as the trained object detector for detecting a human object. The PIDAMS utilizes the output from the selected trained object detector 308, or 309, or 310, or 311 for further processing and detection 307 of one or more human objects in each video frame.

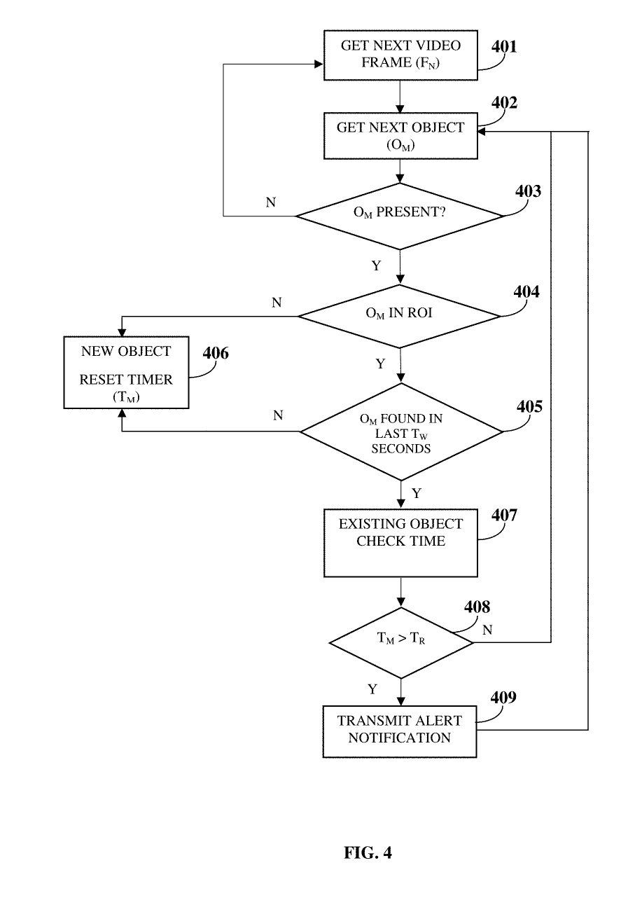

FIG. 4 exemplarily illustrates a flowchart comprising the steps performed by the purchase intent determination and assistance management system (PIDAMS) for generating an alert notification based on dwell time of an anonymous shopper. The PIDAMS receives 401 each video frame from visual sensors positioned at configured regions of interest at a retail store and obtains 402 objects as disclosed in the detailed description of FIG. 3. The PIDAMS iterates each video frame over the objects that are found in that video frame. The PIDAMS checks 403 whether objects are present in each video frame. The PIDAMS determines 404 whether the location of each object is in one or more of the configured regions of interest. If the object is located in one or more of the configured regions of interest, the PIDAMS checks 405 whether there is a match for this object in the objects that were identified in the earlier video frames up to a predetermined wait time of T_{W} seconds measured by a timer. If there is no match, the PIDAMS considers 406 the object as a new object and resets 406 the timer. If there is a match, the PIDAMS checks 407 the time of the presence of the object and determines 408 whether the object has crossed the dwell time threshold (T_{R}) that is configured for that region of interest. If the object is not detected in one or more of the configured regions of interest, the PIDAMS considers 406 the object as a new object and resets 406 the timer. If the timer crosses the dwell time threshold T_{R} configured for that region of interest, the PIDAMS generates and transmits 409 an alert notification to a communication device of an available store assistant in the retail store, proceeds to obtain 402 the next object in the video frame, and performs the steps 403, 404, 405, 406, 407, and 408 on the next object. If the timer does not cross the dwell time threshold T_{R} configured for that region of interest, the PIDAMS obtains 402 the next object in the video frame and performs the steps 403, 404, 405, 406, 407, and 408 on the next object. The PIDAMS repeats the above process for each video frame.

FIG. 5 exemplarily illustrates a flowchart comprising the steps performed by the purchase intent determination and assistance management system (PIDAMS) for computing dwell time thresholds of a configured region of interest based on weather conditions at a location of a retail store. The PIDAMS receives 501 metadata from sensors, for example, video cameras, video recorders, etc., positioned at the retail store for dwell time threshold calculation for a configured region of interest. The metadata comprises, for example, sensor identification (ID), trackscount, track ID, trackdatabase ID, region of interest ID (ROIID), region of interest name (ROI name), timestamp, time, condition, etc. An example of the metadata received by the PIDAMS is disclosed below:

“trackdbid”: [“4273761”, “4273707”, “4273722 . . . ]
“timestamp”: [“1475470849”, “1475470849”, “1 . . . ]
“dwelltime”: [“32”, “62”, “32”, “24”, “4”, “ . . . ]
“roiId1”: [“ROI331001107”, “ROI331001107”, “ . . . ]
“time1”: [“16”, “62”, “0”, “24”, “0”, “0”, “ . . . ]
“roiId2”: [“ROI331001108”, “ROI331001108”, “ . . . ]
“time2”: [“32”, “1”, “4”, “55”, “323”, “2”, . . . ]
“condition”: [“Rain”, “Rain”, “Rain”, “Rain” . . . ]

The purchase intent determination and assistance management system (PIDAMS) uses combinations of the received metadata and weather conditions for each region of interest (ROI) over a duration of time that form historical data to train and test the iterative statistical models. The purchase intent determination and assistance management system (PIDAMS) also obtains 502 weather conditions at the location of the retail store for the current day, for example, rain, clear skies, cloudy, fog, mist, overcast, etc., for dwell time threshold calculation for the configured region of interest. The PIDAMS filters 503 the received metadata with the weather conditions of the current day. For example, from the metadata disclosed above, the PIDAMS filters the metadata with the “rain” weather condition. That is, the PIDAMS collects the region of interest IDs (ROIIDs), trackdbid, dwell time, etc., for the “rain” weather condition. From the filtered metadata, the PIDAMS selects 504 each ROIID at a time for calculating the dwell time per hour for the “rain” weather condition of the current day. The PIDAMS selects 505 a time interval in a day for the selected ROIID. The time interval, for example, an hour or two hours, etc., for the selected ROIID is defined by a start time and an end time. In the example above, for each ROIID, the PIDAMS selects a time interval in the region of interest using the metadata for timestamp, time1, and time2. Consider an example where the retail store is open from 0800 hours (hrs) in the morning to 2200 hrs in the evening. The PIDAMS determines a dwell time threshold for each hour within the store timings. That is, the PIDAMS computes the dwell time threshold for 0800 hrs to 0900 hrs, 0900 hrs to 1000 hrs, 1000 hrs to 1100 hrs, etc. 0800 hrs to 0900 hrs is a time interval with 0800 hrs as a start time and 0900 hrs as an end time of the time interval. For a selected ROIID, the dwell time thresholds in different time intervals of the current day are different. For example, a stationary section in the retail store has a relatively less dwell time threshold from 0800 hrs to 0900 hrs compared to the dwell time threshold from 1700 hrs to 1800 hrs in the current day.

For each time interval in the region of interest (ROI), the purchase intent determination and assistance management system (PIDAMS) computes the dwell time thresholds through trained iterative statistical models using the received metadata and the weather conditions of the current day. That is, the PIDAMS uses a pattern of the identified anonymous shoppers in various weather conditions to train the iterative statistical models and uses the trained iterative statistical models to compute the dwell time threshold and predict footfalls, that is, the number of anonymous shoppers entering the retail store for the time range. The PIDAMS computes mean and median, or first quartile and third quartile ranges of the received metadata and the weather conditions for each time interval in the ROI. The PIDAMS computes 506 the dwell time thresholds using the mean and the median or the first quartile and third quartile ranges for the selected ROIID and the selected time interval.

The purchase intent determination and assistance management system (PIDAMS) removes 507 outliers of the computed mean and median or the first quartile and third quartile ranges, that is, the data crossing the customizable and defined boundary. The PIDAMS also compares 507 current data with historical metadata for similar weather conditions, day of the week conditions, and time of the day conditions, and uses, for example, a 75 percentile range for setting the dwell time threshold for each time interval in the current day for each region of interest ID (ROIID). The PIDAMS outputs 508 the dwell time threshold for each ROIID with the selected time interval in the current day. The output comprises, for example, optimal dwell time and the dwell time threshold of the region of interest along with the number of alert notifications to be sent to the store assistants. For computing the number of alert notifications to be sent, the PIDAMS accesses a shift roster of the available store assistants. In an embodiment, the PIDAMS refines the dwell time threshold for the next day based on the weather condition and ranking performed as disclosed in the detailed description of FIG. 8.

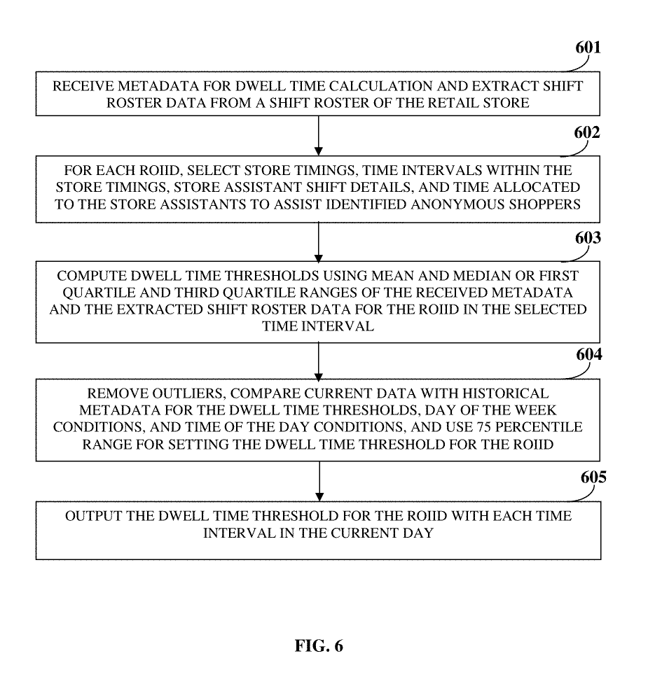

FIG. 6 exemplarily illustrates a flowchart comprising the steps performed by the purchase intent determination and assistance management system (PIDAMS) for computing dwell time thresholds of a configured region of interest based on shift roster data of a retail store. The PIDAMS transmits alert notifications to the store assistants based on the number of store assistants available at the retail store. The PIDAMS calculates a number of alert notifications to be transmitted to the communication device of each of the store assistants based on a percentage of time allocated to assist an identified anonymous shopper and a number of available store assistants to assist the identified anonymous shopper. The PIDAMS receives 601 metadata from the sensors, for example, video cameras, video recorders, etc., positioned at the retail store for dwell time threshold calculation for a configured region of interest. The metadata comprises, for example, sensor identification (ID), trackscount, track ID, trackdatabase ID, region of interest ID (ROIID), region of interest name (ROI name), etc. An example of the metadata is disclosed below:

“trackdbid”: [“4273691”, “4273697”, “4273792 . . . ]
“timestamp”: [“1475470801”, “1475470803”, “1 . . . ]
“dwelltime”: [“16”, “61”, “489”, “31”, “23”, “ . . . ]
“roiId1”: [“ROI331001107”, “ROI331001107”, “ . . . ]
“time1”: [“16”, “61”, “484”, “4”, “23”, “29”, “ . . . ]
“roiId2”: [“ROI331001108”, “ROI331001108”, “ . . . ]
“time2”: [“3”, “0”, “289”, “31”, “0”, “15”, . . . ]

The purchase intent determination and assistance management system (PIDAMS) also extracts 601 shift roster data from a shift roster of the retail store. The shift roster data comprises, for example, departmentID, total number of store assistants, and start time and end time of the store assistants in a region of interest (ROI). An example of the shift roster data is disclosed below:

“departmentId”: [“153331001”, “1533 . . . ]
“startTime”: [“9”, “10”, “11”, “9”, . . . ]
“endTime”: [“18”, “19”, “20”, “18”, . . . ]
“totalNoOfstaff”: [“1”, “4”, “1”, . . . ]

The purchase intent determination and assistance management system (PIDAMS) uses the dwell time thresholds computed based on weather conditions as disclosed in the detailed description of FIG. 5, in computing dwell time thresholds based on the shift roster data. The PIDAMS maps the extracted shift roster data to the received metadata. The PIDAMS performs the mapping by mapping the department ID to the region of interest ID (ROIID) as disclosed below:

### “ROI331001271”: [“150331001” ],

### “ROI331001272”: [“151331001” ],

### “ROI331001273”: [“152331001” ],

### “ROI331001274”: [“153331001” ],

### “ROI331001275”: [“154331001” ]

For each region of interest ID (ROIID), the purchase intent determination and assistance management system (PIDAMS) selects 602 store timings, time intervals within the store timings, store assistant shift details, and time allocated to the store assistants to assist identified anonymous shoppers. The time interval, for each of the selected ROIIDs, is defined by a start time and an end time. For different time intervals within the store timings, the dwell time thresholds are different for the same configured region of interest (ROI). In the example above, for each ROIID, the PIDAMS selects a time interval in the region of interest using the metadata for timestamp, time1, and time2. For each time interval in the ROI, the PIDAMS computes the dwell time thresholds through trained iterative statistical models using the received metadata and the shift roster data of the current day. The PIDAMS computes mean and median, or first quartile and third quartile ranges of the received metadata and the extracted shift roster data for each time interval in the ROI.

The purchase intent determination and assistance management system (PIDAMS) computes 603 dwell time thresholds using the mean and the median, or the first quartile and third quartile ranges of the received metadata and the extracted shift roster data for the region of interest ID (ROIID) in the selected time interval. The PIDAMS removes 604 outliers of the computed mean and median or the first quartile and third quartile ranges. The PIDAMS also compares 604 current data with historical metadata for the dwell time thresholds, day of the week conditions, and time of the day conditions, and uses, for example, a 75 percentile range for setting the dwell time threshold for each time interval in the current day for each ROIID. The PIDAMS outputs 605 the dwell time threshold for each time interval or shift interval in the current day for each ROIID to the communication devices of the store assistants. In an embodiment, the PIDAMS sends a batch output with the dwell time threshold for each time interval or shift interval for the next day for each ROIID to the communication devices of the store assistants. The output comprises, for example, optimal dwell time and the dwell time threshold of the region of interest along with the number of alert notifications to be sent to the available store assistants.

The dwell time threshold computation for each region of interest identification (ROIID) is a batch process and the purchase intent determination and assistance management system (PIDAMS) performs the batch process at the end of the previous day. That is, the PIDAMS computes the dwell time threshold for the next day on the night of the current day based on the received metadata, the weather conditions, and the shift roster data of the current day. The PIDAMS collates weather conditions from external sources, for example, meteorological departments, etc., for the next 15 days. In an embodiment, the PIDAMS refines the dwell time threshold for the next day based on a dwell time parameter extracted from the event data, historical data, and the shift roster data.

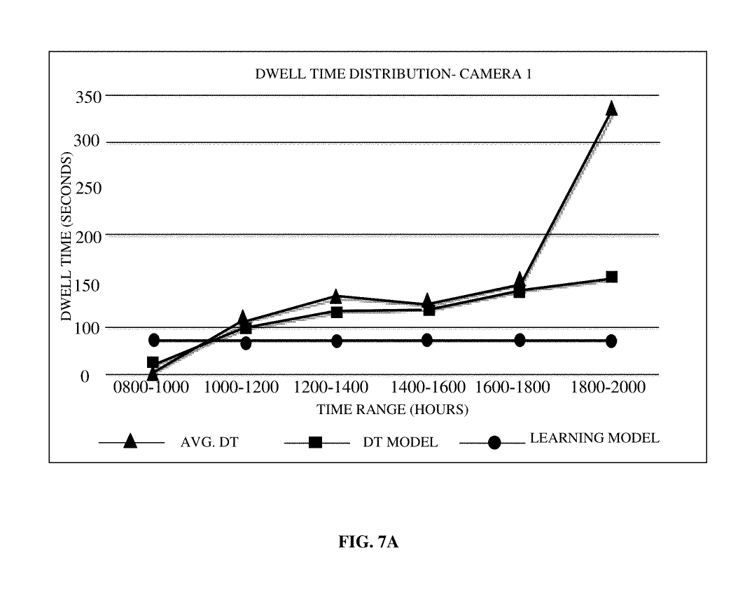

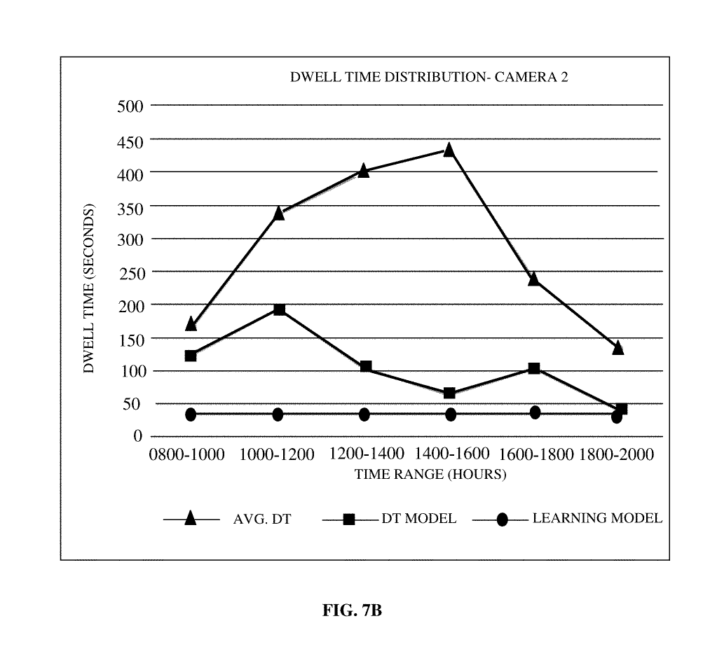

FIGS. 7A-7B exemplarily illustrate graphical representations showing dwell time distributions of anonymous shoppers identified in configured regions of interest that are in view of sensors, for example, camera-1 and camera-2 in a retail store, indicating performance of iterative statistical models in determining dwell time thresholds. The iterative statistical models learn from the received metadata, the weather conditions, and the shift roster data. The purchase intent determination and assistance management system (PIDAMS) computes the dwell time of the identified anonymous shoppers as disclosed in the detailed description of FIG. 2. The iterative statistical models compute the dwell time thresholds as disclosed in the detailed description of FIGS. 5-6. The average dwell time of the identified anonymous shoppers in a configured region of interest in view of camera-1 increases as the day proceeds as exemplarily illustrated in FIG. 7A, and the average dwell time of the identified anonymous shoppers in a configured region of interest in view of camera-2 increases and then decreases as the day proceeds as exemplarily illustrated in FIG. 7B. In an embodiment, the trained iterative statistical models, using the received metadata, the weather conditions, and the shift roster data, compute the dwell time threshold for a region of interest to be less than the dwell time threshold computed by the trained iterative statistical models using only the received metadata. The iterative statistical models calculate the dwell time thresholds in a batch mode at the end of a current day using historical data of dwell time obtained until the end of working hours of the current day of the retail store.

FIG. 8 exemplarily illustrates a flowchart comprising the steps performed by the purchase intent determination and assistance management system (PIDAMS) for ranking an identified anonymous shopper and alerting store assistants. The PIDAMS receives 801 feedback data from the assistant application on a store assistant's communication device. The feedback data comprises, for example, responses of the store assistant to a questionnaire on behaviour of the identified anonymous shopper in a configured region of interest in a retail store, such as, whether the identified anonymous shopper needed assistance, whether the identified anonymous shopper found a desired product, whether the identified anonymous shopper is a value shopper or a frequent shopper, whether the store assistant recommended a product, whether the identified anonymous shopper showed interest in the recommendation, etc. The store assistant responds with a yes or a no to the questionnaire by indicating a “Y” or an “N” respectively, on the graphical user interface of the assistant application. Along with the feedback data, the PIDAMS uses the section attributes and the event generated by the PIDAMS based on the configurable dwell time threshold to rank the identified anonymous shopper in the configured region of interest. In an embodiment, the PIDAMS ranks the identified anonymous shopper in the configured region of interest using event data, feedback data, and weather data.

The purchase intent determination and assistance management system (PIDAMS) receives, for example, about 20 input variables comprising the feedback data, the metadata, the generated event, and the section attributes in total. Behaviour of the identified anonymous shopper in two sections, for example, an electronics section and a household section of a retail store is different. Thus, for a configured region of interest, out of the 20 input variables, a combination of, for example, only 3 input variables influence the rank of the identified anonymous shopper. Consider an example where mobile phones of a particular brand are on promotion on a Friday between 1500 hrs to 1600 hrs in a mobile phone section of a retail store. The input variables with higher weight are the region of interest, that is, the mobile phone section and the section attributes, for example, day of the week, time of the day, and offers of the day. In this example, the input variables, for example, gender and age of the identified anonymous shopper have low weight associated with them since the promotion on Friday in the afternoon draws shoppers of any gender in all age groups. Consider another example where mobile phones in the mobile phone section of the retail store are being sold at a marked price on a Monday while the temperature at the location of the retail store is 15° C. In this example, the input variables with higher weight are the region of interest and the weather conditions at the location of the retail store. The day of the week is associated with a relatively low weight since a Monday will not draw many shoppers to the retail store but the weather conditions attract more shoppers into the retail store.

The purchase intent determination and assistance management system (PIDAMS) determines 802 weights associated with the input variables comprising the feedback data, the metadata, the generated event, and the section attributes using trained iterative statistical models, for example, trained linear regression models iteratively. The trained linear regression models predict weights associated with the input variables based on training on combinations of historical input variables and corresponding weights. The trained linear regression models are trained on a linear relationship between the input variables and their corresponding weights. The PIDAMS evaluates 803 an intercept value, a residual standard error, and an adjusted R squared error for every iteration of the trained iterative statistical model. The PIDAMS deduces the sum of squared errors for each iteration. The PIDAMS tests the determined weights associated with the input variables using the trained iterative statistical models and the evaluated intercept value, the residual standard error, and the adjusted R squared error. If the determined weights by the trained iterative statistical models are closer to +1, the PIDAMS outputs the weights associated with the input variables as coefficients of the received feedback data, the metadata, the generated event, and the section attributes to rank the identified anonymous shopper.

The purchase intent determination and assistance management system (PIDAMS) runs 804 iterative statistical models, for example, logistic regression models to fit the trained iterative statistical models, for example, the trained linear regression models. The logistic regression models capture error distribution in prediction of the weights associated with the input variables by the trained linear regression models. The logistic regression models predict a rank of the identified anonymous shopper using the determined weight associated with the received feedback data, the metadata, the generated event, and the section attributes. The PIDAMS establishes 805 a rating scale to rank the identified anonymous shopper using the rank predicted by the logistic regression models. The PIDAMS performs steps 804 and 805 in multiple iterations. The rating scale allows the PIDAMS to relatively rate identified anonymous shoppers.

Consider an example where the purchase intent determination and assistance management system (PIDAMS) identifies three anonymous shoppers, Shopper-A, Shopper-B, and Shopper-C in a configured region of interest, for example, a refrigerator section in a retail store. The shopper attributes of Shopper-A, Shopper-B, and Shopper-C are, for example, a woman whose age is between 45 years and 55 years, a woman whose age is between 25 years and 35 years, and a man whose age is between 35 years and 45 years respectively. Shopper-A spends more time in the refrigerator section than Shopper-B and Shopper-C. That is, dwell time of Shopper-A in the refrigerator section is greater than dwell times of Shopper-B and Shopper-C in the refrigerator section. Historical data of the refrigerator section states that a woman aged between 45 years and 55 years who spends 15 minutes in the refrigerator section purchases a refrigerator as opposed to a man aged between 35 years and 45 years who spends 8 minutes in the refrigerator section and does not make a purchase. The shopper attributes and dwell times of Shopper-A, Shopper-B, and Shopper-C are compared with the historical data and Shopper-A is ranked higher than Shopper-B and Shopper-C.

The purchase intent determination and assistance management system (PIDAMS) accesses the shift roster data of the store assistants and determines, for example, that multiple identified anonymous shoppers are ranked high while the number of store assistants available to attend to the high ranked identified anonymous shoppers is less. The PIDAMS establishes a customizable rating scale to send alert notifications to the store assistants regarding the identified anonymous shoppers. If the rank of an identified anonymous shopper is greater than 85%, the PIDAMS sends an alert notification to the available store assistants. If the ranks of multiple identified anonymous shoppers, for example, Shopper-A and Shopper-B in the above example are greater than 85% and the number of store assistants is less, the PIDAMS ranks Shopper-A higher than Shopper-B based on the shopper attributes and their dwell times, and sends alert notifications to the available store assistants to assist Shopper-A.

The customizable rating scale also indicates that an identified anonymous shopper with a higher rank has a higher probability to make a purchase in the configured region of interest of the retail store. For example, if the rank of an identified anonymous shopper is greater than 85% and less than 100%, there is a high probability that the identified anonymous shopper will make a purchase in the configured region of interest. If the rank of the identified anonymous shopper is greater 75% and less than 85%, the probability of the identified anonymous shopper to make a purchase is relatively low. The purchase intent determination and assistance management system (PIDAMS) generates a list of alert notifications with the ranks of the identified anonymous shoppers. Based on the ranks of the identified anonymous shoppers defined by the customizable rating scale, the PIDAMS sends 806 alert notifications to the communication devices of the store assistants along with the ranks of the identified anonymous shoppers.

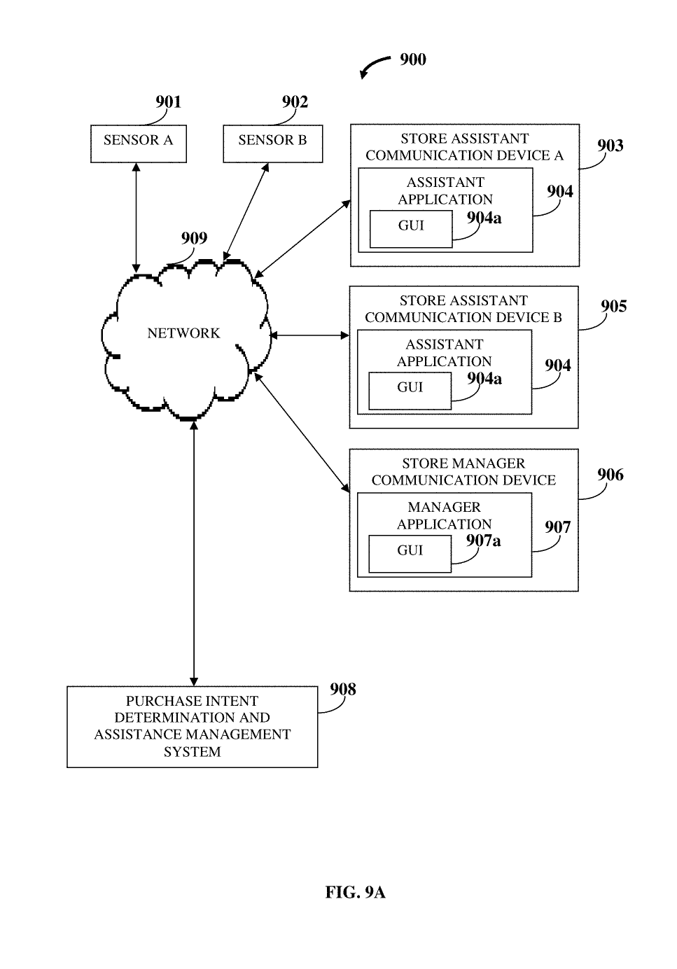

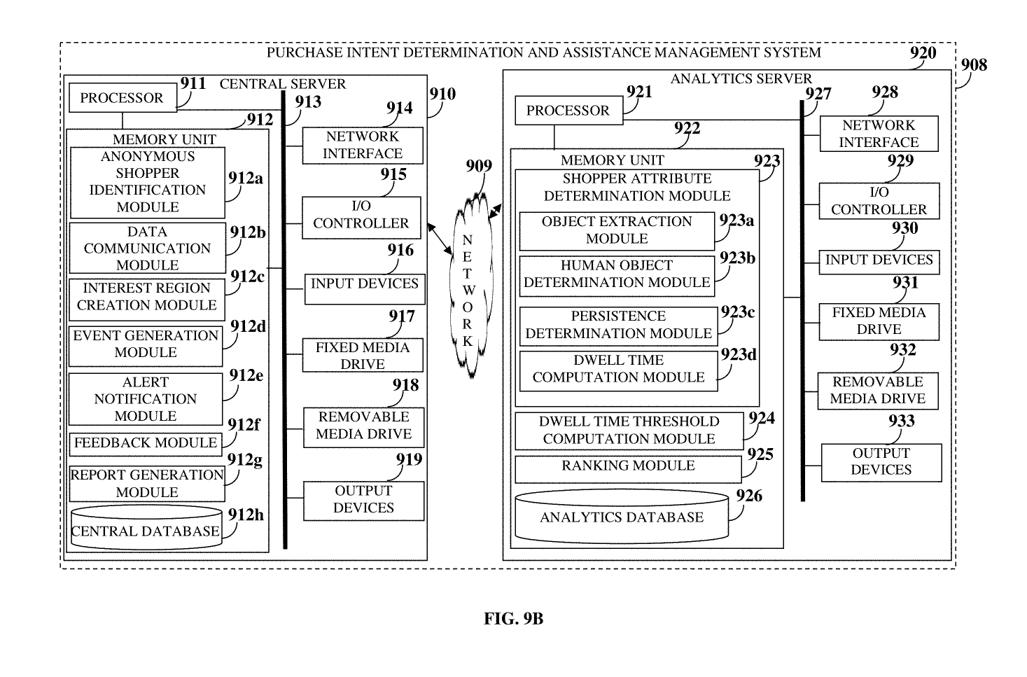

FIG. 9A exemplarily illustrates a system 900 comprising the purchase intent determination and assistance management system (PIDAMS) 908 for determining purchase intent of an anonymous shopper in a retail store and providing assistance to the anonymous shopper in the retail store based on the determined purchase intent. The system 900 disclosed herein further comprises multiple sensors, for example, sensor A 901 and sensor B 902. The sensors 901 and 902 are positioned at multiple sections of the retail store for capturing multiple images of anonymous shoppers. The sensors 901 and 902 communicate with the PIDAMS 908 via a network 909, for example, a short range network or a long range network. The system 900 disclosed herein further comprises the assistant application 904 installed on each of multiple store assistants' communication devices, for example, store assistant communication device A 903 and store assistant communication device B 905, and the manager application 907 installed on a store manager communication device 906.

The purchase intent determination and assistance management system (PIDAMS) 908 communicates with the assistant application 904 on each of the store assistant communication devices A 903 and B 905, and the manager application 907 of the store manager communication device 906 via the network 909. In an embodiment, the manager application 907 is hosted on a webserver and is accessed by the store manager via the store manager communication device 906. In the system 900 disclosed herein, the PIDAMS 908 interfaces instantaneously with the sensors 901 and 902, the assistant application 904 on each of the store assistant communication devices A 903 and B 905, and the manager application 907 on the store manager communication device 906 for determining purchase intent of an anonymous shopper in the retail store and providing assistance to the anonymous shopper in the retail store based on the determined purchase intent, and therefore more than one specifically programmed computer system is used for determining purchase intent of the anonymous shopper in the retail store and providing assistance to the anonymous shopper in the retail store based on the determined purchase intent.

The store assistant communication devices A 903 and B 905, and the store manager communication device 906 are electronic devices selected, for example, from personal computers, tablet computing devices, mobile computers, mobile phones, smartphones, portable computing devices, personal digital assistants, laptops, wearable computing devices such as the Google Glass® of Google Inc., the Apple Watch® of Apple Inc., the Android Smartwatch® of Google Inc., etc., touch centric devices, client devices, portable electronic devices, network enabled computing devices, interactive network enabled communication devices, gaming devices, image capture devices, web browsers, portable media players, any other suitable computing equipment, combinations of multiple pieces of computing equipment, etc. In an embodiment, the store assistant communication devices A 903 and B 905 and the store manager communication device 906 are hybrid computing devices that combine the functionality of multiple devices. Examples of hybrid computing devices comprise a cellular telephone that includes a media player functionality, a gaming device that includes a wireless communications capability, a cellular telephone that includes gaming and multimedia functions, and a portable device that receives electronic mail (email), supports mobile telephone calls, has a media player functionality, and supports web browsing. In an embodiment, computing equipment is used to implement applications such as media playback applications, instant messenger applications, a web browser, an electronic mail (email) application, a calendar application, etc. The purchase intent determination and assistance management system (PIDAMS) 908 is accessible to users, for example, through a broad spectrum of technologies and devices such as personal computers, cellular phones, tablet computing devices, etc., with access to the internet.

The network 909 through which the sensors 901 and 902 communicate with the purchase intent determination and assistance management system (PIDAMS) 908 and through which the PIDAMS 908 communicates with the assistant application 904 of each of the store assistant communication devices A 903 and B 905, and with the manager application 907 of the store manager communication device 906 is selected, for example, from the internet, an intranet, a wired network, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks.

The purchase intent determination and assistance management system (PIDAMS) 908 is a computer system, for example, a personal computer, a tablet computing device, a mobile computer, a portable computing device, a laptop, a touch centric device, a workstation, a server, a portable electronic device, a network enabled computing device, an interactive network enabled communication device, any other suitable computing equipment, combinations of multiple pieces of computing equipment, etc., that is programmable using a high level computer programming language. In an embodiment, the PIDAMS 908 is implemented using programmed and purposeful hardware. The PIDAMS 908 comprises at least one non-transitory computer readable storage medium for storing computer program instructions defined by software modules of the PIDAMS 908, and at least one processor communicatively coupled to the non-transitory computer readable storage medium for executing the computer program instructions defined by the software modules of the PIDAMS 908 as disclosed in the detailed description of FIG. 9B. As used herein, “non-transitory computer readable storage medium” refers to all computer readable media, for example, non-volatile media, volatile media, and transmission media, except for a transitory, propagating signal. Non-volatile media comprise, for example, solid state drives, optical discs or magnetic disks, and other persistent memory volatile media including a dynamic random access memory (DRAM), which typically constitute a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor. In an embodiment, the assistant application 904 is implemented on each of the store assistant communication devices A 903 and B 905 using programmed and purposeful hardware. Similarly, the manager application 907 is implemented on the store manager communication device 906 using programmed and purposeful hardware.

The assistant application 904 renders a graphical user interface (GUI) 904a on each of the store assistant communication devices A 903 and B 905 for displaying alert notifications transmitted by the purchase intent determination and assistance management system (PIDAMS) 908, receiving an acceptance indication from the store assistants to provide assistance to an anonymous shopper identified by the PIDAMS 908, displaying information on target items and offers on the target items applicable to the identified anonymous shopper, receiving feedback on a communication initiated with the identified anonymous shopper by the store assistants, etc. The manager application 907 renders a GUI 907a on the store manager communication device 906 for displaying a consolidated view of the generated alert notifications for assignment of the generated alert notifications to the store assistants. The GUIs 904a and 907a on the store assistant communication devices A 903 and B 905 and the store manager communication device 906 display information, display interfaces, user interface elements such as swipable arrows, icons, search boxes, etc., for example, for viewing information and receiving inputs from the store assistants and the store manager respectively. The GUIs 904a and 907a are, for example, webpages of a website hosted by the PIDAMS 908, online web interfaces, web based downloadable application interfaces, mobile based downloadable application interfaces, etc.

FIG. 9B exemplarily illustrates an implementation of the purchase intent determination and assistance management system (PIDAMS) 908 for determining purchase intent of an anonymous shopper in a retail store and providing assistance to the anonymous shopper in the retail store based on the determined purchase intent. In the implementation of the PIDAMS 908 exemplarily illustrated in FIG. 9B, the PIDAMS 908 comprises a central server 910 and an analytics server 920. The central server 910 communicates with the analytics server 920 via the network 909. The central server 910 and the analytics server 920 are computer systems that are programmable using a high level computer programming language. The analytics server 920 performs both real time processing of inputs and batch processing of the inputs.

As exemplarily illustrated in FIG. 9B, the central server 910 and the analytics server 920 comprise non-transitory computer readable storage media, for example, memory units 912 and 922 respectively, for storing program instructions, applications, and data. The memory unit 912 of the central server 910 stores computer program instructions defined by modules, for example, 912a, 912b, 912c, 912d, 912e, 912f, 912g, 912h, etc., of the central server 910. The memory unit 922 of the analytics server 920 stores computer program instructions defined by modules, for example, 923, 924, 925, 926, etc., of the analytics server 920. The memory units 912 and 922 of the central server 910 and the analytics server 920 respectively are, for example, random access memories (RAMs) or other types of dynamic storage devices that store information and instructions for execution by processors 911 and 921 of the central server 910 and the analytics server 920 respectively. The memory units 912 and 922 also store temporary variables and other intermediate information used during execution of the instructions by the processors 911 and 921 respectively. The central server 910 and the analytics server 920, each further comprises a read only memory (ROM) or another type of static storage device that stores static information and instructions for the processors 911 and 921 respectively.

The processors 911 and 921 of the central server 910 and the analytics server 920 respectively, are communicatively coupled to the memory units 912 and 922 of the central server 910 and the analytics server 920 respectively. The processor 911 of the central server 910 executes the computer program instructions defined by the modules 912a, 912b, 912c, 912d, 912e, 912f, 912g, 912h, etc., of the central server 910. The processor 921 of the analytics server 920 executes the computer program instructions defined by the modules 923a, 923b, 923c, 923d, 924, 925, 926, etc., of the analytics server 920. The processors 911 and 921 of the central server 910 and the analytics server 920 respectively, refer to any one or more microprocessors, central processing unit (CPU) devices, finite state machines, computers, microcontrollers, digital signal processors, logic, a logic device, an user circuit, an application specific integrated circuit (ASIC), a field-programmable gate array (FPGA), a chip, etc., or any combination thereof, capable of executing computer programs or a series of commands, instructions, or state transitions. In an embodiment, each of the processors 911 and 921 is implemented as a processor set comprising, for example, a programmed microprocessor and a math or graphics co-processor. The processors 911 and 921 are selected, for example, from the Intel® processors such as the Itanium® microprocessor or the Pentium® processors, Advanced Micro Devices (AMD®) processors such as the Athlon® processor, UltraSPARC® processors, microSPARC® processors, Hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The purchase intent determination and assistance management system (PIDAMS) 908 disclosed herein is not limited to employing the processors 911 and 921. In an embodiment, the PIDAMS 908 employs controllers or microcontrollers.

As exemplarily illustrated in FIG. 9B, the central server 910 and the analytics server 920 further comprise data buses 913 and 927, network interfaces 914 and 928, input/output (I/O) controllers 915 and 929, input devices 916 and 930, fixed media drives 917 and 931 such as hard drives, removable media drives 918 and 932 for receiving removable media, output devices 919 and 933, etc. The data bus 913 of the central server 910 permits communication between the modules, for example, 911, 912, 914, 915, 916, 917, 918, 919, etc., of the central server 910. The data bus 927 of the analytics server 920 permits communication between the modules, for example, 921, 922, 928, 929, 930, 931, 932, 933, etc., of the analytics server 920. The network interfaces 914 and 928 enable connection of the central server 910 and the analytics server 920 respectively, to the network 909. In an embodiment, the network interfaces 914 and 928 of the central server 910 and the analytics server 920 respectively, are provided as interface cards also referred to as “line cards”. The network interfaces 914 and 928 are, for example, one or more of infrared (IR) interfaces, interfaces implementing Wi-Fi® of Wi-Fi Alliance Corporation, universal serial bus (USB) interfaces, FireWire® interfaces of Apple Inc., Ethernet interfaces, frame relay interfaces, cable interfaces, digital subscriber line (DSL) interfaces, token ring interfaces, peripheral controller interconnect (PCI) interfaces, local area network (LAN) interfaces, wide area network (WAN) interfaces, interfaces using serial protocols, interfaces using parallel protocols, Ethernet communication interfaces, asynchronous transfer mode (ATM) interfaces, high speed serial interfaces (HSSIs), fiber distributed data interfaces (FDDIs), interfaces based on transmission control protocol (TCP)/internet protocol (IP), interfaces based on wireless communications technology such as satellite technology, radio frequency (RF) technology, near field communication, etc. The I/O controllers 915 and 929 control input actions and output actions performed by the central server 910 and the analytics server 920 respectively.

Computer applications and programs are used for operating the central server 910 and the analytics server 920 of the purchase intent determination and assistance management system (PIDAMS) 908. The programs are loaded onto the fixed media drives 917 and 931 of the central server 910 and the analytics server 920 respectively, and into the memory units 912 and 922 of the central server 910 and the analytics server 920 respectively, via the removable media drives 918 and 932 of the central server 910 and the analytics server 920 respectively. In an embodiment, the computer applications and programs are loaded directly into the central server 910 and the analytics server 920 via the network 909.

The central server 910 comprises an anonymous shopper identification module 912a, a data communication module 912b, an interest region creation module 912c, an event generation module 912d, an alert notification module 912e, a feedback module 912f, a report generation module 912g, and a central database 912h installed and stored in the memory unit 912 of the central server 910. The analytics server 920 comprises a shopper attribute determination module 923, a dwell time threshold computation module 924, a ranking module 925, and an analytics database 926 installed and stored in the memory unit 922 of the analytics server 920. The anonymous shopper identification module 912a of the central server 910 identifies an anonymous shopper within a region of interest configured for a section in the retail store using one or more sensors 901 and 902 exemplarily illustrated in FIG. 9A, positioned at multiple sections of the retail store. The data communication module 912b of the central server 910 receives multiple images of the identified anonymous shopper captured by the sensors 901 and 902 positioned at the configured region of interest. The interest region creation module 912c creates regions of interest based on a mapping of images captured by the sensors 901 and 902 on a floor plan for each section of the retail store. A code snippet of the interest region creation module 912c executed by the processor 911 of the central server 910 for creating regions of interest is disclosed below:

@RequestMapping(value = “/saveRoi”, method = RequestMethod.POST)
public String saveRoiMapping(@ModelAttribute(value = “roiform”) RoiForm roiForm,
RedirectAttributes attributes) throws ParseException, CloneNotSupportedException {
DepartmentInfo departmentInfo =
departmentService.getDepartmentInfo(shapes.getJSONObject(i).getString(“departmentI
D”));
RoiWebHelper.populateModelWithSaveRoiMapping(departmentInfo, storeInfo,
cameraInfo, roiInfo, newROIForm,

tenantInfo);

RoiWebHelper.populateModelWithSaveRoiMapping(roiInfo,

newROIForm);

roiInfo.setEnableAlgo(roiForm.getEnableAlgo( ));
roiInfoObj = roiService.saveRoi(roiInfo);
if( i == move_ID){

roiID = roiInfoObj.getRoiId( );

}
listRoiInfo.add(roiInfo);
RoiWebHelper.populateModelWithSaveRoiMapping(attributes,

roiInfoObj, newROIForm);

}
GladiusRequest gladiusRequest = new GladiusRequest( );
gladiusRequest.setListRoiInfo(listRoiInfo);
gladiusRequest.setCameraInfo(cameraInfo);
gladiusService.gladiusROICreation(gladiusRequest);
return “redirect:viewRoiInfo/” + roiForm.getCameraId( )+“/”+roiID;

}

The data communication module 912b transmits the received images to the analytics server 920 via the network 909. The shopper attribute determination module 923 of the analytics server 920 receives the images transmitted by the central server 910 and determines shopper attributes comprising, for example, dwell time, sections of dwell, an age range, gender, location, date, time, etc., of the identified anonymous shopper from the received images as disclosed in the detailed description of FIGS. 1-3. The shopper attribute determination module 923 comprises an object extraction module 923a, a human object determination module 923b, a persistence determination module 923c, and a dwell time computation module 923d. The object extraction module 923a extracts one or more objects from the received images. The human object determination module 923b determines one or more human objects from the extracted objects based on predefined criteria as disclosed in the detailed description of FIG. 3. The persistence determination module 923c determines persistence of the identified anonymous shopper from the determined human objects at the configured region of interest. The dwell time computation module 923d computes the dwell time of the identified anonymous shopper based on the determined persistence by calculating a duration of presence of the identified anonymous shopper at the configured region of interest. A code snippet of the anonymous shopper identification module 912a executed by the processor 911 of the central server 910 for identifying an anonymous shopper within a region of interest and the shopper attribute determination module 923 executed by the processor 921 of the analytics server 920 for determining shopper attributes of the identified anonymous shopper from the received images is disclosed below:

extract foreground objects
detect objects
if object human

if matched to previously initialized object

increase dwell time

else

give new ID
initialize dwell time to zero
initialize object for tracking

for each tracked object

compute dwell time

The dwell time threshold computation module 924 of the analytics server 920 dynamically configures a dwell time threshold based on iterative statistical inputs as disclosed in the detailed description of FIG. 1 and FIGS. 5-6. A code snippet of the dwell time threshold computation module 924 executed by the processor 921 of the analytics server 920 for configuring the dwell time threshold based on iterative statistical inputs is disclosed below:

library(jsonlite)
#reading the input
myFile<file.path(myPath,“Data19001-RExport.json”)
cam Data<−as data frame(from JSON(myFile))
#filtering the data
cam Data<−subset(cam DAta,camData$condition==“Rain”)
#Calculating the DT per hour for the required weather condition
for(n in

seq(from=round(min(cam_Data$startTime)),to=max(cam_Data$startTime),by=1)){

timeData<−subset(cam_Data,as numeric(format(cam_Data$datetime,%H”))>=n &

as numeric(format(cam_Data$datetime,“%H”))<n+1)

...
x1<−quantile(val, qVal)[[1]]
...
#returning the output
colnames(reqData) <−

c(“roiId”,“startTime”,“endTime”,“optimalDT”,“noOfAlerts”)

res<−paste(RJSONIO::toJSON(reqData))
return(res)

The shopper attribute determination module 923 transmits the determined shopper attributes to the central server 910 via the network 909. The dwell time threshold computation module 924 of the analytics server 920 transmits the dynamically configured dwell time threshold to the central server 910 via the network 909. The event generation module 912d of the central server 910 generates an event associated with the received images and the determined shopper attributes based on the configurable dwell time threshold and transmits the generated event to the analytics server 920 via the network 909. A code snippet of the event generation module 912d executed by the processor 911 of the central server 910 for generating an event associated with the received images and the determined shopper attributes based on the configurable dwell time threshold is disclosed below:

@RequestMapping(value = “/getEventIdOnClick”, method =
RequestMethod.GET)
@ResponseBody
public String getEventIdOnClick(@RequestParam(value = “storeId”,
required = false) String storeId,

@RequestParam(value = “currentDate”, required = false) String

currentDate) {

String eventId = “”;
List<SaleInfo> saleInfos = saleService.getSaleByStoreId(storeId);
eventId = SaleWebHelper.getSalesEventId(saleInfos, currentDate);
return eventId;

}

The ranking module 925 of the analytics server 920 iteratively ranks the identified anonymous shopper based on the generated event and section attributes of the configured region of interest for determining the purchase intent of the identified anonymous shopper to convert the identified anonymous shopper into a potential buyer as disclosed in the detailed description of FIG. 1 and FIG. 8. A pseudocode of the ranking module 925 for iteratively ranking the identified anonymous shopper is disclosed below:
Get the JSON “Shopper Feedback” and ranking input variables input from Java to R via rServe
Read JSON data and store the data in the dataframe
Pre-process the data
Get the processed data and criteria for ranking
Send the data to a different ranking model and process the data
Calculate rank aggregation based on a weighted Shopper Feedback rank, a weighted text based review rank, and a normalized rating using a customized ranking algorithm
Ranking based on model-learning process using the dataset into training and test. Predict the score how good and then get the new comments. Computing the set of features (and derived features), then use the model to map those features to a score.
Get the final output from the ranking model, convert the final output into a JSON format, and return the result.

A code snippet of the ranking module 925 executed by the processor 921 of the analytics server 920 for iteratively ranking the identified anonymous shopper is disclosed below:

{ ″productPicked″ : ″Y″, ″assistanceRequired″ : ″N″, ″productFound″ :
″N″,
″recommended″ : ″N″, ″recommendInterest″ : ″N″, ″gender″ : ″N″,
″frequentlyShopper″ : ″N″, ″valueShopper″ : ″N″ }
{ ″gender″ ,“age″ }
metadata<−as.data.frame(fromJSON(strData1))
factdata<−as.data.frame(fromJSON(strData2))
...
for(m in seq(from=1,to=ncol(metadata),by=1)){

metadata <−subset(metadata, metadata [,m]!=″NA″)

...
}
rankdata<−function(metadata, factdata){
...
}
res<−paste(RJSONIO::toJSON(rankdata))
return(res)

The ranking module 925 of the analytics server 920 transmits the rank of the identified anonymous shopper to the central server 910 via the network 909. The alert notification module 912e of the central server 910 generates and transmits one or more alert notifications with the determined shopper attributes, images that provide a physical identification of the identified anonymous shopper, and the region of interest to the store assistant communication devices A 903 and B 905 via the network 909 exemplarily illustrated in FIG. 9A, to provide assistance to the identified anonymous shopper based on the iterative ranking of the identified anonymous shopper and predetermined section criteria as disclosed in the detailed description of FIG. 1, FIG. 4, and FIG. 8. In an embodiment, the alert notification module 912e calculates a number of alert notifications to be transmitted to the store assistant communication devices A 903 and B 905 based on a percentage of time allocated and a number of available store assistants to assist the identified anonymous shopper. In another embodiment, the alert notification module 912e generates and renders a consolidated view of the generated alert notifications on the graphical user interface (GUI) 907a provided by the manager application 907 deployable on the store manager communication device 906 exemplarily illustrated in FIG. 9A, for assignment of the generated alert notifications to one or more of the store assistants. A code snippet of the alert notification module 912e executed by the processor 911 of the central server 910 for calculating the number of alert notifications to be transmitted to the store assistant communication devices A 903 and B 905 is disclosed below:

#reading the input
myFile<−file.path(myPath,“Data21001-RExport.json”)
camData<−as.data.frame(fromJSON(myFile))
srFile<−as.data.frame(fromJSON(srFile))
...
#Processing
for(n in seq(from=1,to=nrow(srData),by=1)){
dname<−as.character(srData[n,1])
...
rDAta<−as.data.frame(rData)
colnames(rData)<−c(“departmentID”,“startTime”,“endTime”,“totalNoOfStaff”)
#Mapping Shift Roster Data with roiId
mapData<−function(camData.rData){
...
}
#Calculating the DT per hour using Shift Roster data
for(n in
seq(from=round(min(cam_Data$startTime)),to=max(cam_Data$startTime),by=1)
){
timeData<−subset(cam_Data,as.numeric(format(cam_Data$datetime,%H”))>=n &
as.numeric(format(cam_Data$datetime,“ %H”))<n+1)
...
#returning the output
colnames(reqData) <−c(“roiId”, “startTime”, “endTime”, “optimalDT”,
“noOfAlerts”)
res<−paste(RJSONIO::toJSON(reqData))
return(res)

A code snippet of the alert notification module 912e executed by the processor 911 of the central server 910 for transmitting alert notifications to the store assistant communication devices A 903 and B 905 is disclosed below:

@RequestMapping(value = “/notification”, method =
RequestMethod.POST)
public CommonResponse proxyNotification(@RequestBody
NotificationMessage message,Map<String, Object> model) {
messageService.pushMessage(message);
notificationSocketService.updateNotification(message.getRoiName( ));
this.notificationSocketService.pushAlerts(message);
try{

expireNotificationService.expireNotification( message );

} catch( Exception e){

logger.error(“Expire Notification Starting place Exception ”+

e.getMessage( ));

e.printStackTrace( );

}
CommonResponse response=new CommonResponse( );
response.setCode(“success”);
response.setMessage(“message pushed”);
logger.info(“...Message successfully posted to Kafka...”);
return response;
}

The data communication module 912b of the central server 910 renders information on target items and offers on the target items applicable to the identified anonymous shopper based on the determined shopper attributes to the store assistant communication device A 903 or B 905 of one of the store assistants on request, on receiving an acceptance indication from the store assistant to provide the assistance to the identified anonymous shopper. A code snippet of the data communication module 912b executed by the processor 911 of the central server 910 for rendering information on target items and offers on the target items applicable to the identified anonymous shopper based on the determined shopper attributes to the store assistant communication device A 903 or B 905 is disclosed below:

TrendController.js
FLOORESENSE.controller(‘TrendController’,function($scope,$rootScope,$stateParams,
$http,$state,$ionicPopup,
TrendingProductService,$translate,$filter,sharedFunction,$cordovaBarcodeScanner,Prod
uctDetailsService,$ionicLoading,RecommendationService){
TrendingProductService.getProductTrendId( ).then(function successCallBack(response){

//service call for fetching trending products IDS

```
}
ProductDetailsService.getProductDetails( ).then(function successCallBack(response){
  //call to mqa Flooresense to fetch product details
//method for recommendation
  $rootScope.getRec=function( ){
RecommendationService.getRecommendedProduct( ).then(function
successCallBack(response) { //service call for fetching recommendations
}}}}
Service.js:
//call neo service for trending product ids
FLOORESENSE.service(‘TrendingProductService’, [‘$http’, ‘$rootScope’, ‘$q’,
function($http, $rootScope, $q) {
this.getProductTrendId = function( ) {
```

var deferred = $q.defer( );
$http({

url:

‘http://csrec1.eastus.cloudapp.azure.com:8080/neoservice/rs/api/content/orderby/trending
?Order=ASC&Limit=15’,

method: “GET”,
headers: {

```
  “Accept”: “application/json”,
  “AppCode”: “FS”,
  “tenantID”: “testTenant”,
  “contentType”:“FSProduct”
```

}

}).
success(function(data, status, headers, config) {

deferred.resolve/data);

}).
error(function(data, status, headers, config) {

deferred.reject(data, status, headers, config);

});
return deferred.promise;

}

}
//product details service
FLOORESENSE.service(‘ProductDetailsService’, [‘$http’, ‘$rootScope’, ‘$q’,
function($http, $rootScope, $q) {

this.getProductDetails = function( ) {

var deferred = $q.defer( );
$http({

url:

‘https://mqa.flooresense.com/flooresense/getProductDetails?productIds=’+$rootScope.pro
ductId,

method: “GET”,
headers: {

“Content-Type”: “application/json”,
“Access-Control-Expose-Headers”: “Content-Disposition”,
“Access-Control-Allow-Credentials”: “true”

}

}).
success(function(data, status, headers, config) {

deferred.resolve(data);

}).
error(function(data, status, headers, config) {

deferred.reject(data, status, headers, config);

});
return deferred.promise;

}

}]);

The feedback module 912f of the central server 910 receives and stores feedback on a communication initiated by the store assistant with the identified anonymous shopper from the store assistant communication device A 903 or B 905 for the iterative ranking of the identified anonymous shopper in conjunction with conversion data extracted from the feedback received from the store assistant communication device A 903 or B 905 of the retail store as disclosed in the detailed description of FIG. 1 and FIG. 8. The feedback module 912f transmits the feedback to the analytics server 920 via the network 909 for the iterative ranking of the identified anonymous shopper. A code snippet of the feedback module 912f executed by the processor 911 of the central server 910 for receiving and storing feedback on the communication initiated by the store assistant with the identified anonymous shopper is disclosed below:

FeedbackController.js:
$scope.feedback = function(id) {

FeedbackService.postFeedback(feedbackValues).then(function(response) {

// Success Callback

},function(error_st) {

// Error Callback

});

}
service.js:
FLOORESENSE.service(‘FeedbackService’, [‘$http’, ‘$rootScope’, ‘$q’, function($http,
$rootScope, $q) {

```
this.postFeedback = function(feedbackValues) {
  var deferred = $q.defer( );
  $http({
```

url: $rootScope.static_URL + ‘/savenotificationFeedback’, //service URL
method: “POST”,
data: feedbackValues,
headers: {

“Content-Type”: “application/json”,
“Access-Control-Allow-Origin”: “*”,
“Access-Control-Allow-Credentials”: “true”,
“Access-Control-Allow-Headers”: “Content-Type”,
“Authorization”:$rootScope.authToken

}

```
  }).
  success(function(data, status, headers, config) {
```

deferred.resolve(data);

```
  }).
  error(function(data, status, headers, config) {
```

deferred.reject(status);

```
  });
  return deferred.promise;
}
```

}]);
Cross sell Module feedback
UserDashboardCtrl.js

$scope.checkAcceptedNotification = function (indexAlert) {

$rootScope.getAllAlerts = function ( ) {

/*method to make service call for getting all alerts*/
MoveToTrend( ) //call trend controller
}
}

The report generation module 912g of the central server 910 generates one or more retail store analytics reports comprising, for example, the conversion data, sales data, a number of generated alert notifications, and the section attributes of the configured region of interest for analyzing purchase intent of anonymous shoppers in the retail store over a duration of time. The report generation module 912g renders the generated retail store analytics reports on the graphical user interface (GUI) 907a provided by the manager application 907 deployable on the store manager communication device 906. A code snippet of the report generation module 912g executed by the processor 911 of the central server 910 for generating one or more retail store analytics reports is disclosed below:

@RequestMapping(value = “/alertTimeReportData”, method =
RequestMethod.POST)
public @ResponseBody DatatableResponse
alertTimeReportData(HttpServletRequest

request) {

DatatableRequest<AlertTimeSearchForm> dtSearchRequest =
AlertResponseHelper.populateAlertReportDatatableRequest(request);

String storeId=dtSearchRequest.getEntityType( ).getStoreId( );
StoreInfo storeInfo = storeService.findByStoreId(storeId);
ZoneId zone = ZoneId.of(storeInfo.getTimeZone( ));
LocalDateTime todayDateTime = LocalDateTime.now(zone);
ZonedDateTime zdt = todayDateTime.atZone(zone);
int offsetSeconds = zdt.getOffset( ).getTotalSeconds( );
String timeZone= storeInfo.getTimeZone( );

EntitySearchRequest<AlertReportInfo> searchRequest =
AlertResponseHelper.populateSearchRequest(
dtSearchRequest, timeZone, offsetSeconds);
EntitySearchResponse<AlertReportInfo> searchResponse =
reportService.searchAlertTimeReportData(searchRequest);
List<AlertReportInfo> alertReportInfoList =

searchResponse.getResultList( );

List<AlertTimeResponse> alertTimeRespList =
ReportsHelper.formatModelToAlertTimeResponse(
alertReportInfoList, zone, storeInfo.getCity( ).getCityName( ));

DatatableResponse jsonDataModel = new DatatableResponse( );
jsonDataModel.setsEcho(dtSearchRequest.getsEcho( ));

jsonDataModel.setiTotalRecords(String.valueOf(

searchResponse.getTotalFilteredList( )));

jsonDataModel.setiTotalDisplayRecords(String.valueOf(
searchResponse.getTotalList( )));

jsonDataModel.setAaData(alertTimeRespList);
return jsonDataModel;

}

In an embodiment, the central database 912h of the central server 910 and the analytics database 926 of the analytics server 920 stores one or more of the images captured by the sensors 901 and 902, the shopper attributes, the section attributes, the dwell time thresholds, rankings of the anonymous shoppers, information on target items and offers, feedback, retail store analytics reports, etc. The central database 912h and the analytics database 926 can be any storage area or medium that can be used for storing data and files. In an embodiment, the central database 912h and the analytics database 926 can be, for example, any of a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j graph database of Neo Technology Corporation, the Cassandra database of the Apache Software Foundation, the HBase® database of the Apache Software Foundation, etc. In an embodiment, the central database 912h and the analytics database 926 can also be locations on respective file systems of the central server 910 and the analytics server 920. In another embodiment, the central database 912h and the analytics database 926 can be external databases remotely accessed by the central server 910 and the analytics server 920 respectively, via the network 909. In another embodiment, the central database 912h and the analytics database 926 are configured as cloud based databases implemented in a cloud computing environment, where computing resources are delivered as a service over the network 909.

Each of the processors 911 and 921 of the central server 910 and the analytics server 920 respectively, executes an operating system, for example, the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., the Palm OS®, the Solaris operating system developed by Sun Microsystems, Inc., the Android® operating system of Google Inc., the Windows Phone® operating system of Microsoft Corporation, the iOS operating system of Apple Inc., the Symbian™ operating system of Symbian Foundation Limited, etc. The central server 910 and the analytics server 920 employ their respective operating systems for performing multiple tasks. The operating systems of the central server 910 and the analytics server 920 are responsible for management and coordination of activities and sharing of their respective resources. The operating systems further manage security, peripheral devices, and network connections. The operating systems of the central server 910 and the analytics server 920 recognize, for example, inputs provided by a user using the input devices 916 and 930 respectively such as a keyboard, a microphone for proving voice input, a computer mouse, a touch pad, any device capable of sensing a tactile input, etc., the output devices 919 and 933 that output the results of operations performed by the central server 910 and the analytics server 920 respectively, files, and directories stored locally on the respective fixed media drives 917 and 931. The operating systems of the central server 910 and the analytics server 920 execute different programs using the processors 911 and 921 respectively. The processors 911 and 921 and the operating systems of the central server 910 and the analytics server 920 respectively, together define a computer platform for which application programs in high level programming languages are written.

The processor 911 of the central server 910 retrieves instructions defined by the anonymous shopper identification module 912a, the data communication module 912b, the interest region creation module 912c, the event generation module 912d, the alert notification module 912e, the feedback module 912f, and the report generation module 912g stored in the memory unit 912 of the central server 910 for performing respective functions disclosed above. The processor 921 of the analytics server 920 retrieves instructions defined by the shopper attribute determination module 923 comprising the object extraction module 923a, the human object determination module 923b, the persistence determination module 923c, and the dwell time computation module 923d stored in the memory unit 922 of the analytics server 920 for performing respective functions disclosed above. The processor 921 of the analytics server 920 further retrieves instructions defined by the dwell time threshold computation module 924 and the ranking module 925 stored in the memory unit 922 of the analytics server 920 for performing respective functions disclosed above. A program counter determines locations of the instructions in the memory units 912 and 922 of the central server 910 and the analytics server 920 respectively. The program counter stores a number that identifies the current position in the program of each of the modules, for example, 912a, 912b, 912c, 912d, 912e, 912f, 912g, etc., of the central server 910, and the modules, for example, 923a, 923b, 923c, 923d, 924, 925, etc., of the analytics server 920. The instructions fetched by the processors 911 and 921 from the memory units 912 and 922 of the central server 910 and the analytics server 920 respectively, after being processed are decoded. The instructions are stored in an instruction register in each of the processors 911 and 921. After processing and decoding, the processors 911 and 921 execute the instructions, thereby performing one or more processes defined by those instructions.

At the time of execution, the instructions stored in the instruction register are examined to determine the operations to be performed. The processors 911 and 921 of the central server 910 and the analytics server 920 respectively, then perform the specified operations. The operations comprise arithmetic operations and logic operations. The operating systems of the central server 910 and the analytics server 920 respectively perform multiple routines for performing a number of tasks required to assign the input devices 916 and 930, the output devices 919 and 933, and the memory units 912 and 922 respectively, for execution of the modules, for example, 912a, 912b, 912c, 912d, 912e, 912f, 912g, etc., of the central server 910, and the modules, for example, 923a, 923b, 923c, 923d, 924, 925, etc., of the analytics server 920. The tasks performed by the respective operating systems comprise, for example, assigning memory to the modules, for example, 912a, 912b, 912c, 912d, 912e, 912f, 912g, etc., of the central server 910, and to the modules, for example, 923a, 923b, 923c, 923d, 924, 925, etc., of the analytics server 920, and to data used by the central server 910 and the analytics server 920 respectively, moving data between the memory units 912 and 922 and disk units, and handling input/output operations. The operating systems of the central server 910 and the analytics server 920 respectively perform the tasks on request by the operations and after performing the tasks, the operating system transfers the execution control back to the processors 911 and 921. The processors 911 and 921 continue the execution to obtain one or more outputs. The outputs of the execution of the modules, for example, 912a, 912b, 912c, 912d, 912e, 912f, 912g, etc., of the central server 910, and the modules, for example, 923a, 923b, 923c, 923d, 924, 925, etc., of the analytics server 920 are displayed to operators of the central server 910 and the analytics server 920 on the output devices 919 and 933 respectively.

For purposes of illustration, the detailed description refers to the central server 910 and the analytics server 920 being run locally as single computer systems; however the scope of the method and the purchase intent determination and assistance management system (PIDAMS) 908 disclosed herein is not limited to the central server 910 and the analytics server 920 being run locally on the computer systems via their respective operating systems and processors 911 and 921, but may be extended to run remotely over the network 909 by employing a web browser and a remote server, a mobile phone, or other electronic devices. In an embodiment, one or more portions of the PIDAMS 908 are distributed across one or more computer systems (not shown) coupled to the network 909. Furthermore, although the detailed description of FIG. 9B relates to an implementation of the PIDAMS 908 comprising the central server 910 and the analytics server 920, the PIDAMS 908 is not limited to be implemented using the central server 910 and the analytics server 920, but may be extended to be implemented using a single server or a network of two or more servers.

The non-transitory computer readable storage media disclosed herein store computer program codes comprising instructions executable by the processors 911 and 921 for determining purchase intent of an anonymous shopper in a retail store and providing assistance to the anonymous shopper in the retail store based on the determined purchase intent. The computer program codes comprise a first computer program code for identifying the anonymous shopper within a region of interest configured for a section in the retail store using one or more sensors 901 and 902 positioned at multiple sections of the retail store; a second computer program code for receiving multiple images of the identified anonymous shopper captured by one or more sensors 901 and 902 positioned at the configured region of interest; a third computer program code for determining shopper attributes of the identified anonymous shopper from the received images; a fourth computer program code for generating an event associated with the received images and the determined shopper attributes based on a configurable dwell time threshold; a fifth computer program code for iteratively ranking the identified anonymous shopper based on the generated event and the section attributes of the configured region of interest for determining the purchase intent of the identified anonymous shopper to convert the identified anonymous shopper into a potential buyer; a sixth computer program code for generating and transmitting one or more alert notifications with the determined shopper attributes, images that provide a physical identification of the identified anonymous shopper, and the region of interest to the store assistant communication devices A 903 and B 905 of the store assistants to provide assistance to the identified anonymous shopper based on the iterative ranking of the identified anonymous shopper and predetermined section criteria; a seventh computer program code for rendering information on target items and offers on the target items applicable to the identified anonymous shopper based on the determined shopper attributes to the store assistant communication device A 903 or B 905 of one of the store assistants on request, on receiving an acceptance indication from the store assistant to provide assistance to the identified anonymous shopper; and an eighth computer program code for receiving and storing feedback on a communication initiated with the identified anonymous shopper from the store assistant communication device A 903 or B 905 for the iterative ranking of the identified anonymous shopper in conjunction with conversion data from the feedback received from the store assistant communication device A 903 or B 905 of the retail store.

The computer program codes further comprise a ninth computer program code for creating regions of interest based on a mapping of images captured by the sensors 901 and 902 on a floor plan for each section of the retail store. In an embodiment, the third computer program code comprises a tenth computer program code for extracting one or more objects from the received images; an eleventh computer program code for determining one or more human objects from the extracted objects based on predefined criteria; a twelfth computer program code for determining persistence of the identified anonymous shopper from the determined human objects at the configured region of interest; and a thirteenth computer program code for computing the dwell time of the identified anonymous shopper based on the determined persistence by calculating a duration of presence of the identified anonymous shopper at the configured region of interest. In an embodiment, the sixth computer program code comprises a fourteenth computer program code for calculating a number of alert notifications to be transmitted to the store assistant communication devices A 903 and B 905 based on a percentage of time allocated and a number of available store assistants to assist the identified anonymous shopper. The sixth computer program code further comprises a fifteenth computer program code for generating and rendering a consolidated view of the generated alert notifications on the graphical user interface 907a provided by the manager application 907 deployable on the store manager communication device 906 for assignment of the generated alert notifications to one or more store assistants.

In an embodiment, the computer program codes further comprise a sixteenth computer program code for generating one or more retail store analytics reports comprising the conversion data, sales data, number of generated alert notifications, and the section attributes of the configured region of interest for analyzing purchase intent of anonymous shoppers in the retail store over a duration of time, and rendering the generated retail store analytics reports on the graphical user interface 907a provided by the manager application 907 deployable on the store manager communication device 906.

The computer program codes further comprise one or more additional computer program codes for performing additional steps that may be required and contemplated for determining purchase intent of an anonymous shopper in a retail store and providing assistance to the anonymous shopper in the retail store based on the determined purchase intent. In an embodiment, a single piece of computer program code comprising computer executable instructions performs one or more steps of the method disclosed herein for determining purchase intent of an anonymous shopper in a retail store and providing assistance to the anonymous shopper in the retail store based on the determined purchase intent. The computer program codes comprising computer executable instructions are embodied on the non-transitory computer readable storage media. The processors 911 and 921 of the purchase intent determination and assistance management system (PIDAMS) 908 retrieve these computer executable instructions and execute them. When the computer executable instructions are executed by the processors 911 and 921, the computer executable instructions cause the processors 911 and 921 to perform the steps of the method for determining purchase intent of an anonymous shopper in a retail store and providing assistance to the anonymous shopper in the retail store based on the determined purchase intent.

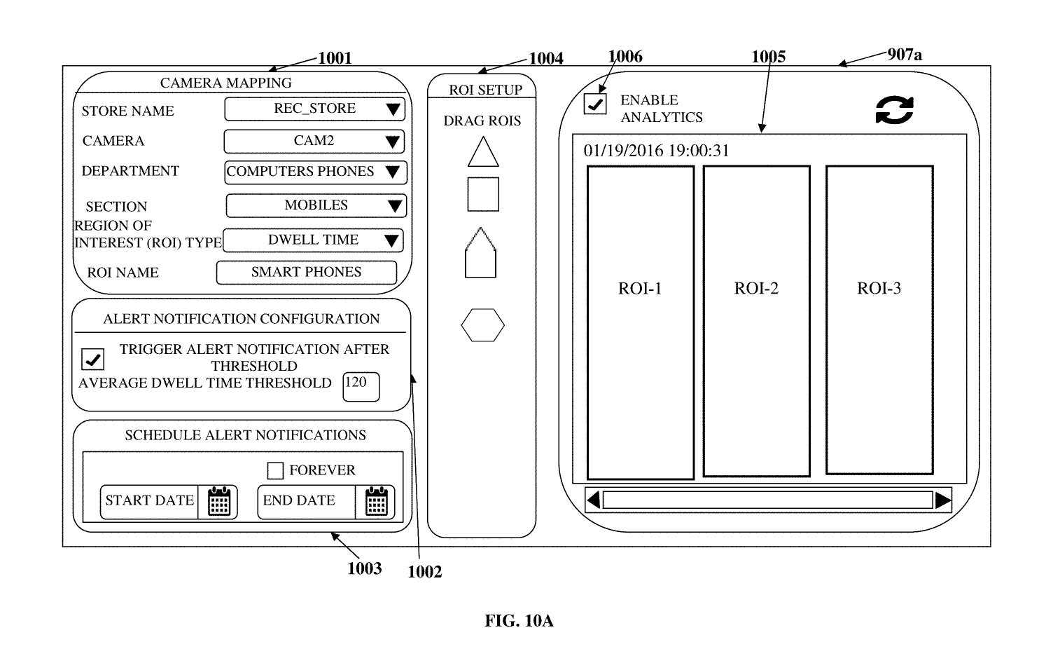

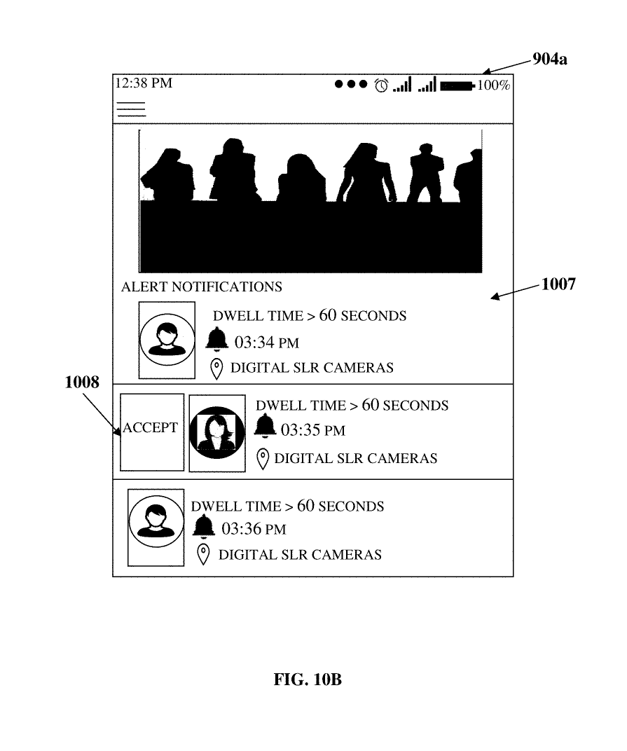

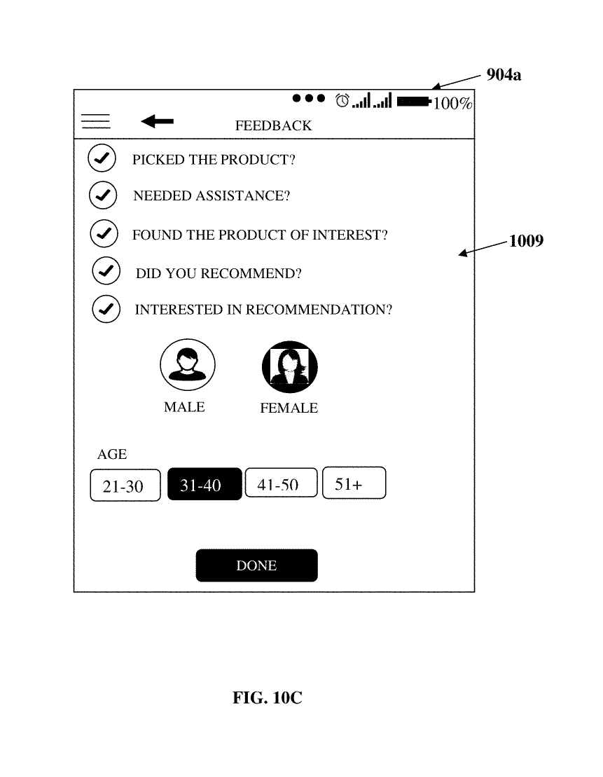

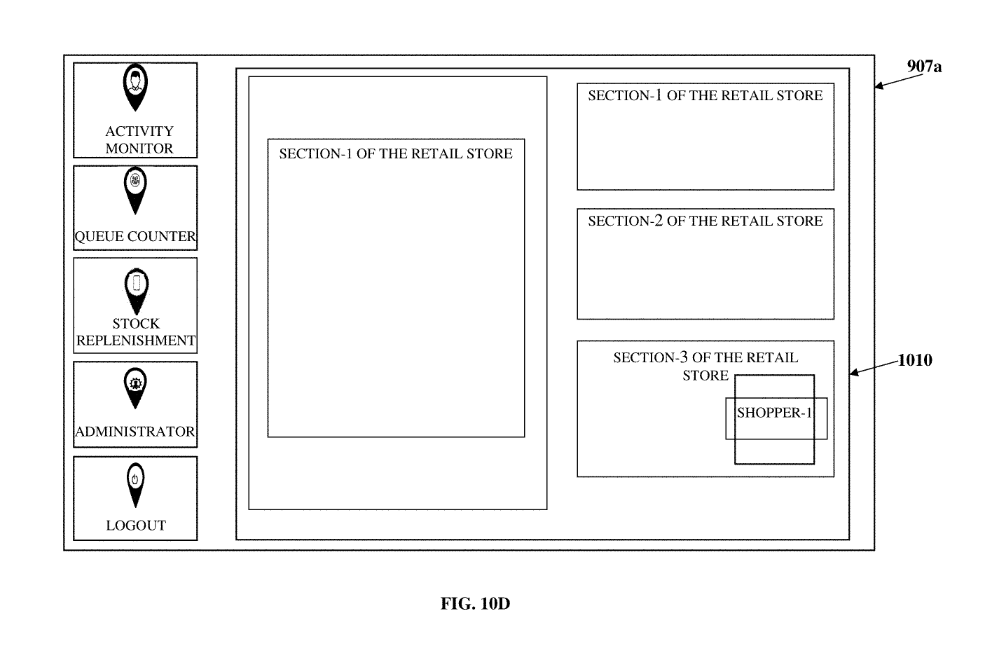

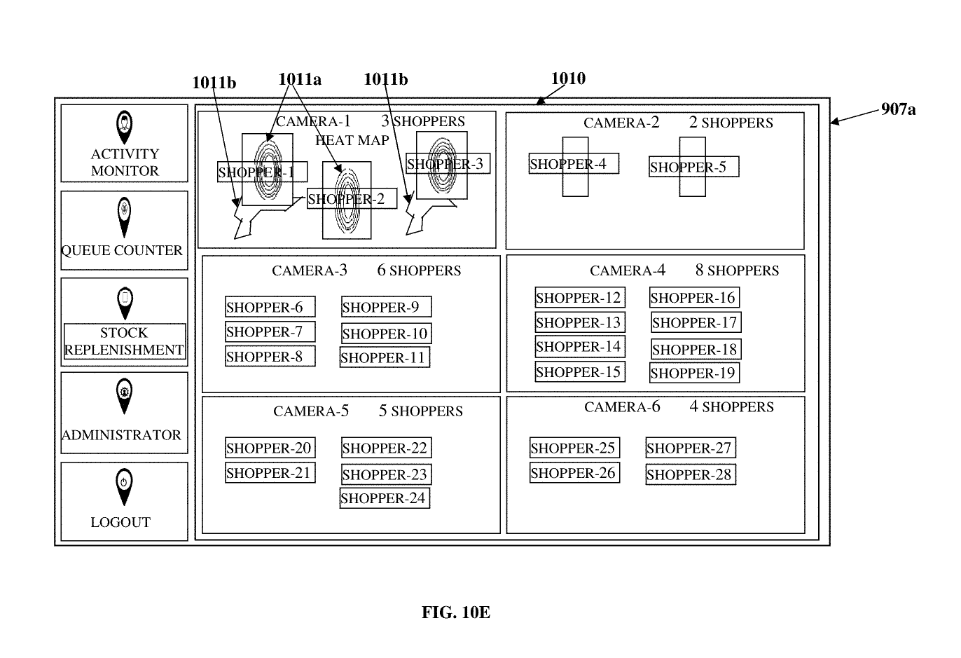

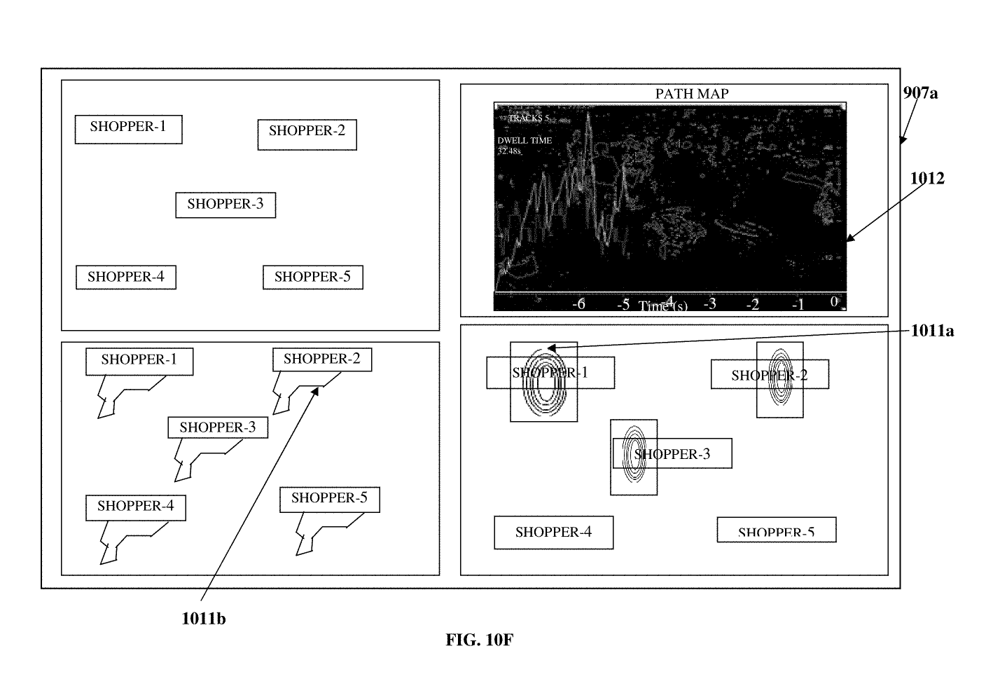

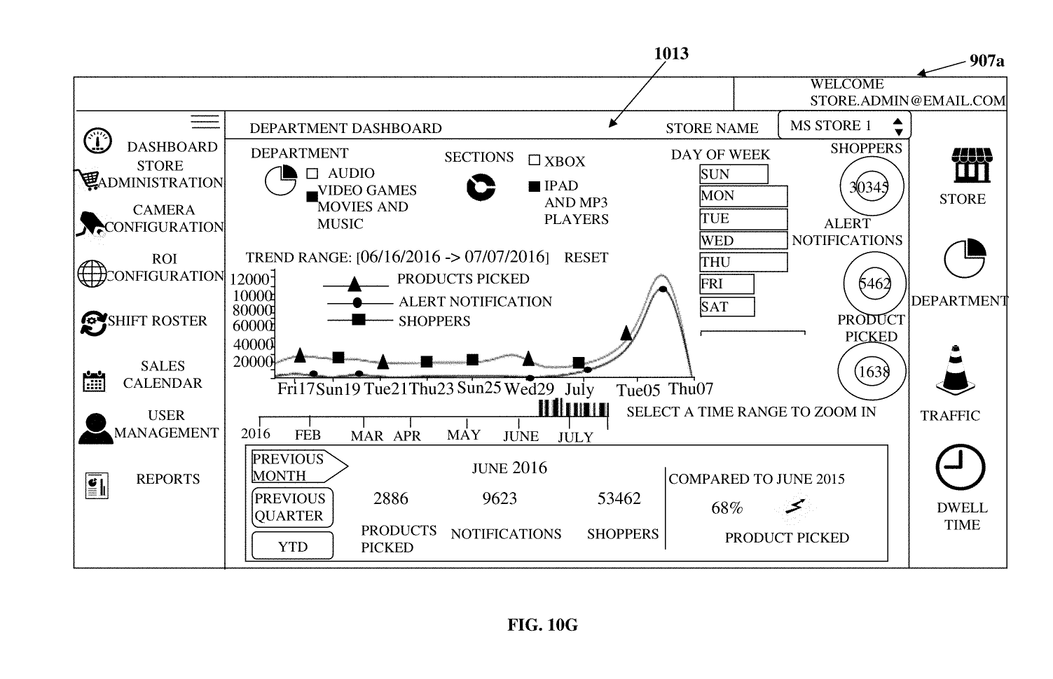

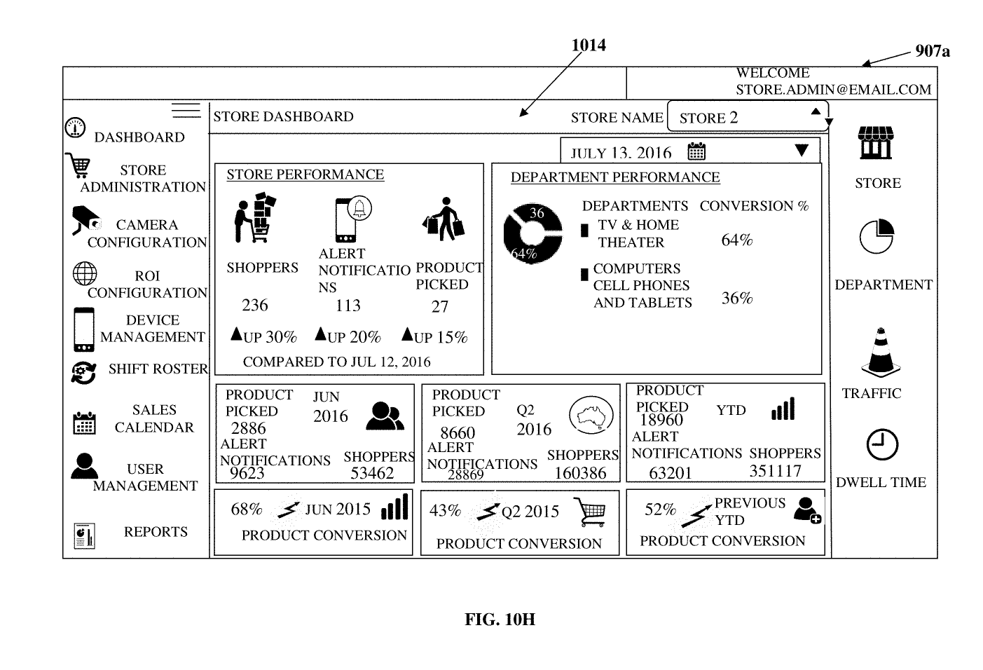

FIGS. 10A-10J exemplarily illustrate screenshots of graphical user interfaces (GUIs) 904a and 907a provided by the purchase intent determination and assistance management system (PIDAMS) 908 exemplarily illustrated in FIGS. 9A-9B, for determining purchase intent of an anonymous shopper in a retail store and providing assistance to the anonymous shopper in the retail store based on the determined purchase intent in real time. Consider an example where multiple anonymous shoppers, for example, shopper-1, shopper-2, etc., are visiting a retail store equipped with multiple sensors 901 and 902 exemplarily illustrated in FIG. 9A, for example, cameras, video cameras, etc., and the PIDAMS 908. Live stream, that is, video feeds from the sensors 901 and 902, are overlaid or mapped on a floor plan of each section of the retail store and the PIDAMS 908 allows a section of the retail store, for example, a mobiles section, in view of a sensor 902, for example, CAM2 to be configured into regions of interest. The PIDAMS 908 allows the store manager to configure the regions of interest on the graphical user interface (GUI) 907a of the manager application 907, for example, a web application accessed on the store manager communication device 906 exemplarily illustrated in FIG. 9A. The PIDAMS 908 identifies an anonymous shopper, for example, shopper-1, in a configured region of interest.

FIG. 10A exemplarily illustrates a screenshot of the graphical user interface (GUI) 907a provided by the manager application 907 on the store manager communication device 906 exemplarily illustrated in FIG. 9A, for configuring regions of interest in a retail store. The GUI 907a displays a camera mapping section 1001, an alert notification configuration section 1002, an alert notification scheduling section 1003, a region of interest (ROI) setup section 1004, and a mapped floor plan 1005. The GUI 907a allows the store manager to map cameras positioned in the retail store via the camera mapping section 1001, configure alert notifications via the alert notification configuration section 1002, and schedule alert notifications via the alert notification scheduling section 1003 of the GUI 907a. The camera mapping section 1001 in the GUI 907a allows the store manager to select the retail store, camera, department, section, ROI type, and ROI name. The alert notification configuration section 1002 in the GUI 907a allows the store manager to define an average dwell time threshold and trigger alert notifications after the dwell time of the shopper, for example, shopper-1, crosses the defined average dwell time threshold. The alert notification scheduling section 1003 allows the store manager to schedule alert notifications, for example, by entering a start date and an end date or by selecting an option to continually transmit alert notifications.

The graphical user interface (GUI) 907a allows the store manager to drag different shapes, for example, triangles, squares, rectangles, polygons, etc., from the region of interest (ROI) setup section 1004 to the mapped floor plan 1005 rendered on the GUI 907a. The store manager configures the section, for example, the mobiles section, in view of the camera, CAM 2, into three regions of interest, ROI-1, ROI-2, and ROI-3 in the mapped floor plan 1005 using the rectangular shapes from the ROI setup section 1004 as exemplarily illustrated in FIG. 10A. After configuring the regions of interest, the store manager activates an enable analytics check box 1006 provided on the GUI 907a. On activating the enable analytics check box 1006, the purchase intent determination and assistance management system (PIDAMS) 908 exemplarily illustrated in FIGS. 9A-9B, extracts metadata of the region of interest where shopper-1 is identified. The metadata comprises, for example, the camera ID, track ID, trackdatabase ID, region of interest ID, region of interest name, etc. The PIDAMS 908 also determines shopper attributes of shopper-1, section attributes of the mobiles section, climatic conditions at the location of the retail store, shopper demographics, number of available store assistants, etc. The PIDAMS 908 compares dwell time of shopper-1 with the average dwell time threshold of the region of interest, for example, a smart phones section where shopper-1 is identified. If the dwell time of shopper-1 in the region of interest exceeds the dwell time threshold of the region of interest, the PIDAMS 908 generates an event.

Using the extracted metadata, the determined shopper attributes, the section attributes, the climatic conditions at the retail store, the number of available store assistants, etc., the purchase intent determination and assistance management system (PIDAMS) 908 executes the machine learning recommendation algorithm to rank shopper-1 as disclosed in the detailed description of FIG. 1 and FIG. 8. After ranking shopper-1, the PIDAMS 908 calculates the number of alert notifications to be transmitted to the communication devices of the store assistants, for example, the store assistant communication devices A 903 and B 905 exemplarily illustrated in FIG. 9A. The PIDAMS 908 performs a lookup in the shift roster of the retail store to determine the number of available store assistants for the configured region of interest where shopper-1 is identified, a predefined percentage of time allocated to serve shopper-1, and availability of store assistants for a given shift to calculate the number of alert notifications to be transmitted to the store assistants' communication devices. The PIDAMS 908 generates and transmits alert notifications with the determined shopper attributes, images that provide a physical identification of shopper-1, and the region of interest to the available store assistants' communication devices, for example, smartphones based on the ranking of shopper-1 and the section criteria. The higher the rank of shopper-1, based on the availability of the store assistants, the PIDAMS 908 transmits a number of alert notifications to the available store assistants to provide immediate assistance to shopper-1. In an embodiment, the PIDAMS 908 generates and renders a consolidated view of the generated alert notifications on the GUI 907a of the manager application 907 on the store manager communication device 906. Using the GUI 907a, the store manager assigns the generated alert notifications to the store assistants.

FIG. 10B exemplarily illustrates a screenshot of alert notifications 1007 rendered on the graphical user interface (GUI) 904a of the assistant application 904 on a store assistant communication device A 903 exemplarily illustrated in FIG. 9A, for example, a smartphone of a store assistant, for multiple anonymous shoppers, for example, shopper-1, shopper-2, and shopper-3 identified in the retail store. As exemplarily illustrated in FIG. 10B, the alert notifications 1007 comprise images of the identified anonymous shoppers, the dwell time of the identified anonymous shoppers, time when the alert notifications 1007 were sent to the assistant application 904, and the regions of interest where the identified anonymous shoppers are located. Along with the alert notifications 1007, the purchase intent determination and assistance management system (PIDAMS) 908 exemplarily illustrated in FIGS. 9A-9B, provides the store assistant with an option to accept or reject the alert notifications 1007, for example, using a swipe action on an accept button 1008 rendered on the GUI 904a by the assistant application 904. On swiping to the right on the accept button 1008, the store assistant accepts an alert notification to assist an identified anonymous shopper, for example, shopper-1. With a swipe action to the left on the accept button 1008, the store assistant rejects the alert notification to assist the identified anonymous shopper, shopper-1.

After accepting the alert notification, the store assistant proceeds to provide assistance to shopper-1 to clarify any questions that shopper-1 may have, recommend products to shopper-1, help shopper-1 locate a specific product in a section of interest, etc., to convert shopper-1 into a potential buyer. The store assistant queries the purchase intent determination and assistance management system (PIDAMS) 908 to render more information on the categories and sub-categories of products on which shopper-1 spends time, prior to meeting shopper-1. The PIDAMS 908 renders information and offers on products that interest shopper-1, on the graphical user interface (GUI) 904a displayed on the store assistant communication device A 903. With the information and offers on products that interest shopper-1, the store assistant meets and has an offline communication with shopper-1. After communicating with shopper-1, the store assistant shares feedback of the offline communication through the GUI 904a of the assistant application 904 with the PIDAMS 908.

FIG. 10C exemplarily illustrates a screenshot of the graphical user interface (GUI) 904a of the assistant application 904 rendered on the store assistant communication device A 903 exemplarily illustrated in FIG. 9A, showing feedback 1009 on the communication initiated with the identified anonymous shopper, for example, shopper-1. As exemplarily illustrated in FIG. 10C, the GUI 904a displays a questionnaire on the interaction and communication with shopper-1, for example, whether shopper-1 picked a specific product in the retail store, whether shopper-1 needed assistance, whether shopper-1 find the product of interest, whether the store assistant recommended a product, whether shopper-1 was interested in the recommendation, etc. The GUI 904a provides interface elements, for example, clickable buttons to the store assistant to respond to the questionnaire with a yes or a no. The store assistant also confirms the determined shopper attributes, for example, gender and age range of shopper-1 on the GUI 904a. The responses to the questionnaire form the feedback 1009. The purchase intent determination and assistance management system (PIDAMS) 908 exemplarily illustrated in FIGS. 9A-9B, stores the feedback 1009 for iteratively ranking shopper-1. The PIDAMS 908 also generates a retail store analytics report to analyze purchase intent of anonymous shoppers in the retail store over a duration of time. The PIDAMS 908 renders the retail store analytics report on the GUI 907a of the manager application 907 on the store manager communication device 906 exemplarily illustrated in FIG. 9A.

FIGS. 10D-10F exemplarily illustrate screenshots of the graphical user interface (GUI) 907a of the manager application 907 on the store manager communication device 906 exemplarily illustrated in FIG. 9A, showing a shopper count dashboard 1010 rendering a live stream from sensors 901 and 902 exemplarily illustrated in FIG. 9A, in the retail store. FIG. 10D exemplarily illustrates the GUI 907a with different panels on the shopper count dashboard 1010 rendering a live stream of different sections of the retail store that are in view of the sensors 901 and 902, for example, cameras positioned at those sections of the retail store. A camera in section-3 identifies an anonymous shopper, for example, shopper-1 who is in the view of the camera as exemplarily illustrated in FIG. 10D. The GUI 907a also provides different tabs to the store manager to monitor movement of the anonymous shoppers in different sections of the retail store, movement of a queue in the retail store, replenishment of stock in the retail store, administration of the retail store, etc.

FIG. 10E exemplarily illustrates the graphical user interface (GUI) 907a of the manager application 907 on the store manager communication device 906 exemplarily illustrated in FIG. 9A, showing different panels on the shopper count dashboard 1010 rendering a live stream of different sections of the retail store that are in the view of other sensors, for example, cameras positioned at those sections of the retail store. As exemplarily illustrated in FIG. 10E, camera-1 identifies 3 anonymous shoppers in a section of retail store, camera-2 identifies 2 anonymous shoppers, camera-3 identifies 6 anonymous shoppers, camera-4 identifies 8 anonymous shoppers, camera-5 identifies 5 anonymous shoppers, and camera-6 identifies 4 anonymous shoppers. Furthermore, the GUI 907a displays heat indicators 1011a that indicate positions of the anonymous shoppers and path indicators 1011b that indicate the path of movement of the anonymous shoppers, on the shopper count dashboard 1010 as exemplarily illustrated in FIG. 10E. The purchase intent determination and assistance management system (PIDAMS) 908 exemplarily illustrated in FIGS. 9A-9B, identifies anonymous shoppers in the retail store using the cameras as disclosed in the detailed description of FIGS. 2-3. The heat indicators 1011a also define a heat map of the identified anonymous shoppers indicating their dwell time. If the dwell time of an identified anonymous shopper, for example, shopper-1, at a region of interest in a section of the retail store crosses the dwell time threshold configured by the PIDAMS 908 for that region of interest, the PIDAMS 908 sends alert notifications 1007 to store assistants in the retail store as exemplarily illustrated in FIG. 10B. The different panels in the shopper count dashboard 1010 exemplarily illustrated in FIG. 10E, are also used in queue monitoring at checkout counters. The PIDAMS 908 sends a notification to the store manager on the number of shoppers that crowd at the checkout counters.

FIG. 10F exemplarily illustrates the graphical user interface (GUI) 907a of the manager application 907 on the store manager communication device 906 exemplarily illustrated in FIG. 9A, showing different panels of the shopper count dashboard 1010 displaying a live stream of different sections of the retail store that are in view of other sensors, for example, cameras positioned at those sections of the retail store, with the heat indicators 1011a and the path indicators 1011b. One of the panels displays a path map 1012 as exemplarily illustrated in FIG. 10F. The purchase intent determination and assistance management system (PIDAMS) 908 exemplarily illustrated in FIGS. 9A-9B, identifies an anonymous shopper, for example, shopper-1 in the retail store using the cameras and draws a path map 1012 using the heat indicators 1011a and the path indicators 1011b indicating movement of shopper-1 and dwell time of shopper-1 in a region of interest of a section of the retail store. The heat indicators 1011a, the path indicators 1011b, and the path map 1012 help the store manager to visualize positions of the anonymous shoppers in the retail store anonymously and identify the popular sections in the retail store. Identifying the popular sections in the retail store facilitates identifying spots or locations in the retail store where layout changes are required and testing impact of new layout changes, concessions, and store concepts.

FIGS. 10G-10J exemplarily illustrate screenshots of the graphical user interface (GUI) 907a of the manager application 907 on the store manager communication device 906 exemplarily illustrated in FIG. 9A, showing shopper conversion dashboards 1013 and 1014 and other retail store analytics reports 1015 and 1016 generated by the purchase intent determination and assistance management system (PIDAMS) 908 exemplarily illustrated in FIGS. 9A-9B, for analyzing purchase intent of anonymous shoppers in the retail store over a duration of time. FIGS. 10G-10H exemplarily illustrate screenshots of the shopper conversion dashboards 1013 and 1014 rendered on the GUI 907a of the manager application 907 on the store manager communication device 906. The shopper conversion dashboards 1013 and 1014 allow the store manager to visualize conversion data and sales data via graphs, charts, etc., by showing the number of shoppers who visited the retail store, the number of alert notifications sent to the store assistants, and the number of products picked by the shoppers. The PIDAMS 908 provides the visualization of the conversions and the sales of the retail store by comparing the conversion data and sales data of the current day with historical conversion data and sales data respectively. The GUI 907a provides the store manager with multiple tabs to view the shopper conversion dashboards 1013 and 1014, administer the retail store, access camera configuration, region of interest (ROI) configuration, the shift roster of the retail store, a sales calendar, etc., manage users, and view the retail store analytics reports 1015 and 1016 exemplarily illustrated in FIGS. 10I-10J. The region of interest configuration tab, when clicked, leads the store manager to the GUI 907a exemplarily illustrated in FIG. 10A. The shopper conversion dashboards 1013 and 1014 are interactive dashboards that allow the store manager to view trends in sales of products and conversions for different departments and different sections of the retail store over a selected period of time, for example, a month, a quarter, an year, etc. Using the shift roster tab on the GUI 907a, the store manager accesses the shift roster of the retail store to determine availability of the store assistants to send alert notifications 1007 exemplarily illustrated in FIG. 10B.

FIGS. 10I-10J exemplarily illustrate screenshots showing generation of the retail store analytics reports, for example, 1015 and 1016 on the graphical user interface (GUI) 907a of the manager application 907 on the store manager communication device 906 exemplarily illustrated in FIG. 9A. The GUI 907a exemplarily illustrated in FIGS. 10I-10J, allows the store manager to generate different retail store analytics reports, for example, 1015 and 1016 by selecting, for example, a report type, a name of the retail store, a department of the retail store, a section of the retail store, a region of interest, a date range, a time of the day, a sale, etc. The retail analytics reports comprise, for example, a dwell time dashboard report 1015, a site traffic analysis report 1016, etc. The dwell time dashboard report 1015 exemplarily illustrated in FIG. 10I, indicates the number of anonymous shoppers identified in a region of interest of the selected section and the average dwell time of the anonymous shoppers in the selected section on different days of the week. The site traffic analysis report 1016 exemplarily illustrated in FIG. 10J, displays footfall in different departments and sections of the retail store and the average dwell time of the anonymous shoppers in the retail store. The iterative statistical models of the purchase intent determination and assistance management system (PIDAMS) 908 exemplarily illustrated in FIGS. 9A-9B, use the data comprised in the retail store analytics reports, for example, 1015 and 1016 for dynamically configuring dwell time thresholds and ranking the identified anonymous shoppers. The PIDAMS 908 accesses the data comprised in the retail store analytics reports, for example, 1015 and 1016 from the central database 912h and the analytics database 926 exemplarily illustrated in FIG. 9B.

FIGS. 11A-11B exemplarily illustrate images 1101 and 1102 captured by sensors 901 and 902 exemplarily illustrated in FIG. 9A, positioned at configured regions of interest in a retail store. Consider an example where a sensor 901, for example, camera-1 is installed at a point-of-sale (POS) in a retail store, for example, a café for capturing images 1101 at the point-of-sale as exemplarily illustrated in FIG. 11A. The point-of-sale experiences traffic uniformly distributed throughout the day with peak traffic during specific time intervals, for example, at noon or in the evening. Consider another example where a sensor 902, for example, camera-2 is installed at an elevator lobby of the café to capture images 1102 and track footfall to the café as exemplarily illustrated in FIG. 11B. The elevator lobby experiences traffic non-uniformly distributed throughout the day with peak traffic at multiple time intervals. The purchase intent determination and assistance management system (PIDAMS) 908 exemplarily illustrated in FIGS. 9A-9B, identifies anonymous shoppers within regions of interest at the point-of-sale and the elevator lobby using camera-1 and camera-2 respectively, and receives the images 1101 and 1102 exemplarily illustrated in FIGS. 11A-11B. The PIDAMS 908 determines shopper attributes of the identified anonymous shoppers, for example, shopper-1, shopper-2, shopper-3, . . . , shopper-13 exemplarily illustrated in FIGS. 11A-11B. The PIDAMS 908 generates an event associated with the received images 1101 and 1102 and the determined shopper attributes based on a configurable dwell time threshold. The PIDAMS 908 obtains an entry time and an exit time of the identified anonymous shoppers in the configured regions of interest and compute the dwell times of the identified anonymous shoppers in the configured regions of interest.

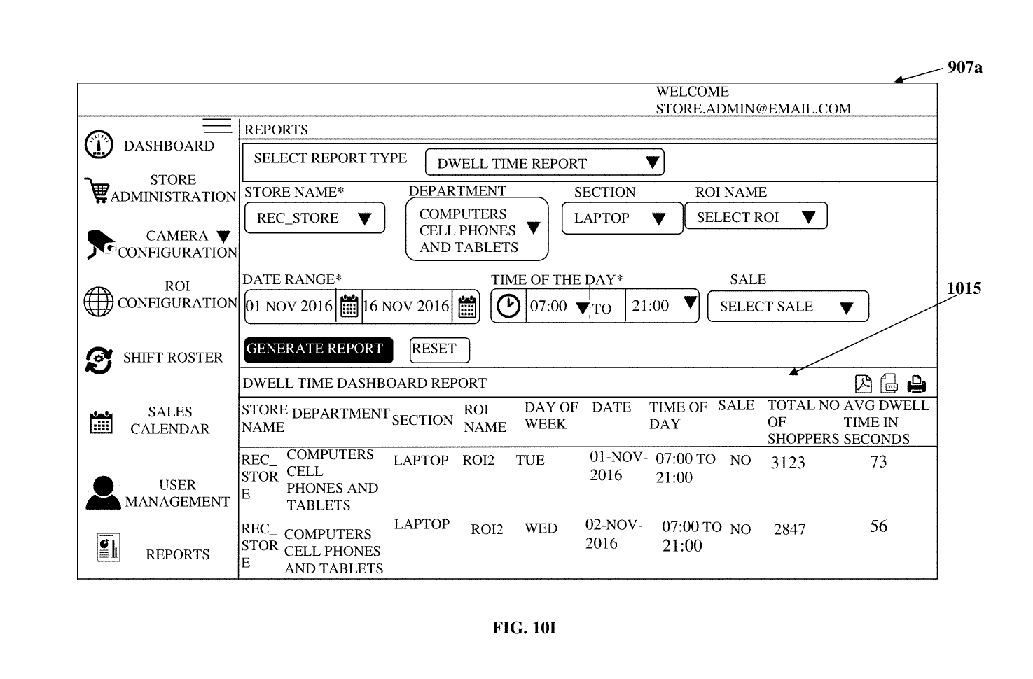

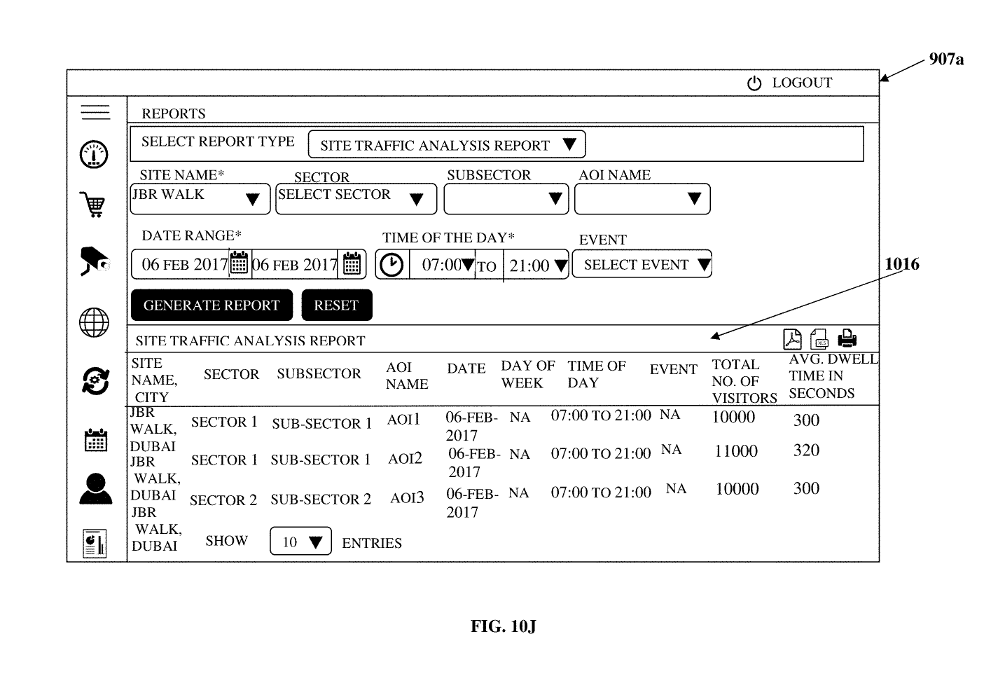

FIGS. 12A-12B exemplarily illustrate scatter graphs with dwell time distributions of the anonymous shoppers identified in the configured regions of interest exemplarily illustrated in FIGS. 11A-11B, which are in view of the sensors 901 and 902 exemplarily illustrated in FIG. 9A, at the point-of-sale (POS) and the elevator lobby of the café. As exemplarily illustrated in FIG. 12A, throughout the working hours of the café, that is, 0800 hours to 2000 hours, the purchase intent determination and assistance management system (PIDAMS) 908 exemplarily illustrated in FIGS. 9A-9B, determines 894 footfalls at the point-of-sale exemplarily illustrated in FIG. 11A, using the sensor 901, for example, camera-1. The PIDAMS 908 renders a dwell time distribution exemplarily illustrated in FIG. 12A, on the graphical user interface (GUI) 907a of the store manager communication device 906 exemplarily illustrated in FIG. 9A. On examining the dwell time distribution, the PIDAMS 908 determines the minimum value, a first quartile range, a median, a mean, a third quartile, and a maximum value of the dwell times of the identified anonymous shoppers to be 2 seconds, 7 seconds, 13 seconds, 36.86 seconds, 42 seconds, and 733 seconds respectively.

Similarly, as exemplarily illustrated in FIG. 12B, throughout the working hours of the café, that is, 0800 hours to 2000 hours, the purchase intent determination and assistance management system (PIDAMS) 908 determines 6788 footfalls at the elevator lobby exemplarily illustrated in FIG. 11B, using the sensor 902, for example, camera-2. The PIDAMS 908 renders a dwell time distribution as exemplarily illustrated in FIG. 12B, on the graphical user interface (GUI) 907a of the store manager communication device 906. On examining the dwell time distribution, the PIDAMS 908 determines the minimum value, a first quartile range, a median, a mean, a third quartile, and a maximum value of the dwell times of identified anonymous shoppers to be 2 seconds, 7 seconds, 10 seconds, 22.22 seconds, 23 seconds, and 473 seconds respectively. The PIDAMS 908 generates events when the dwell times of the identified anonymous shoppers reach the dwell time thresholds configured for the configured regions of interest. The PIDAMS 908 iteratively ranks the identified anonymous shoppers based on the generated events by implementing the machine learning recommendation algorithm using iterative statistical models.

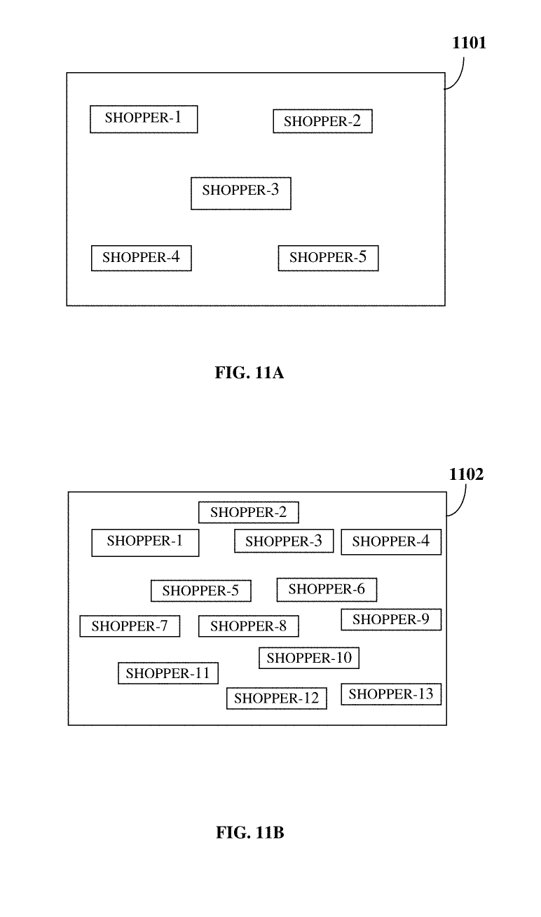

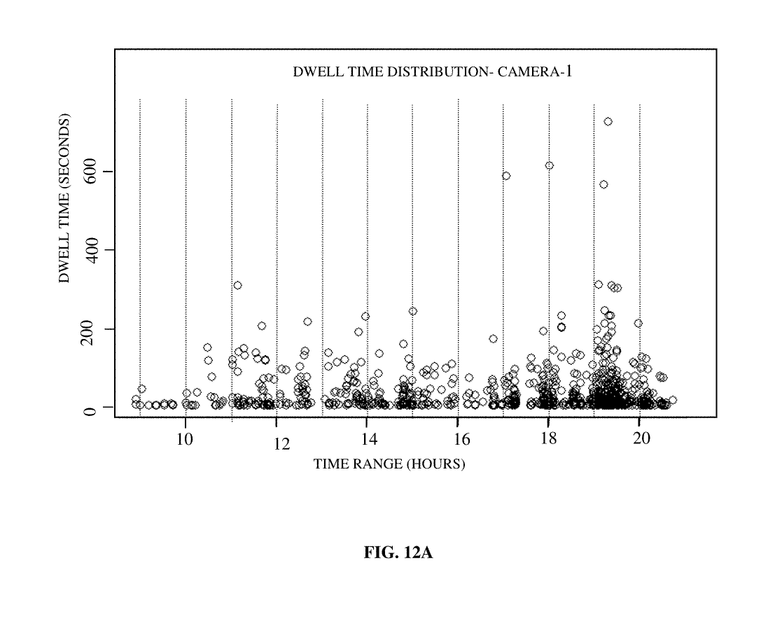

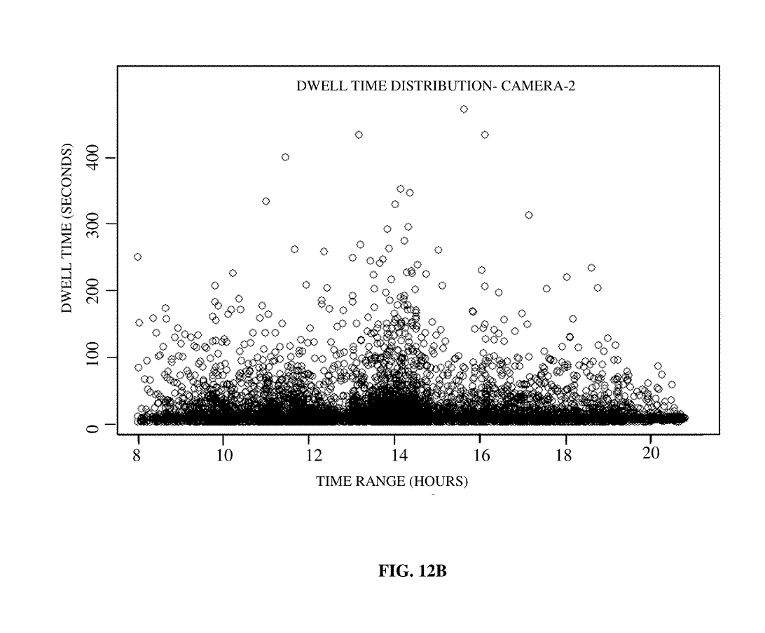

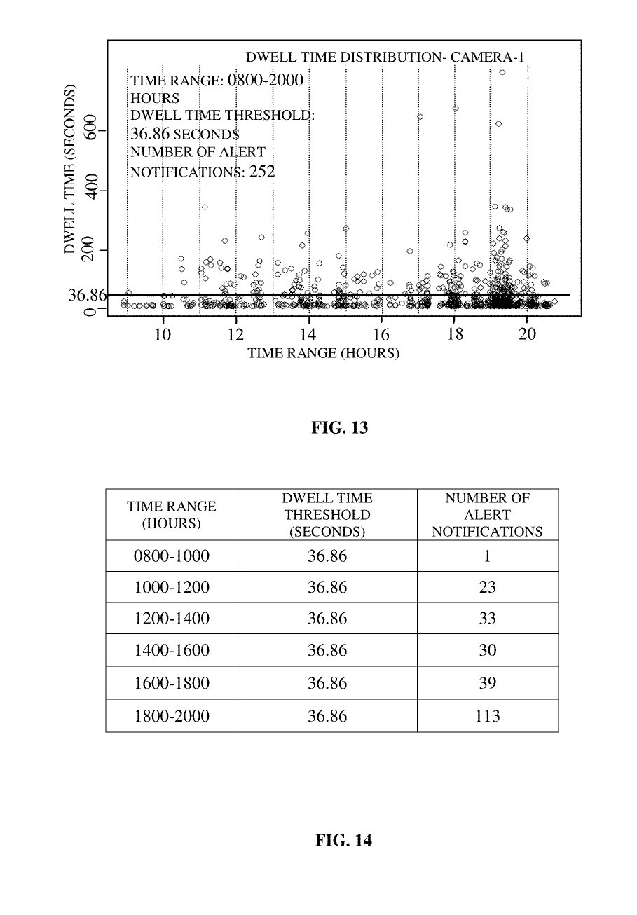

FIGS. 13-14 exemplarily illustrate a scatter graph of dwell time distributions of anonymous shoppers identified in the configured region of interest exemplarily illustrated in FIG. 11A, and a tabular representation of the number of alert notifications generated by the purchase intent determination and assistance management system (PIDAMS) 908 exemplarily illustrated in FIGS. 9A-9B, based on a onetime dwell time threshold configuration for the configured region of interest, respectively. As exemplarily illustrated in FIGS. 13-14, the PIDAMS 908 configures a onetime dwell time threshold of 36.86 seconds. The PIDAMS 908 generates events when the dwell times of the identified anonymous shoppers reach the configured onetime dwell time threshold. The PIDAMS 908 iteratively ranks the identified anonymous shoppers and generates and transmits alert notifications to one or more of the store assistant communication devices A 903 and B 905 exemplarily illustrated in FIG. 9A, to assist the identified anonymous shoppers and convert the identified anonymous shoppers into potential buyers. The PIDAMS 908 sends, for example, about 239 alert notifications to the store assistants during the working hours of the retail store, for example, the café. As exemplarily illustrated in FIG. 14, the PIDAMS 908 sends, for example, 1 alert notification to one of the store assistants between 0800 hours and 1000 hours. From 1000 hours to 1200 hours, the PIDAMS 908 sends, for example, 23 alert notifications to the store assistants. Similarly, the PIDAMS 908 sends, for example, 33, 30, 39, and 113 alert notifications to the store assistants every 2 hours starting from 1200 hours to 2000 hours. The number of alert notifications sent to the store assistants is maximum between 1800 hours and 2000 hours.

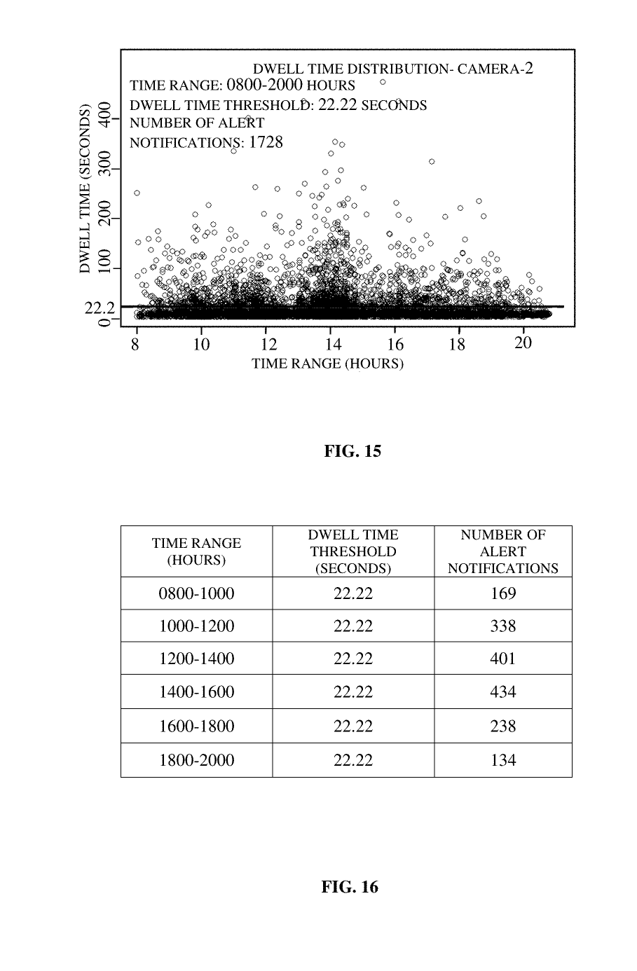

FIGS. 15-16 exemplarily illustrate a scatter graph of dwell time distributions of anonymous shoppers identified in the configured region of interest exemplarily illustrated in FIG. 11B, and a tabular representation of the number of alert notifications generated by the purchase intent determination and assistance management system (PIDAMS) 908 exemplarily illustrated in FIGS. 9A-9B, based on a onetime dwell time threshold configuration for the configured region of interest, respectively. As exemplarily illustrated in FIGS. 15-16, the PIDAMS 908 configures a onetime dwell time threshold of 22.22 seconds. The PIDAMS 908 sends, for example, about 1714 alert notifications to the store assistants during the working hours of the retail store, for example, the café. As exemplarily illustrated in FIG. 16, the PIDAMS 908 sends, for example, 169 alert notifications to the store assistants between 0800 hours and 1000 hours. From 1000 hours to 1200 hours, the PIDAMS 908 sends, for example, 338 alert notifications to the store assistants. Similarly, the PIDAMS 908 sends, for example, 401, 434, 238, and 134 alert notifications to the store assistants every 2 hours starting from 1200 hours to 2000 hours. The number of alert notifications sent to the store assistants is maximum in the afternoon between 1200 hours and 1600 hours since many anonymous shoppers walk in and out of the café during these times.

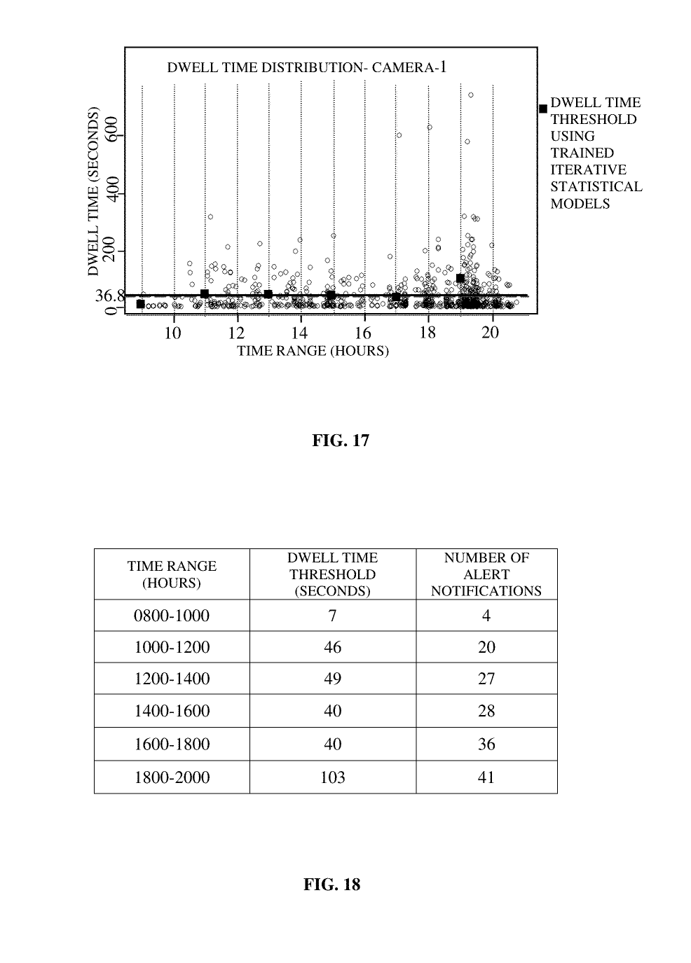

FIGS. 17-18 exemplarily illustrate a scatter graph of dwell time distributions of anonymous shoppers identified in the configured region of interest exemplarily illustrated in FIG. 11A, and a tabular representation of the number of alert notifications generated by the purchase intent determination and assistance management system (PIDAMS) 908 exemplarily illustrated in FIGS. 9A-9B, based on dwell time thresholds dynamically generated by the PIDAMS 908 using iterative statistical models associated with the configured region of interest, respectively. As exemplarily illustrated in FIGS. 17-18, the PIDAMS 908 dynamically configures dwell time thresholds for the configured regions of interest using the iterative statistical models based on iterative statistical inputs, for example, time of day, day of week, promotions in the configured regions of interest, shopper demographics, etc., and generates events when the dwell times of the identified anonymous shoppers reach the dynamically configured dwell time thresholds.

The purchase intent determination and assistance management system (PIDAMS) 908 iteratively ranks the identified anonymous shoppers and generates and transmits alert notifications to one or more of the store assistant communication devices A 903 and B 905 exemplarily illustrated in FIG. 9A, to assist the identified anonymous shoppers and convert the identified anonymous shoppers into potential buyers. As exemplarily illustrated in FIGS. 17-18, the PIDAMS 908, between 0800 hours and 1000 hours, configures the dwell time threshold for the point-of sale of the retail store, for example, the café as 7 seconds and sends, for example, 4 alert notifications to the store assistants. Between 1000 hours and 1200 hours, the PIDAMS 908 configures the dwell time threshold for the point-of-sale, for example, as 46 seconds and sends, for example, 20 alert notifications to the store assistants. The PIDAMS 908 dynamically configures the dwell time thresholds for 1200 hours to 1400 hours, 1400 hours to 1600 hours, 1600 hours to 1800 hours, and 1800 hours to 2000 hours, for example, as 49 seconds, 40 seconds, 40 seconds, and 103 seconds respectively. Correspondingly, the PIDAMS 908 sends, for example, 27, 28, 36, and 41 alert notifications to the store assistants.

On comparing the dwell time thresholds and the number of alert notifications sent to the store assistants between 0800 hours and 2000 hours by the purchase intent determination and assistance management system (PIDAMS) 908 in FIG. 14 and FIG. 18, it is evident that the PIDAMS 908 dynamically configures the dwell time thresholds as the day progresses to generate less number of alert notifications with higher accuracy. That is, the PIDAMS 908 generates and sends alert notifications based on the dynamically configured dwell time thresholds to the store assistants to assist the identified anonymous shoppers who are more likely to be converted into potential buyers.

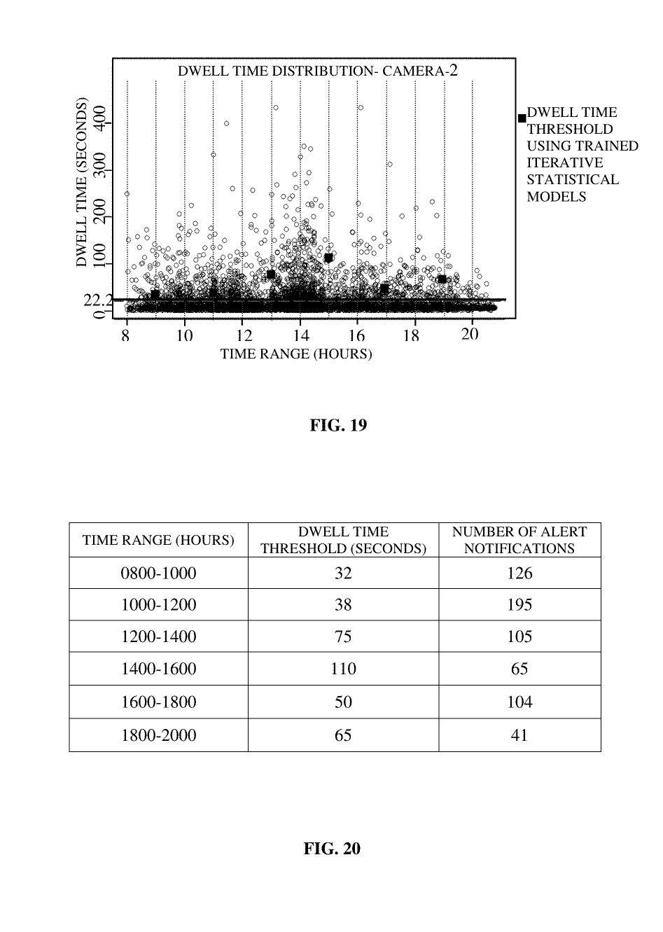

FIGS. 19-20 exemplarily illustrate a scatter graph of dwell time distributions of anonymous shoppers identified in the configured region of interest exemplarily illustrated in FIG. 11B, and a tabular representation of the number of alert notifications generated by the purchase intent determination and assistance management system (PIDAMS) 908 exemplarily illustrated in FIGS. 9A-9B, based on dwell time thresholds dynamically generated by the PIDAMS 908 using iterative statistical models associated with the configured region of interest, respectively. As exemplarily illustrated in FIGS. 19-20, the PIDAMS 908, between 0800 hours and 1000 hours, configures the dwell time threshold for the elevator lobby of the retail store, for example, the café as 32 seconds and sends, for example, 126 alert notifications to the store assistants. Between 1000 hours and 1200 hours, the PIDAMS 908 configures the dwell time threshold for the elevator lobby, for example, as 38 seconds and sends, for example, 195 alert notifications to the store assistants. The PIDAMS 908 dynamically configures the dwell time thresholds for 1200 hours to 1400 hours, 1400 hours to 1600 hours, 1600 hours to 1800 hours, and 1800 hours to 2000 hours, for example, as 75 seconds, 110 seconds, 50 seconds, and 65 seconds respectively. Correspondingly, the PIDAMS 908 sends, for example, 105, 65, 104, and 41 alert notifications to the store assistants. On comparing the dwell time thresholds and the number of alert notifications sent to the store assistants between 0800 hours and 2000 hours by the PIDAMS 908 in FIG. 16 and FIG. 20, it is evident that the PIDAMS 908 dynamically configures the dwell time thresholds as the day progresses to generate less number of alert notifications with higher accuracy. The total number of alert notifications sent to the store assistants is reduced since the extraneous shoppers who do not appear to be serious buyers need not be assisted.

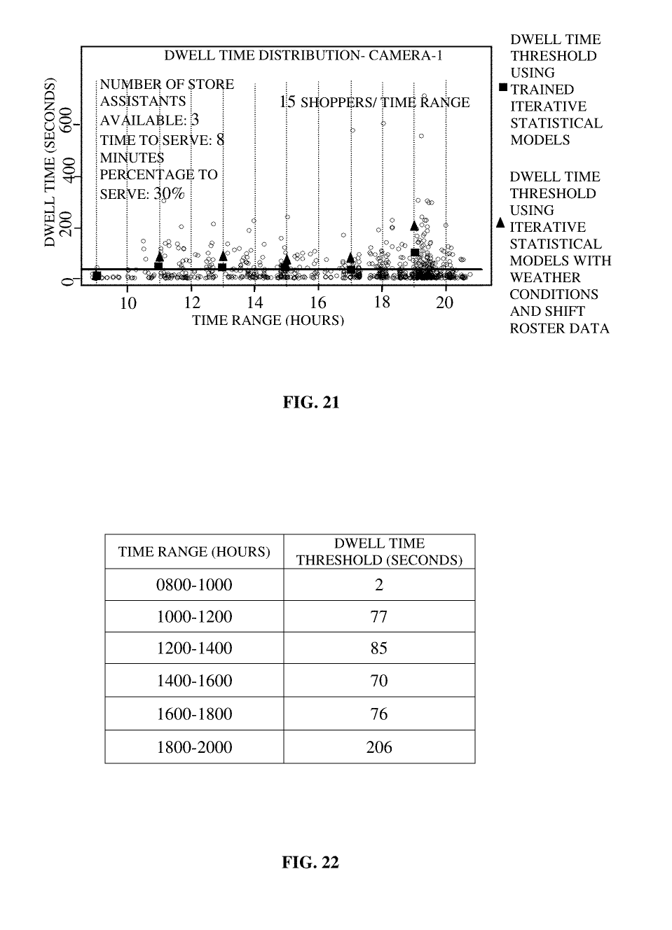

FIGS. 21-22 exemplarily illustrate a scatter graph of dwell time distributions of anonymous shoppers identified in the configured region of interest exemplarily illustrated in FIG. 11A, and a tabular representation of dwell time thresholds dynamically generated by the purchase intent determination and assistance management system (PIDAMS) 908 exemplarily illustrated in FIGS. 9A-9B, using iterative statistical models trained on weather conditions and shift roster data of the configured region of interest, respectively. In dynamically configuring the dwell time threshold using the trained iterative statistical models, the PIDAMS 908 considers other iterative statistical inputs, for example, weather conditions and shift roster data from the shift roster of the café along with time of day, day of week, promotions in the configured regions of interest, and shopper demographics as disclosed in the detailed description of FIGS. 5-6.

As exemplarily illustrated in FIG. 21, the number of store assistants available at the point-of sale of the café as extracted by the purchase intent determination and assistance management system (PIDAMS) 908 from the shift roster data is 3. Using the shift roster data, the PIDAMS 908 determines that the time to serve each identified anonymous shopper is, for example, 8 minutes, and the percentage of the identified shoppers to be served by a store assistant is, for example, 30%. The PIDAMS 908 computes the number of identified anonymous shoppers to assist every 2 hours of the working hours of the café, for example, as 15 from the historical footfall in the café. Based on the shift roster data, the PIDAMS 908 using the trained iterative statistical models computes the dwell time thresholds for 0800 hours to 1000 hours, 1000 hours to 1200 hours, 1200 hours to 1400 hours, 1400 hours to 1600 hours, 1600 hours to 1800 hours, and 1800 hours to 2000 hours, for example, to be 2 seconds, 77 seconds, 85 seconds, 70 seconds, 76 seconds, and 206 seconds respectively as exemplarily illustrated in FIG. 22.

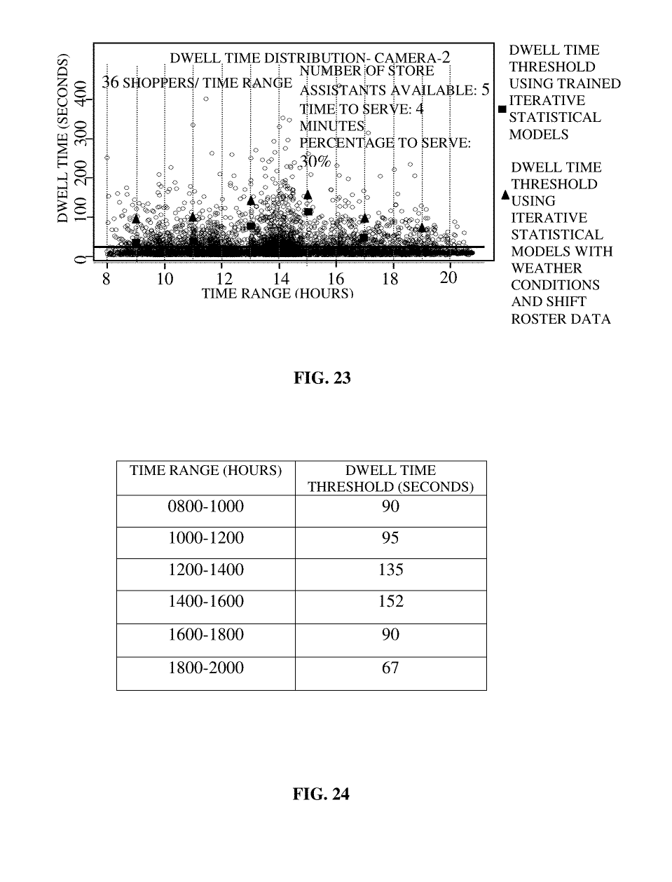

FIGS. 23-24 exemplarily illustrate a scatter graph of dwell time distributions of anonymous shoppers identified in the configured region of interest exemplarily illustrated in FIG. 11B, and a tabular representation of the dwell time thresholds dynamically generated by the purchase intent determination and assistance management system (PIDAMS) 908 exemplarily illustrated in FIGS. 9A-9B, using the iterative statistical models trained on weather conditions and shift roster data of the configured region of interest, respectively. As exemplarily illustrated in FIG. 23, the number of store assistants available at the elevator lobby of the café as extracted by the PIDAMS 908 from the shift roster data is 5. Using the shift roster data, the PIDAMS 908 determines that the time to serve each identified anonymous shopper is, for example, 4 minutes, and the percentage of the identified shoppers to be served by a store assistant is, for example, 30%. The PIDAMS 908 computes the number of identified anonymous shoppers to assist every 2 hours of the working hours of the café, for example, as 36 from the historical footfall in the café. Based on the shift roster data, the PIDAMS 908, using the trained iterative statistical models, computes the dwell time thresholds for 0800 hours to 1000 hours, 1000 hours to 1200 hours, 1200 hours to 1400 hours, 1400 hours to 1600 hours, 1600 hours to 1800 hours, and 1800 hours to 2000 hours, for example, to be 90 seconds, 95 seconds, 135 seconds, 152 seconds, 90 seconds, and 67 seconds respectively.

The purchase intent determination and assistance management system (PIDAMS) 908 determines the dwell time thresholds at the configured regions of interest based on the traffic at the configured regions of interest and the availability of store assistants in the configured regions of interest. Since the number of store assistants is less compared to the number of identified anonymous shoppers, the PIDAMS 908 sends alert notifications to the store assistants after the dwell times of the identified anonymous shoppers reaches the increased dwell time thresholds in the configured regions of interest as exemplarily illustrated in FIGS. 21-24.

It will be readily apparent in different embodiments that the various methods, algorithms, and computer programs disclosed herein are implemented on non-transitory computer readable storage media appropriately programmed for computing devices. The non-transitory computer readable storage media participates in providing data, for example, instructions that are read by a computer, a processor, or a similar device. In different embodiments, the “non-transitory computer readable storage media” further refers to a single medium or multiple media, for example, a centralized database, a distributed database, and/or associated caches and servers that store one or more sets of instructions that are read by a computer, a processor, or a similar device. The “non-transitory computer readable storage media” further refers to any medium capable of storing or encoding a set of instructions for execution by a computer, a processor, or a similar device, and that causes a computer, a processor, or a similar device to perform any one or more of the methods disclosed herein. Common forms of non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in a number of manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C#, Java®, JavaScript®, Fortran, Ruby, Perl®, Python®, Visual Basic®, hypertext preprocessor (PHP), Microsoft®.NET, Objective-C®, etc. Other object-oriented, functional, scripting, and/or logical programming languages can also be used. In an embodiment, the computer program codes or software programs are stored on or in one or more mediums as object code. In another embodiment, various aspects of the method and the system 900 exemplarily illustrated in FIG. 9A, disclosed herein are implemented in a non-programmed environment comprising documents created, for example, in a hypertext markup language (HTML), an extensible markup language (XML), or other format that render aspects of the graphical user interfaces (GUI) 904a and 907a exemplarily illustrated in FIG. 9A and FIGS. 10A-10J, or perform other functions, when viewed in a visual area or a window of a browser program. In another embodiment, various aspects of the method and the system 900 disclosed herein are implemented as programmed elements, or non-programmed elements, or any suitable combination thereof.

Where databases are described such as the central database 912h and the analytics database 926 of the purchase intent determination and assistance management system (PIDAMS) 908 exemplarily illustrated in FIG. 9B, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary skill in the art will understand that the number and content of the entries can be different from those disclosed herein. In another embodiment, despite any depiction of the databases as tables, other formats including relational databases, object-based models, and/or distributed databases are used to store and manipulate the data types disclosed herein. Object methods or behaviours of a database can be used to implement various processes such as those disclosed herein. In another embodiment, the databases are, in a known manner, stored locally or remotely from a device that accesses data in such a database. In embodiments where there are multiple databases in the system 900, the databases are integrated to communicate with each other for enabling simultaneous updates of data linked across the databases, when there are any updates to the data in one of the databases.

The method and the system 900 disclosed herein can be configured to work in a network environment comprising one or more computers that are in communication with one or more devices via the network 909 exemplarily illustrated in FIGS. 9A-9B. In an embodiment, the computers communicate with the devices directly or indirectly, via a wired medium or a wireless medium such as the internet, a local area network (LAN), a wide area network (WAN) or the Ethernet, a token ring, or via any appropriate communications mediums or combination of communications mediums. Each of the devices comprises processors, examples of which are disclosed in the detailed description of FIG. 9B, that are adapted to communicate with the computers. In an embodiment, each of the computers is equipped with a network communication device, for example, a network interface card, a modem, or other network connection device suitable for connecting to the network 909. Each of the computers and the devices executes an operating system, examples of which are disclosed above. While the operating system may differ depending on the type of computer, the operating system provides the appropriate communications protocols to establish communication links with the network 909. Any number and type of machines may be in communication with the computers.

The method and the system 900 disclosed herein are not limited to a particular computer system platform, processor, operating system, or network. In an embodiment, one or more aspects of the method and the system 900 disclosed herein are distributed among one or more computer systems, for example, servers configured to provide one or more services to one or more client computers, or to perform a complete task in a distributed system. For example, one or more aspects of the method and the system 900 disclosed herein are performed on a client-server system that comprises components distributed among one or more server systems that perform multiple functions according to various embodiments. These components comprise, for example, executable, intermediate, or interpreted code, which communicate over the network 909 using a communication protocol. The method and the system 900 disclosed herein are not limited to be executable on any particular system or group of systems, and are not limited to any particular distributed architecture, network, or communication protocol.

The foregoing examples have been provided merely for the purpose of explanation and are in no way to be construed as limiting of the method and the system 900 disclosed herein. While the method and the system 900 have been described with reference to various embodiments, it is understood that the words, which have been used herein, are words of description and illustration, rather than words of limitation. Furthermore, although the method and the system 900 have been described herein with reference to particular means, materials, and embodiments, the method and the system 900 are not intended to be limited to the particulars disclosed herein; rather, the method and the system 900 extend to all functionally equivalent structures, methods and uses, such as are within the scope of the appended claims. Those skilled in the art, having the benefit of the teachings of this specification, may affect numerous modifications thereto and changes may be made without departing from the scope and spirit of the method and the system 900 disclosed herein in their aspects.

We claim:

1. A method for determining purchase intent of an anonymous shopper in a retail store and providing assistance to said anonymous shopper in said retail store based on said determined purchase intent, said method employing a purchase intent determination and assistance management system comprising at least one processor configured to execute computer program instructions for performing said method comprising:
identifying said anonymous shopper within a region of interest configured for a section in said retail store, by said purchase intent determination and assistance management system using one or more of a plurality of sensors positioned at a plurality of sections of said retail store;
receiving, by said purchase intent determination and assistance management system, a plurality of images of said identified anonymous shopper captured by said one or more of said sensors positioned at said configured region of interest;
determining shopper attributes of said identified anonymous shopper from said received images by said purchase intent determination and assistance management system;
generating an event associated with said received images and said determined shopper attributes by said purchase intent determination and assistance management system based on a configurable dwell time threshold, wherein said configurable dwell time threshold is dynamically configured by said purchase intent determination and assistance management system based on iterative statistical inputs;
iteratively ranking said identified anonymous shopper by said purchase intent determination and assistance management system based on said generated event and section attributes of said configured region of interest for determining said purchase intent of said identified anonymous shopper to convert said identified anonymous shopper into a potential buyer;
generating and transmitting one or more alert notifications with said determined shopper attributes, images that provide a physical identification of said identified anonymous shopper, and said region of interest to a communication device of each of one or more of a plurality of store assistants to provide said assistance to said identified anonymous shopper by said purchase intent determination and assistance management system based on said iterative ranking of said identified anonymous shopper and predetermined section criteria;
rendering information on target items and offers on said target items applicable to said identified anonymous shopper based on said determined shopper attributes to said communication device of one of said store assistants on request, by said purchase intent determination and assistance management system on receiving an acceptance indication from said one of said store assistants to provide said assistance to said identified anonymous shopper; and
receiving and storing feedback on a communication initiated with said identified anonymous shopper from said communication device of said one of said store assistants by said purchase intent determination and assistance management system for said iterative ranking of said identified anonymous shopper in conjunction with conversion data extracted from said feedback received from said communication device of said one of said store assistants of said retail store.

2. The method of claim 1, wherein said shopper attributes of said identified anonymous shopper comprise dwell time, sections of dwell, an age range, gender, prominent colour of a clothing worn by said identified anonymous shopper, whether said identified anonymous shopper is accompanied by another shopper, location, date, and time.

3. The method of claim 1, wherein said section attributes comprise time of day, day of week, section value, store sales, offers, and shopper conversion elements.

4. The method of claim 1, wherein said predetermined section criteria comprise section value, type of said section, and number of available store assistants assigned to said section.

5. The method of claim 1, wherein said iterative statistical inputs comprise time of day, day of week, promotions in said configured region of interest, temperature, and shopper demographics.

6. The method of claim 1, further comprising creating regions of interest by said purchase intent determination and assistance management system based on a mapping of images captured by said sensors on a floor plan for each of said sections of said retail store.

7. The method of claim 1, wherein said determination of said shopper attributes comprising dwell time of said identified anonymous shopper from said received images by said purchase intent determination and assistance management system comprises:
extracting one or more objects from said received images by said purchase intent determination and assistance management system;
determining one or more human objects from said extracted one or more objects by said purchase intent determination and assistance management system based on predefined criteria;
determining persistence of said identified anonymous shopper from said determined one or more human objects at said configured region of interest by said purchase intent determination and assistance management system; and
computing said dwell time of said identified anonymous shopper based on said determined persistence by said purchase intent determination and assistance management system by calculating a duration of presence of said identified anonymous shopper at said configured region of interest.

8. The method of claim 1, wherein said generation of said one or more alert notifications by said purchase intent determination and assistance management system comprises calculating a number of alert notifications to be transmitted to said communication device of said each of said one or more of said store assistants based on a percentage of time allocated and a number of available store assistants to assist said identified anonymous shopper.

9. The method of claim 1, further comprising generating and rendering a consolidated view of said generated one or more alert notifications on a graphical user interface provided by a manager application deployable on a communication device of a store manager, by said purchase intent determination and assistance management system for assignment of said generated one or more alert notifications to said one or more of said store assistants.

10. The method of claim 1, further comprising generating one or more retail store analytics reports comprising said conversion data, sales data, a number of said generated one or more alert notifications, and said section attributes of said configured region of interest by said purchase intent determination and assistance management system for analyzing purchase intent of anonymous shoppers in said retail store over a duration of time, and rendering said generated one or more retail store analytics reports on a graphical user interface provided by a manager application deployable on a communication device of a store manager by said purchase intent determination and assistance management system.

11. A system for determining purchase intent of an anonymous shopper in a retail store and providing assistance to said anonymous shopper in said retail store based on said determined purchase intent, said system comprising:
a plurality of sensors positioned at a plurality of sections of said retail store for capturing a plurality of images of said anonymous shopper;
a purchase intent determination and assistance management system in communication with said sensors via a network, said purchase intent determination and assistance management system comprising:
at least one non-transitory computer readable storage medium for storing computer program instructions defined by modules of said purchase intent determination and assistance management system; and
at least one processor communicatively coupled to said at least one non-transitory computer readable storage medium for executing said computer program instructions defined by said modules of said purchase intent determination and assistance management system, said modules of said purchase intent determination and assistance management system comprising:
an anonymous shopper identification module for identifying said anonymous shopper within a region of interest configured for a section in said retail store using one or more of said sensors positioned at said sections of said retail store;
a data communication module for receiving a plurality of images of said identified anonymous shopper captured by said one or more of said sensors positioned at said configured region of interest;
a shopper attribute determination module for determining shopper attributes of said identified anonymous shopper from said received images;
an event generation module for generating an event associated with said received images and said determined shopper attributes based on a configurable dwell time threshold, wherein said configurable dwell time threshold is dynamically configured by a dwell time threshold computation module based on iterative statistical inputs;
a ranking module for iteratively ranking said identified anonymous shopper based on said generated event and section attributes of said configured region of interest for determining said purchase intent of said identified anonymous shopper to convert said identified anonymous shopper into a potential buyer;
an alert notification module for generating and transmitting one or more alert notifications with said determined shopper attributes, images that provide a physical identification of said identified anonymous shopper, and said region of interest to a communication device of each of one or more of a plurality of store assistants to provide said assistance to said identified anonymous shopper based on said iterative ranking of said identified anonymous shopper and predetermined section criteria;
said data communication module for rendering information on target items and offers on said target items applicable to said identified anonymous shopper based on said determined shopper attributes to said communication device of one of said store assistants on request, on receiving an acceptance indication from said one of said store assistants to provide said assistance to said identified anonymous shopper; and
a feedback module for receiving and storing feedback on a communication initiated with said identified anonymous shopper from said communication device of said one of said store assistants for said iterative ranking of said identified anonymous shopper in conjunction with conversion data extracted from said feedback received from said communication device of said one of said store assistants of said retail store.

12. The system of claim 11, wherein said shopper attributes of said identified anonymous shopper comprise dwell time, sections of dwell, an age range, gender, prominent colour of a clothing worn by said identified anonymous shopper, whether said identified anonymous shopper is accompanied by another shopper, location, date, and time.

13. The system of claim 11, wherein said section attributes comprise time of day, day of week, section value, store sales, offers, and shopper conversion elements.

14. The system of claim 11, wherein said predetermined section criteria comprise section value, type of said section, and number of available store assistants assigned to said section.

15. The system of claim 11, wherein said iterative statistical inputs comprise time of day, day of week, promotions in said configured region of interest, temperature, and shopper demographics.

16. The system of claim 11, wherein said modules of said purchase intent determination and assistance management system further comprise an interest region creation module for creating regions of interest based on a mapping of images captured by said sensors on a floor plan for each of said sections of said retail store.

17. The system of claim 11, wherein said shopper attribute determination module comprises:
an object extraction module for extracting one or more objects from said received images;
a human object determination module for determining one or more human objects from said extracted one or more objects based on predefined criteria;
a persistence determination module for determining persistence of said identified anonymous shopper from said determined one or more human objects at said configured region of interest; and
a dwell time computation module for computing said dwell time of said identified anonymous shopper based on said determined persistence by calculating a duration of presence of said identified anonymous shopper at said configured region of interest.

18. The system of claim 11, wherein said alert notification module calculates a number of alert notifications to be transmitted to said communication device of said each of said one or more of said store assistants based on a percentage of time allocated and a number of available store assistants to assist said identified anonymous shopper.

19. The system of claim 11, wherein said alert notification module generates and renders a consolidated view of said generated one or more alert notifications on a graphical user interface provided by a manager application deployable on a communication device of a store manager for assignment of said generated one or more alert notifications to said one or more of said store assistants.

20. The system of claim 11, wherein said modules of said purchase intent determination and assistance management system further comprise a report generation module for generating one or more retail store analytics reports comprising said conversion data, sales data, a number of said generated one or more alert notifications, and said section attributes of said configured region of interest for analyzing purchase intent of anonymous shoppers in said retail store over a duration of time, and rendering said generated one or more retail store analytics reports on a graphical user interface provided by a manager application deployable on a communication device of a store manager.

21. A non-transitory computer readable storage medium having embodied thereon, computer program codes comprising instructions executable by at least one processor for determining purchase intent of an anonymous shopper in a retail store and providing assistance to said anonymous shopper in said retail store based on said determined purchase intent, said computer program codes comprising:
a first computer program code for identifying said anonymous shopper within a region of interest configured for a section in said retail store using one or more of a plurality of sensors positioned at a plurality of sections of said retail store;
a second computer program code for receiving a plurality of images of said identified anonymous shopper captured by said one or more of said sensors positioned at said configured region of interest;
a third computer program code for determining shopper attributes of said identified anonymous shopper from said received images, wherein said shopper attributes comprise dwell time, sections of dwell, an age range, gender, prominent colour of a clothing worn by said identified anonymous shopper, whether said identified anonymous shopper is accompanied by another shopper, location, date, and time;
a fourth computer program code for generating an event associated with said received images and said determined shopper attributes based on a configurable dwell time threshold, wherein said configurable dwell time threshold is dynamically configured based on iterative statistical inputs, wherein said iterative statistical inputs comprise time of day, day of week, promotions in said configured region of interest, temperature, and shopper demographics;
a fifth computer program code for iteratively ranking said identified anonymous shopper based on said generated event and section attributes of said configured region of interest for determining said purchase intent of said identified anonymous shopper to convert said identified anonymous shopper into a potential buyer, wherein said section attributes comprise time of day, day of week, section value, store sales, offers, and shopper conversion elements;
a sixth computer program code for generating and transmitting one or more alert notifications with said determined shopper attributes, images that provide a physical identification of said identified anonymous shopper, and said region of interest to a communication device of each of one or more of a plurality of store assistants to provide said assistance to said identified anonymous shopper based on said iterative ranking of said identified anonymous shopper and predetermined section criteria, wherein said predetermined section criteria comprise section value, type of said section, and number of available store assistants assigned to said section;
a seventh computer program code for rendering information on target items and offers on said target items applicable to said identified anonymous shopper based on said determined shopper attributes to said communication device of one of said store assistants on request, on receiving an acceptance indication from said one of said store assistants to provide said assistance to said identified anonymous shopper; and
an eighth computer program code for receiving and storing feedback on a communication initiated with said identified anonymous shopper from said communication device of said one of said store assistants for said iterative ranking of said identified anonymous shopper in conjunction with conversion data extracted from said feedback received from said communication device of said one of said store assistants of said retail store.

22. The non-transitory computer readable storage medium of claim 21, wherein said computer program codes further comprise a ninth computer program code for creating regions of interest based on a mapping of images captured by said sensors on a floor plan for each of said sections of said retail store.

23. The non-transitory computer readable storage medium of claim 21, wherein said third computer program code comprises:
a tenth computer program code for extracting one or more objects from said received images;
an eleventh computer program code for determining one or more human objects from said extracted one or more objects based on predefined criteria;
a twelfth computer program code for determining persistence of said identified anonymous shopper from said determined one or more human objects at said configured region of interest; and
a thirteenth computer program code for computing said dwell time of said identified anonymous shopper based on said determined persistence by calculating a duration of presence of said identified anonymous shopper at said configured region of interest.

24. The non-transitory computer readable storage medium of claim 21, wherein said sixth computer program code comprises a fourteenth computer program code for calculating a number of alert notifications to be transmitted to said communication device of said each of said one or more of said store assistants based on a percentage of time allocated and a number of available store assistants to assist said identified anonymous shopper.

25. The non-transitory computer readable storage medium of claim 21, wherein said sixth computer program code comprises a fifteenth computer program code for generating and rendering a consolidated view of said generated one or more alert notifications on a graphical user interface provided by a manager application deployable on a communication device of a store manager for assignment of said generated one or more alert notifications to said one or more of said store assistants.

26. The non-transitory computer readable storage medium of claim 21, wherein said computer program codes further comprise a sixteenth computer program code for generating one or more retail store analytics reports comprising said conversion data, sales data, number of said generated one or more alert notifications, and said section attributes of said configured region of interest for analyzing purchase intent of anonymous shoppers in said retail store over a duration of time, and rendering said generated one or more retail store analytics reports on a graphical user interface provided by a manager application deployable on a communication device of a store manager.
